(19) United States
(12) Patent Application Publication
(10) Pub. No.: US 2010/0020689 A1
(43) Pub. Date: Jan. 28, 2010

(54) IMMEDIATE READY IMPLEMENTATION OF VIRTUALLY CONGESTION FREE GUARANTEED SERVICE CAPABLE NETWORK : NEXTGENTCP/FTP/UDP INTERMEDIATE BUFFER CYCLICAL SACK RE-USE

(76) Inventor: Bob Tang, London (GB)

Correspondence Address: Bob Tang, Flat82 Eton HallEton College Road, London, EN, NW3 2DH, GB

(21) Appl. No.: 12/449,198

(22) PCT Filed: Jan. 28, 2008
(86) PCT No.: PCT/GB2008/000292

§ 371 Date: Jul. 28, 2009

(30) Foreign Application Priority Data
Jan. 29, 2007 (GB) 0701668.6

(51) Int. Cl. H04L 12/24

(52) U.S. Cl. 370/235

(57) ABSTRACT

Various increment deployable TCP Friendly techniques of direct simple source code modifications to TCP/FTP/UDP based protocol stacks & other susceptible protocols, or other related network's switches/routers configurations, are presented for immediate ready implementations over proprietary LAN/WAN/external Internet of virtually congestion free guaranteed service capable network, without requiring use of existing QoS/MPLS techniques nor requiring any of the switches/routers softwares within the network to be modified or contribute to achieving the end-to-end performance results nor requiring provision of unlimited bandwidths at each and every inter-node links within the network.

[NOTE: This invention references whole complete earlier filed related published PCT application WO2005053265 by the same inventor, references whole complete Descriptions (&/or incorporates paragraphs therein where not already included in this application) of published PCT application PCT/IB2005/003580 of 29 Nov. 2005, and WO2007088393 Published 9 Oct. 2007, by the same Inventor]

At present implementations of RSVP/QoS/TAG Switching etc to facilitate multimedia/voice/fax/realtime IP applications on the Internet to ensure Quality of Service suffers from complexities of implementations. Further there are multitude of vendors' implementations such as using ToS (Type of service field in data packet), TAG based, source IP addresses, MPLS etc; at each of the QoS capable routers traversed through the data packets needs to be examined by the switch/router for any of the above vendors' implemented fields (hence need be buffered/queued), before the data packet can be forwarded. Imagined in a terabit link carrying QoS data packets at the maximum transmission rate, the router will thus need to examine (and buffer/queue) each arriving data packets & expend CPU processing time to examine any of the above various fields (eg the QoS priority source IP addresses table itself to be checked against alone may amount to several tens of thousands). Thus the router manufacturer's specified throughput capacity (for forwarding normal data packets) may not be achieved under heavy QoS data packets load, and some QoS packets will suffer severe delays or dropped even though the total data packets loads has not exceeded the link bandwidth or the router manufacturer's specified data packets normal throughput capacity. Also the lack of interoperable standards means that the promised ability of some IP technologies to support these QoS value-added services is not yet fully realised.

Here are described methods to guarantee quality of service for multimedia/voice/fax/realtime etc applications with better or similar end to end reception qualities on the Internet/Proprietary Internet Segment/WAN/LAN, without requiring the switches/routers traversed through by the data packets needing RSVP/Tag Switching/QoS capability, to ensure better Guarantee of Service than existing state of the art QoS implementation. Further the data packets will not necessarily require buffering/queuing for purpose of examinations of any of existing QoS vendors' implementation fields, thus avoiding above mentioned possible drop or delay scenarios, facilitating the switch/router manufacturer's specified full throughput capacity while forwarding these guaranteed service data packets even at link bandwidth's full transmission rates.

### VARIOUS REFINEMENTS & NOTES

### Increment Deployable TCP Friendly External Internet 100% Link Utilisation Data Storage Transfer NextGenTCP

At the top most level, CWND now never ever gets reduced at all whatsoever.

Its easy to use Windows desktop ‘Folder string search’ facility to locate each & every occurrences of CWND variable in all the sub-folders/files . . . to be thorough on RTO Timedout . . . even if its congestion induced we do not reduce/resets CWND at all . . . .
our RTO Timedout algorithm pseudocodes, modifying existing RFC's specifications, would be to (for ‘real congestions drops’ indications):

Timeout: /*Multiplicative Decrease*/
recordedCWND=CWND (BUT IF another RTO Timeout occurs during a
‘pause ’ in progress THEN recordedCWND=recordedCWND!/*doesn't want to erroneously cause CWND size to be reduced*/)
ssthresh=cwnd (BUT IF another RTO Timeout occurs during a ‘pause ’ in progress THEN SStresh=recordedCWND!/*doesn't want to erroneously cause SSTresh size to be reduced*/);
calculate ‘pause’ interval &sets CWND=‘1*MSS’ &restores CWND=recordedCWND after ‘pause’ counteddown;
our RTO Timedout algorithm pseudocodes, modifying existing RFC's specifications, would be to (for ‘non-congestion drops’ indications):

### Timeout: /*Multiplicative Decrease*/

ssthresh=sstresh;

### CWND=CWND;

/*both unchanged!*/

just need ensure RFC's TCP modified complying with these simple rules of thumb:
1. never ever reduces CWND value whatsoever, except to temporarily effect ‘pause’ upon ‘real congestion’ indications (restores CWND to recordedCWND thereafter). Note upon real congestion indications (latest RTT when 3rd DUP ACK or when RTO Timeout−min(RTT)>eg 200 ms) SSTresh needs be set to pre-existing CWND so subsequent CWND increments is additive linear
2. If non-congestion indications (latest RTT when 3rd DUP ACK or when RTO Timedout−min(RTT)<eg 200 ms), for both fast retransmit & RTO Timedout modules do not ‘pause ’ & do not allow existing RFCs to change CWND value nor SStresh value at all.
Note current pause ‘in progress (which could only have been triggered by ‘real congestions’ indication), if any, should be allowed to progress onto counteddown (for both fast retransmit & RTO Timeout modules).
3. If there is already current ‘pause’ in progress, subsequent intervening ‘real congestion’ indications will now completely terminates current ‘pause’ & begin a new ‘pause’ (a matter of merely setting/overwriting a new ‘pause’ countdown value): taking care that for both fast retransmit & RTO Timeout modules recordedCWND now=recordedCWND (instead of =CWND) & now SStresh=recordedCWND (instead of CWND)

### VERY SIMPLE BASIC WORKING 1ST VERSION COMPLETE SPECIFICATIONS

### Only Few Lines Very Simple FreeBSD/Linux TCP Source Code Modifications

[Initially needs sets very large initialised min(RTT) value=eg 30,000 ms, then continuously set min(RTT)=min (latest arriving ACK's RTT, min(RTT)]
1.1 If 3rd DUP ACK then
IF RTT of latest returning ACK when 3 DUP ACKs fast retransmission−current recorded min(RTT)=<eg 200 ms (ie we know now this packet drop couldn't possibly be caused by ‘congestion event’, thus should not unnecessarily set SStresh to CWND value) THEN do not change CWND/SSTresh value (ie to not even set CWND=CWND/2 nor SSthrsh to CWND/2, as presently done in existing fast retransmit RFCs)
ELSE should set SSThresh to be same as this recorded existing CWND size (instead of to CWND/2 as in existing Fast Retransmit RFCs), AND to instead keeps a record of existing CWND size & set CWND=‘1*MSS’ & set a ‘pause’
‘countdown global variable=minimum of (latest RTT of packet triggering the 3rd DUP ACK fast retransmit or triggering RTO Timeout−min(RTT), 300 ms)
   Note: setting CWND value=1*MSS, would cause the desired temporary
   pause/halt of all forwarding onwards of packets, except the very 1st fast retransmit packet retransmission packet/s, to allow buffered packets along the path to be cleared ‘before TCP resumes sending]
ENDIF
   ENDIF
      1.2 after ‘pause’ time variable counted down, restores CWND to recorded previous CWND value (ie sender can now resumes normal sending after ‘pause’ over)
      2.1 IF RTO Timeout then
IF RTT of latest returning ACK when RTO Timedout−current recorded min(RTT)=<eg 200 ms (ie we know now this packet drop couldn't possibly be caused by ‘congestion event’, thus should not unnecessarily reset CWND value to 1*MSS) THEN do not reset CWND value to 1*MSS nor changes CWND value at all (ie to not even resets CWND at all, as presently done in existing RTO Timeout RFCs)
ELSE should instead keeps a record of existing CWND size & set CWND=‘1*MSS’ & set a ‘pause’ countdown global variable=minimum of (latest RTT of packet when RTO Timedout−min(RTT), 300 ms)
   Note: setting CWND value=1*MSS, would cause the desired temporary pause/halt of all forwarding onwards of packets, except the RTO Timedout retransmission packet/s, to allow buffered packets along the path to be cleared ‘before TCP resumes sending]
   2.2 after ‘pause’ time variable counted down, restores CWND to recorded previous CWND value (ie sender can now resumes normal sending after ‘pause’ over)
   That's all, Done Now!

### BACKGROUND MATERIALS

latest RTT of packet triggering the 3rd DUP ACK fast retransmit or triggering RTO Timeout, is readily available from existing Linux TCB maintained variable on last measured roundtrip time RTT_. the minimum recorded min(RTT) is only readily available from existing Westwood/FastTCP/Vegas TCB maintained variables, but should be easy enough to write few lines of codes to continuously update min(RTT)=minimum of [min(RTT), last measured roundtrip time RTT] References: http://www.cs.umd.edu/˜shankar/417-Notes/5-note-transportCongControl.htm: RTT variables maintained by Linux TCB<http://www.scit.wlv.ac.uk/rfc/rfc29xx/RFC2988.html>: RTO computation Google Search term ‘tcp rtt variables’ <http://www.psc.edu/networking/perf_tune.html>: tuning Linux TCP RTT parameters Google Search: ‘linux TCP minimum recorded RTT’ or ‘linux tcp minimum recorded rtt variable’. NOTE: TCP Westwood measures minimum RTT

### Notes:

1. The above ‘congestion notification trigger events’, may alternatively be defined as when latest RTT−min(RTT)>=specified interval eg 5 ms/50/300 ms ms . . . etc (corresponding to delays introduced by buffering experienced along the path over & beyond pure uncongested RTT or its estimate min(RTT), instead of packet drops indication event.
2. Once the ‘pause’ has counteddown, triggered by real congestion drop/s indications, above algorithms/schemes may be adapted so that CWND is now set to a value equal to the total outstanding in-flight-packets at this instantaneous ‘pause’ counteddown time (ie equal to latest largest forwarded SeqNo-latest
largest returning ACKNo)=>this would prevent a sudden large burst of packets being generated by source TCP, since during'pause ‘period’ there could be many returning ACKs received which could have very substantially advanced the Sliding Window's edge.

Also as an alternative example among many possible, CWND could initially upon the 3^{rd} DUP ACK fast retransmit request triggering ‘pause’ countdown be set to either unchanged CWND (instead of to ‘1*MSS’) or to a value equal to the total outstanding in-flight-packets at this very instance in time, and further be restored to a value equal to this instantaneous total outstanding in-flight-packets when ‘pause’ has counteddown [optionally MINUS the total number additional same SeqNo multiple DUP ACKS (beyond the initial 3 DUP ACKS triggering fast retransmit) received before ‘pause’ counteddown at this instantaneous ‘pause’ counteddown time (ie equal to latest largest forwarded SeqNo−latest largest returning ACKNo at this very instant in time)] [symbol] modified TCP could now stroke out a new packet into the network corresponding to each additional multiple same SeqNo DUP ACKs received during ‘pause’ interval, & after ‘pause’ counteddown could optionally belatedly ‘slow down’ transmit rates to clear intervening bufferings along the path IF CWND now restored to a value equal to the now instantaneous total outstanding in-flight-packets MINUS the total number additional same SeqNo multiple DUP ACKS received during ‘pause’, when ‘pause’ has counteddown.

Another possible example is for CWND initially upon the 3^{rd} DUP ACK fast

retransmit request triggering ‘pause’ countdown be set to ‘1*MSS’, and then be restored to a value equal to this instantaneous total outstanding in-flight-packets MINUS the total number additional same SeqNo multiple DUP ACKS when ‘pause’ has counteddown [symbol] this way when ‘pause’ counteddown modified TCP will not ‘burst’ out new packets but to only start stroking out new packets into network corresponding to subsequent new returning ACK rates
3. The above algorithm/scheme's ‘pause’ countdown global variable=minimum of (latest RTT of packet triggering the 3rd DUP ACK fast retransmit or triggering RTO Timeout−min(RTT), 300 ms) above, may instead be set=minimum of (latest RTT of packet triggering the 3rd DUP ACK fast retransmit or triggering RTO Timeout−min(RTT), 300 ms, max(RTT)), where max(RTT) is the largest RTT observed so far. Inclusion of this max(RTT) is to ensure even in very very rare unlikely circumstance where the nodes' buffer capacity are extremely small (eg in a LAN or even WAN), the ‘pause’ period will not be unnecessarily set to be too large like eg the specified 300 ms value. Also instead of above example 300 ms, the value may instead be algorithmically derived dynamically for each different paths.
4. A simple method to enable easy widespread implementation of ready guaranteed service capable network (or just congestion drops free network, &/or just network with much much less buffering delays), would be for all (or almost all) routers & switches at a node in the network to be modified/software upgraded to immediately generate total of 3 DUP ACKs to the traversing TCP flows' sources to indicate to the sources to reduce their transmit rates when the node starts to buffer the traversing TCP flows' packets (ie forwarding link now is 100% utilised & the aggregate traversing TCP flows' sources' packets start to be buffered). The 3 DUP ACKs generation may alternatively be triggered eg when the forwarding link reaches a specified utilisation level eg 95%/98% . . . etc, or some other trigger conditions specified. It doesn't matter even if the packet corresponding to the 3 pseudo DUP ACKs are actually received correctly at the destinations, as subsequent ACKs from destination to source will remedy this.

The generated 3 DUP ACKs packet's fields contain the minimum required source & destination addresses & SeqNo (which could be readily obtained by

inspecting the packet/s that are now presently being buffered, taking care that the 3 pseudo DUP ACKs' ACK field is obtained/or derived from the inspected buffered packet's ACKNo). Whereas the pseudo 3 DUP ACKs' ACKNo field could be obtained/or derived from eg switches/routers' maintained table of latest largest ACKNo generated by destination TCP for particular the uni-directional source/destination TCP flow/s, or alternatively the switches/routers may first wait for a destination to source packet to arrive at the node to then obtain/or derive the 3 pseudo DUP ACKs' ACKNo field from inspecting the returning packet's ACK field.

Similarly to above schemes, existing RED & ECN . . . etc could similarly have the algorithm modified as outlined above, enabling real time guaranteed service capable networks (or non congestion drops, &/or much much less buffer delays networks).

### 5. Another Variant Implementation on Windows:

first needs the module taking over all fast retransmit/RTO Timeout from MSTCP, ie MSTCP never ever sees any DUP ACKs nor RTO Timeout: the module will simply spoof acked every intercepted new packets from MSTCP (ONLY LATER: & where required send MSTCP ‘0’ window size update, or modify incoming network packets'
window size field to ‘0’, to pause/slow down MSTCP packets generations: upon congestion notifications eg 3 DUP ACKs or RTO Timeout). Module builds a list of SeqNo/packet copy/systime of all packets forwarded (well ordered in SeqNo) & do fast retransmit/RTO retransmit from this list. All items on list with SeqNo<current largest received ACK will be removed, also removed are all SeqNos SACKed.

Remember needs incorporate ‘SeqNo wraparound’ & ‘time wraparound’ protections in this module.

By spoofing acks all intercepted MSTCP outgoing packets, our windows software now doesn't need to alter any incoming network packets to MSTCP at all whatsoever . . . MSTCP will simply ignore all 3 DUP ACKs received since they are now already outside of the sliding window (being already acked!), nor will sent packets ever timedout (being already acked !)

further we can now easily control MSTCP packets generation rates at all times, via receiver window size fields changes . . . etc. Software could emulate MSTCP own Windows increment/Congestion Control/AIMD mechanisms, by allowing at any time a maximum of packets-in-flights equal to emulated/tracked MSTCP's CWND size: as an overview outline example (among many possible), this could be achieved eg assuming for each returning ACKs emulated/tracked pseudo-mirror CWND size is doubled in each RTT when there has not been any 3 DUP ACK fast retransmit, but once this has occurred emulated/tracked pseudo-mirror CWND size would only now be incremented by 1*MSS per RTT. Software would only ever allows a maximum of instantaneous total outstanding in-flight-packets not more than the emulated/tracked pseudo CWND size, & to throttle MSTCP packets generations via receiver window size update of ‘0’/modifying incoming packets' receiver window size to ‘0’ to ‘pause’ MSTCP transmissions when the pseudo-CWND size is exceeded.

This Window software could then keeps track of or estimate the MSTCP CWND size at all times, by tracking latest largest forwarded onwards MSTCP packets' SeqNo & latest largest network's incoming packets' ACKNo (their difference gives the total in-flight-packets outstanding, which correspond to MSTCP's CWND value quite very well). Window Software here just needs make sure it would stop ‘automatic spoof ACKs’ to MSTCP once total number of in-flight-packets>=above mentioned CWND estimate (or alternatively effective window size derived from above CWND estimate & RWND &/or SWND)

### 20 Dec. 2005 Filing

### VARIOUS REFINEMENTS & NOTES

Various refinements &/or adaptations to implementing earlier described methods could easily be devised, yet coming under the scope & principles earlier disclosed.

With Intercept Module (eg using Windows' NDIS or Registry Hooking, or eg IPChain in Linux/FreeBSD . . . etc), an TCP protocol modification implementation was earlier described which emulates & takes over complete responsibilities of fast retransmission & RTO Timeout retransmission from unmodified TCP itself totally, which necessitates the Intercept Module to include codes to handle complex recordations of Sliding Window's worth of sent packets/fast retransmissions/RTO retransmissions . . . etc. Here is further described an improved TCP protocol modification implementation which does not require Intercept Module to take over complete responsibilities of fast retransmission & RTO Timeout retransmission from unmodified TCP itself:

1 Intercept Module first needs to dynamically track the TCP's CWND size ie total in-flights-bytes (or alternatively in units of in-flights-packets), this can be achieved by tracking the latest largest SentSeqNo−latest largest ReceivedACKNo:
immediately after TCP connection handshake established, Intercept Module records the SentSeqNo of the 1^{st} packet sent & largest SentSeqNo subsequently sent prior to when ACKnowledgement for this 1^{st} packet's SentSeqNo is received back taking one RTT variable time period, the largest SentSeqNo—the 1^{st} packet's SentSeqNo now gives the flow's tracked TCP's dynamical CWND size during this particular RTT period. The next subsequent newly generated sent packet's SentSeqNo will now be noted (as marker for the next RTT period) as well as the largest SentSeqNo subsequently sent prior to when ACKnowledgement for this next marker packet's SentSeqNo is received back, the largest SentSeqNo—this next marker packet's SentSeqNo now gives the flow's tracked TCP's dynamical CWND size during this next RTT period. Obviously a marker packet's could be acknowledged by a returning ACK with ACKNo>the marker packet's SentSeqNo, &/or can be further deemed/treated to be ‘acknowledged’ if TCP RTO Timedout retransmit this particular marker packet's SentSeqNo again. This process is repeated again & again to track TCP's dynamic CWND value during each successive RTTs throughout the flow's lifetime, & an update record is kept of the largestCWND attained thus far (this is useful since Intercept Module could now help ensure there is only at most largestCWND amount of in-flights-bytes (or alternatively in units of in-flights-packets, at any one time). Note there are also various other pre-existing methods which tracks CWND value passively, which could be utilised.
   2 When there is a returning 3^{rd} DUP ACK packet intercepted by Intercept Module, Intercept Module notes this 3^{rd} DUP ACK's FastRmxACKNo & the total in-flights-bytes (or alternative in units of in-flights-packets) at this instant to update largestCWND value if required. During this duration when TCP enters into fast retransmit recovery phase, Intercept Module notes all subsequent same ACKNo returning multiple DUP ACKs (ie the rate of returning ACKs) & records MultACKbytes the total number of bytes (or alternatively in units of packets) representing the total data payload sizes (ignoring other packet headers . . . etc) of all the returning same ACKNo multiple DUP, before TCP exits the particular fast retransmit recovery phase (such as when eg Intercept Module next detects returning network packet with incremented ACKNo). In the alternative MultACKbytes may be computed from the total number of bytes (or alternatively in units of packets) representing the total data payload sizes (ignoring other packet headers . . . etc) of all the fast retransmitted packets DUP, before TCP exits the particular fast retransmit recovery phase . . . or some other devised algorithm calculations. Existing RFCs TCPs during fast retransmit recovery phase usually halved CWND value+fast retransmit the requested 1^{st} fast retransmit packet+wait for CWND size sufficiently incremented by each additional subsequent returning same ACKNo multiple DUP ACKs to then retransmit additional enqueued fast retransmit requested packet/s.

TCP is modified such that CWND never ever gets decremented regardless, & when 3^{rd} DUP ACK request fast retransmit modified TCP may (if desired, as specified in existing RFC) immediately forward onwards the very 1^{st} fast retransmit packet regardless of Sliding Window mechanism's constraints whatsoever, & then only allow fast retransmit packets enqueued (eg generated according to SACK ‘missing gaps’ indicated) to be forwarded onwards ONLY one at a time in response to each subsequent arriving same ACKNo multiple DUP ACKs (or alternatively a corresponding number of bytes in the fast retransmit packet queue, in response to the number of bytes ‘freed up’ by the subsequent arriving same ACKNo multiple DUP ACKs). When the fast retransmit recovery is exited (such as the returning network packet's ACKNo is now incremented, different from earlier 3^{rd} or further multiple DUP ACKNos), this will be the ONLY EXCEPTION CIRCUMSTANCE EVER whereby CWND would now be decremented by the number of bytes forwarded onwards from the fast retransmit packets queue (or decremented by the number of bytes ‘freed up’ by the subsequent arriving same ACKNo multiple DUP ACKs) [symbol] upon exiting fast retransmit recovery phase, modified TCP will not suddenly ‘surge’ out a burst of packets into network (due to eg the single returning network packet's ACKNo now acknowledges an exceptionally large number of received packets), & it is this very appropriate reduction of CWND value that does the better congestion control/avoidance mechanism more efficiently than existing RFCs. Similarly during RTO Timeout retransmissions, CWND is never decremented under any circumstances ever without any exceptions. Note during fast retransmit recovery phase, modified TCP ‘strokes’ out fast retransmit packets (&/or with lesser priority normal TCP generated packets queue if any) only in accordance/allowed by the rates of the returning ACKs.

### EXAMPLE

### Without Requiring Intercept Module Implementing Fast Retransmit/RTO Timeout Retransmit

Intercept Module Tracks Largest Observed CWND (Ie Total in-Flights-Bytes/Packets)
on 3^{rd} DUP ACK, Intercept Module follows with generation of multiple same ACKNo DUP ACKs, exact number of these could be eg such that it is a largest possible integer number*remote sender's TCP's SMSS=<total in-flight-bytes at the instant of the initial 3^{rd} DUP ACK triggering fast retransmit request being forwarded to resident RFC's TCP (note SMSS is the negotiated sender maximum segment size, which should have been ‘recorded’ by Receiver Side Intercept Software during the 3-way handshake TCP establishment stage, since existing RFC TCPs reduces CWND to CWND/2 on 3^{rd} DUP ACK fast retransmit request, to restore CWND size to be unhalved. TCP itself should now fast retransmit the 1^{st} requested packet, & only ‘stroke’ out any subsequent enqueued fast retransmit requested packets only at the same rate as the returning same ACKNo multiple DUP ACKS.
On TCP exiting fast retransmit recovery phase, Intercept Module again generates ACK divisions to inflate CWND back to unhalved value (note on exiting fast retransmit recovery phase TCP sets CWND to stored value of CWND/2)
   see http://www.cs.toronto.edu/syslab/courses/csc2231/05au/reviews/HTML/09/0007.html
similarly on RTO Timedout retransmit, Intercept Module could generate ACK divisions to inflate CWND back to same value (note on RTO Timedout retransmit TCP resets CWND to 1*SMSS)

### January 2006 Filing

### VARIOUS REFINEMENTS & NOTES

“. where all Receiver TCPs in the network are all thus modified as described above, Receiver TCPs could have complete control of the sender TCPs transmission rates via its total complete control of the same SeqNo series of multiple DUP ACKs generation rates/spacings/temporary halts . . . etc according to desired algorithms devised . . . eg multiplicative increase &/or linear increase of multiple DUP ACKs rates every RTT (or OTT) so long as RTT (or OTT) remains equal to or less than current latest recorded min(RTT) (or current latest recorded min(OTT))+variance (eg 10 ms to allow for eg Windows OS non-real time characteristics) . . . etc. . . . .”

Improvements were Added/Inserted (Underlined):

. . . [NOTE COULD ALSO INSTEAD OF PAUSING OR VARIOUS EARLIER CWND SIZE SETTING FORMULA, TO JUST SET CWND TO APPROPRIATE CORRESPONDING ALGORITHMICALLY DETERMINED VALUE/S! such as reducing CWND size (or in cases of closed proprietary source TCPs where CWND could not be directly modified, the value of largest SentSeqNo+its data payload length−largest ReceivedACKNo ie total in-flights-bytes (or in-flight-packets) must instead be ensured to be reduced accordingly eg by enqueing newly generated packets from MSTCP instead of forwarding them immediately) by factor of {latest RTT value (or OTT where appropriate)−recorded min(RTT) value (or min(OTT) where appropriate)}/min (RTT), OR reducing CWND size by factor of [{latest RTT value (or OTT where appropriate)−recorded min(RTT) value (or min(OTT) where appropriate)}/latest RTT value], OR setting CWND size (&/or ensuring total in-flight-bytes) to CWND (&/or total in-flight-bytes)*[1.000 ms/1,000 ms+{latest RTT value (or OTT where appropriate)−recorded min(RTT) value (or min(OTT) where appropriate)}] . . . etc ie CWND now set to CWND*[1−[{latest RTT value (or OTT where appropriate)−recorded min(RTT) value (or min(OTT) where appropriate)}/latest RTT value]], OR setting CWND size to CWND*min(RTT) (or min(OTT) where appropriate)/latest RTT value (or OTT where appropriate), OR setting CWND size (&/or ensuring total in-flight-bytes) to CWND (&/or total in-flight-bytes)*[1.000 ms/1.000 ms+{latest RTT value (or OTT where appropriate)−recorded min(RTT) value (or min(OTT) where appropriate)}] . . . etc depending on desired algorithm devised]. Note min (RTT) being most current estimate of uncongested RTT of the path recorded,”

Above latest RTT value (or OTT where appropriate), recorded min(RTT) value (or min(OTT) where appropriate), CWND size, total in-flight-bytes . . . etc refers to their recorded value/s as at the very moment of 3^{rd} DUP ACK fast retransmit request or at the very moment of RTO Timeout. Also instead & in place of effecting ‘pause’ in any of the earlier described methods/sub-component methods, the method/sub-component methods described may set CWND size (&/or ensuring total in-flight-bytes) to CWND (or total in-flight-bytes)*[1,000 ms/1,000 ms+{latest RTT value (or OTT where appropriate)−recorded min(RTT) value (or min(OTT) where appropriate)}]

It should be noted here 1 second is always the bottleneck link's equivalent bandwidth, & the latest Total In-flight-Bytes' equivalent in milliseconds is 1,000 ms+(latest returning 3^{rd} DUP ACK's RTT value or RTO Timedout value−min(RTT)) [symbol] Total number of In-flight-Bytes' as at the time of 3^{rd} DUP ACK or as at the time of RTO Timeout*1,000 ms/(1,000 ms+(latest returning 3^{rd} DUP ACK's RTT value or RTO Timedout value−min(RTT))} equates to the correct amount of in-flight-bytes which would now maintain 100% bottleneck link's bandwidth utilisation (assuming all flows are modified TCP flows which all now reduce their CWND size &/or all now ensure their total number of in-flight-bytes are now reduced accordingly, upon exiting fast retransmit recovery phase or upon RTO Timedout. During fast retransmit recovery phase, modified TCP may optionally after the initial 1^{st} fast retransmit packet is forwarded (this 1^{st} fast retransmit packet is always forwarded immediately regardless of Sliding Window constraints, as in existing RFCs) to ensure only 1 fast retransmit packet is ‘stroked’ out for every one returning ACK (or where sufficient cumulative bytes are freed by returning ACK/s to ‘stroke’ out the fast retransmit packet)

Note: Other Examples Implementation of NextGenTCP could Just:
1. modified TCP basically always at all times ‘stroke’ out a new packet only when an ACK returns (or when returning ACK/s cumulatively frees up sufficient bytes in Sliding Window to allow this new packet to be sent), unless
CWND incremented to inject ‘extra’ in-flight-packets as in existing RFC's AIM, or in accordance with some other designed CWND size &/or total in-flight-bytes increment/decrement mechanism algorithms.

Note ‘stroking’ out a new packet for every one of the returning ACKs (or when returning ACK/s cumulatively frees up sufficient bytes in Sliding Window to allow this new packet to be sent) will only generate a new packet to take the place of the ACKed packet which has now left the network, maintaining only the same present total amount of In-Flight-Bytes. Further if returning ACK's RTT is ‘uncongested’ ie if latest returning ACK's RTT=<min(RTT)+var (eg 10 ms to allow for Windows OS non-real time characteristics) then could increment present Total-In-Flight-Bytes by 1 packet's worth, in addition to the ‘basic’ stroking one out for every one returning ACK=>equivalent to Exponential Increase (can further be usefully adapted to eg one tenth increment per RTT eg increment inject 1 ‘extra’ packet for every 10 returning ACKs with uncongested RTTs).

2. Optionally either way, TCP never increases CWND size &/or ensures increase of total in-flight-bytes (exponential or linear increments) OR increases in accordance with specified designed algorithm (eg as described in immediate paragraph above) IF returning RTT<min(RTT)+var (eg 10 ms to allow for Windows OS non-real time characteristics), ELSE do not increment CWND &/or total in-flight-bytes whatsoever OR increment only in accordance with another specified designed algorithm (eg linear increment of 1*SMSS per RTT if all this RTT's packets are all acked).
1. Optional but much prefers, sets CWND &/or ensure total in-flight-bytes sets to recorded MaxUncongestedCWND immediately upon exiting fast retransmit recovery (ie an ACK now arrives back for a SeqNo sent after the 3rd DUP ACK triggering present fast retransmit) or upon RTO Timeout.

MaxUncongestedCWND, ie the maximum size of in-flight-bytes (or packets) during ‘uncongested’ periods, could be tracked/recorded as follows, note here total in-flight-bytes is different/not always same as CWND size (this is the traffics ‘quota’ secured by this particular TCP flow under total continuously ‘uncongested’ RTT periods):

Initialise min(RTT) to very large eg 3,000,000 ms

### Initialise MaxUncongestedCWND to 0

check each returning ACK's RTT:
IF RTT<recorded min(RTT) THEN min(RTT)=RTT
IF RTT=<min(RTT)+variance THEN IF (present LargestSentSeqNo+datalength)−present LargestACKNo (ie total amount of in-flight-bytes)>recorded MaxUncongestedCWND (must be for eg at least 3 consecutive RTT periods &/or at least for eg 500 ms period)
THEN recorded MaxUncongestedCWND=present LargestSentSeqNo+datalength−present LargestACKNo/*ie update CWND to the increased total number of in-flight-bytes, which must have endured for eg at least 3 consecutive RTT periods &/or at least for eg 500 ms period: this to ensure the increase is not due to ‘spurious’ fluctuations)*/

Instead of having to track MaxUncongestedCWND & reset CWND size &/or total in-flight-bytes to MaxUncongestedCWND we could instead just update record maximum of total in-flight-bytes (ie maximum largest SentSeqNo+datalength−largest ReceivedACKNo, which must have endured for eg at least 3 consecutive RTT periods &/or at least for eg 500 ms period) & ensure total in-flight-bytes is reset to eg {maximum largest SentSeqNo+datalength−largest ReceivedACKNo}*{1,000 ms/(1,000 ms+(latest returning ACK's RTT−latest recorded min(RTT))} . . . etc.

NextGenTCP/NextGenFTP now basically ‘stroke’ out packets in accordance with the returning ACK rates ie feedback from ‘real world’ networks.NextGenTCP/NextGenFTP may now specify/designed various CWND increment algorithm &/or total in-flight-bytes/packets constraints: eg based at least in part on latest returning ACKs RTT (whether within min(RTT)+eg 10 ms variance, or not), &/or current value of CWND &/or total in-flight-bytes/packets, &/or current value of MaxUncongestedCWND, &/or pastTCP states transitions details, &/or ascertained bottleneck link's bandwidth, &/or ascertained path's actual real physical uncongested RTT/OTT or min(RTT/min(OTT), &/or Max Window sizes, &/or ascertained network conditions such as eg ascertained number of TCP flows traversing the ‘bottleneck’ link &/or buffer sizes of the nodes along the path &/or utilisation levels of the link/s along the path, &/or ascertained user application types &/or ascertained file size to be transferred . . . or combination subsets thereof.

Eg when latest returning ACK is considered ‘uncongested’, & NextGenTCP/NextGenFTP has already previously experienced ‘packet drop/s event’, the increment algorithm injecting new extra packets into network may now increment CWND &/or total in-flight-bytes by eg 1 ‘extra’ packet for every 10 returning ACKs received (or increment by eg 1/10^{th} of the cumulative bytes freed up by returning ACKs), INSTEAD of eg exponential increments prior to the 1^{st} ‘packet drop/s event occurring . . . there are many many useful increment algorithms possible for different user application requirements.

This Intercept Software is based on implementing stand-alone fast retransmit &RTO Timeout retransmit module (taking over all retransmission tasks from MSTCP totally). This module takes over all 3DUP ACK fast retransmit & RTO Timeout responsibility from MSTCP, MSTCP will not ever encounter any 3^{rd} DUP ACK fast retransmit request nor experience any RTO Timeout event (an illustrative situation where this can be so is eg Intercept Software immediately ‘spoof acks’ to MSTCP whenever receiving new SeqNo packet/s from MSTCP: here MSTCP will exponentially increment its CWND until it reaches MIN [negotiated Max Receiver Window Size, negotiated Max Sender Window Size] & stays at this size continuously, Intercept Software could eg now just ‘immediately spoof ACKs’ to MSTCP so long as the total in-flights-packets (=LargestRecordedSentSeqNo−LargestRecordedACKNo)<MIN [advertised Receiver Window Size, negotiated Max Sender Window Size, CWND] or even some specified algorithmically derived size). By spoofing acks of all intercepted MSTCP outgoing packets, Intercept Software now doesn't need to alter any incoming network packets' fields value/s to MSTCP at all whatsoever . . . MSTCP will simply ignore all 3 DUP ACKs received since they are now already outside of the sliding window (being already acked!), nor will sent packets ever timedout (being already acked!). Further Intercept Software can now easily control MSTCP packets generation rates at all times, via receiver window size fields changes, ‘spoof acks’ . . . etc.

### Some Examples of Fast Retransmit Policy Considerations (Rule of Thumbs):

1. should cover fast retransmit with SACK feature enabled
2. Old Reno RFC specifies only one packet to be immediately retransmitted upon initial 3rd DUP ACK (regardless of Sliding Window/CWND constraint), WHEREAS NewReno with SACK feature RFC specifies one packet to be immediately retransmitted upon initial 3rd DUP ACK (regardless of Sliding Window/CWND constraint)+halving CWND+increment halved CWND by one MSS for each subsequent same SeqNo multiple DUP ACKs to enable possibly more than one fast retransmission packet per RTT (subject to Sliding Window/CWND constraints)

### An Example Fast Retransmit Policy (For Outline Purposes Only):

(a) one packet to be immediately retransmitted upon initial 3rd DUP ACK (regardless of Sliding Window/CWND/‘Pause’ constraint, since we don't have access to Sliding Window/CWND any way!)
(b) Any retransmission packets enqueued (as possibly indicated by SACK ‘gaps’) will be stroked out one at a time, corresponding to each one of the returning same SeqNo multiple DUP ACKs (or preferably where the returning same SeqNo multiple DUP ACKS' total byte counts permits . . . ). Any enqueued retransmission packets will be removed if SACKed by a returning same SeqNo multiple DUP ACKs (since acknowledged receipt). On returning ACKNo incremented, we can simply let these enqueued retransmission packets be priority stroked out one at a time, corresponding to each one of the returning normal ACKs (LATER: OPTIONALLY we can instead simply discard all enqueued retransmission packets, & start anew as in (a) above).

Some examples of the features which may be required in the Intercept Software:

1 Track SACK —remove SACKed entries from packet copies list (entries here also removed whenever ACKed): an easy implementation could be for every multiple DUP ACKS during fast retransmit recovery phase, if SACK flagged THEN remove all SACKed packet copies & remove all SACKed Fast Retransmit packets enqueued:
ie upon initial 3rd DUP ACK first note the pointer position of the present last packet copy entry & fast retransmit the requested 1st packet regardless, remove SACKed packet copies, enqueue all packet copies up to the noted present last packet copy in Fast Retransmit Queue, THEN for every subsequent multiple DUP ACKs first remove all SACKed entries in packet copies & Fast Retransmit Queue & ‘stroke’ out one enqueue fast retransmit packet (if any) for every returning multiple DUP ACK (or where returning multiple DUP ACK/s cumulatively frees up sufficient bytes).

Upon exiting fast retransmit recovery, discard the Fast Retransmit Queue but do not remove entries in the packet copies list.

3. Reassemble fragmented IP datagrams
4. Standard RTO calculation—RTO Timeout Retransmission calculations includes successive Exponential Backoff when same segment timeouted again, includes RTO min flooring 1 second, Not includes DUP/fast retransmit packet's RTT in RTO calculations (Karn's algorithm)
5. If RTO Timeouted during fast retransmit recovery phase==>exit fast retransmit recovery ie follows RFC's specification)
6. When TCPAcceleration.exe acking in the other direction with same SeqNo & no data payload (rare)==>needs handling (ie if ACK in the other direction has no data payload, just forward & needs not add to packet copies list.)
7. local system Time Wrapround protection (eg at midnight) & SeqNo wrapround protection whenever codes involve SeqNo comparisons.

To ensure Intercept Module only ever forward total number of in-flights-bytes=<MSTCP's CWND size=>needs to ‘passive track’ CWND size (eg generate SWND Update of ‘0’ immediately & set all incoming packet's SWND to ‘0’ during the required time, so MSTCP refrains from generating new packets. Note all received MSTCP packets continue to be ‘immediately spoof acked’ regardless, its the ‘0’ sender window size update that cause MSTCP to refrain):

“Intercept Module first needs to dynamically track the TCP's CWND size ie total in-flights-bytes (or alternatively in units of in-flights-packets), this can be achieved by tracking the latest largest SentSeqNo−latest largest ReceivedACKNo:
immediately after TCP connection handshake established, Intercept Module records the SentSeqNo of the 1st packet sent & largest SentSeqNo subsequently sent prior to when ACKnowledgement for this 1st packet's SentSeqNo is received back (taking one RTT variable time period), the largest SentSeqNo—the 1st packet's SentSeqNo now gives the flow's tracked TCP's dynamical CWND size during this particular RTT period. The next subsequent newly generated sent packet's SentSeqNo will now be noted (as marker for the next RTT period) as well as the largest SentSeqNo subsequently sent prior to when ACKnowledgement for this next marker packet's SentSeqNo is received back, the largest SentSeqNo—this next marker packet's SentSeqNo now gives the flow's tracked TCP's dynamical CWND size during this next RTT period. Obviously a marker packet's could be acknowledged by a returning ACK with ACKNo>the marker packet's SentSeqNo,
   &/or can be further deemed/treated to be ‘acknowledged’ if TCP RTO Timedout retransmit this particular marker packet's SentSeqNo again. This process is repeated again & again to track TCP's dynamic CWND value during each successive RTTs throughout the flow's lifetime, & an update record is kept of the largestCWND attained thus far (this is useful since Intercept Module could now help ensure there is only at most largestCWND amount of in-flights-bytes (or alternatively in units of in-flights-packets, at any one time). Note there are also various other pre-existing methods which tracks CWND value passively, which could be utilised.”

At sender TCP, estimate of CWND or actual inFlights can very easily be derived from latest largest SentSeqNo−latest largest ReceivedACKNo

Another example implementation outline improving the above:
Intercept Software should now ONLY ‘spoof next ack’ when it receives 3rd DUP ACKs (ie it first generates the next ack to this particular 3rd DUP packet's ACKNo (look up the next packet copies' SeqNo, or set spoofed ack's ACNo to 3^{rd} DUP ACK's SeqNo+DataLength), before forwarding onwards this 3rd DUP packet to MSTCP, & does retransmit from the packet copies), or ‘spoof next ack’ to the RTO Timedout's SeqNo (look up the next packet copies' SeqNo, or set spoofed ack's ACNo to 3^{rd} DUP ACK's SeqNo+DataLength) if eg 850 ms expired since receiving the packet from MSTCP (to avoid MSTCP timeout after 1 second). This way Intercept Software does not within few milliseconds immediately upon TCP connection cause CWND to reach max window size. Intercept Software now never ‘immediately’ spoof acks.
   /*now should really generate spoofed ACKNo>the 3rd DUP ACKNo, to pre-empt fast retransmit being triggered)*/
With this Corrections there is no longer any need at all to generate ‘0’ sender window updates nor set any incoming packet's SWND to ‘0’, since Intercept Software no longer indiscriminately ‘spoof acks’

With this Corrections there is also no longer any need at all to ‘passive track’ CWND size.

Intercept Sofware should upon 3rd DUP ACK immediately generate the 1st retransmit packet requested, (if SACK option) enqueue other indicated SACK ‘gap’ packets & forward one of these for each returning ACK during fast retransmit recovery (or alternatively if returning ACK frees up sufficient bytes): BUT now should simply just ‘discard’ any enqueued packets here immediately upon exiting fast retransmit recovery phase (ie when an ACK now arrives for a SeqNo sent after the 3rd DUP ACK triggered Fast Retransmit request)==>keeps everything simple robust. These packet copies remained on packet copies queue, if needed could always be requested to be retransmitted by a next 3rd DUP ACK.

Note: earlier implementation's existing already in place 3rd DUP ACK retransmit & RTO Timeout retransmit mechanism can remain as is, unaffected by Corrections (whether or not this RTO Timeout calculation differs from fixed 850 ms). Improvements just needs to ‘spoof next ack’ on 3rd DUP ACK or eg 850 ms timeout (earlier implementation's existing retransmission mechanism unaffected), ‘discard’ enqueue retransmission packets on exiting fast retransmit recovery, & forwarding DUP SEQNo packet (if any) without replacing packet copies.
And now this final layer/improvement modifications will add TCP Friendliness not just 100% bandwidth utilisation capability:
   1. Concept: NextGenTCP Intercept Software primarily ‘stroke’ out a new packet only when an ACK returns (or when returning ACK/s cumulatively frees up sufficient bytes in Sliding Window to allow this new packet to be sent), unless MSTCP CWND incremented & injects ‘extra’ new packets (after the very 1st packet drop event ie 3^{rd} DUP ACK fast retransmit request or RTO Timeout, MSTCP increments CWND only linearly ie extra 1*SMSS per RTT if all previous RTTs sent packets are all ACKed) OR Intercept Software algorithm injects more new packets by ‘spoof ack/s’.
   2. Intercept Software keeps track of present Total In-Flight-Bytes (ie largest SentSeqNo−largest ReceivedACKNo). All MSTCP packets are first enqueued in a ‘MSTCP transmit buffer’ before being forwarded onwards.

Only upon the very 1st packet drop event eg 3rd DUP ACKs fast retransmit request or RTO Timeout, Intercept Software does not ‘spoof next ack’ to pre-empt MSTCP's from noticing & react to such event==>MSTCP thereafter always' linear increment CWND by 1*SMSS per RTT if all this RTTs packets are all acked==>Intercept Software could now easily ‘step in’ to effect any ‘increment sizes’ via ‘immediate required # of spoof acks’ with successive as yet unacked SeqNos (after this initial 1st drop, Intercept Software continues with its usual 3rd DUP ACK or 850 ms ‘spoof next ack’).
3. Intercept Software now tracks min(RTT) ie latest best estimate of actual uncongested RTT of the source-destination pair (min(RTT) initialised to very large eg 30,000 ms & set min(RTT)=latest returning RTT if latest returning RTT<min(RTT)), & examine every returning ACK packet's RTT if=<min(RTT)+eg 10 ms variance (window's &/or network's real time variance allowance) THEN forward returning ACK packet to MSTCP & ensures present Total In-Flight-Bytes is incremented by an ‘extra’ packet's worth by immediately ‘spoof next ack’ the 1st enqueued ‘MSTCP transmit packet’s with ACKNo set to the next packet's SeqNo on the ‘maintained’ Packet Copies list or with ACKNo set to SeqNo+data length (or if none enqueued on the ‘MSTCP transmit queue’, then ‘spoof next ack’ the new MSTCP packet received in response to the latest forwarded returning ACK which only shifts Sliding Window's left ledge, note this will not immediately increment CWND if received after the initial Fast Retransmit). ie if returning ACK's RTT is ‘uncongested’ then could increment present Total-In-Flight-Bytes by 1 packet's worth, in addition to the ‘basic’ stroking one out for every one returning ACK==>this is equivalent to Exponential Increase (can further be usefully adapted to eg ‘one tenth’ increment per RTT eg increment inject 1 ‘extra’ packet for every 10 returning ACKs with ‘uncongested’ RTTs)

If returning ACK packet's RTT>min(RTT)+eg 10 ms variance (ie onset of congestions) THEN forward returning ACK packet to MSTCP & ‘do nothing’ since MSTCP would now generate a new packet in response to shift of Sliding Window's left edge & only increment CWND by 1*SMSS if all this RTT's packets are all acked: ie during congestions Intercept Software does not ‘extra’ increment present Total-In-Flight-Bytes on its own (MSTCP will only generate a new packet to take the place of the ACKed packet which has now left the network, maintaining the same present Total-In-Flight-Bytes)==>equivalent to Linear additive 1*SMSS increment per RTT if all this RTT's packets all acked.

4. Whenever after exiting fast retransmit recovery phase or after an RTO Timeout, will want to ensure Total In-Flight-Bytes is proportionally reduced (Note: Total In-Flight-Bytes could be different from MSTCP's CWND size!) to Total In-Flight-Bytes at the instant when the packet drop event occurs*[1,000 ms/(1,000 ms+(latest returning ACK's RTT−min(RTT))]: since 1 second is always the bottleneck link's equivalent bandwidth, & the latest Total In-flight-Bytes' equivalent in milliseconds is 1,000 ms+(latest returning ACK's RTT−min(RTT)). This is accomplished by eg generate & forward a ‘0’ window update packet (& also modifying all incoming network packets' Receiver Window Size field to ‘0’) to MSTCP during the required period of time, &/OR enqueuing a number of MSTCP newly generated packet/s in ‘MSTCP transmit queue’ UNTIL Total In-flight-Bytes=<Total In-Flight-Bytes at the instant when the packet drop event occurs*[1,000 ms/(1,000 ms+(latest returning ACK's RTT−min(RTT))]

Here is a variant NextGenTCP/NextGenFTP implementation (or direct modifications/code module add-ons to resident RFC's TCPs own source code itself) based on the immediately preceding implementations, with Intercept Software continues to:

1. Concept: NextGenTCP/NextGenFTP Intercept Software primarily ‘stroke’ out a new packet only when an ACK returns (or when returning ACK/s cumulatively frees up sufficient bytes in Sliding Window to allow this new packet to be sent), unless resident RFC's TCP's own CWND incremented & injects ‘extra’ new packets (after the very 1st packet drop event ie 3^{rd} DUP ACK fast retransmit request or RTO Timeout, resident RFC's TCP increments own CWND only linearly ie extra 1*SMSS per RTT if all previous RTT's sent packets are all ACKed) OR Intercept Software algorithm injects more new packets by ‘spoof ack/s’ (to resident RFC's TCP eg with ACKNo=present smallest ‘unacked’ sent SeqNo+this corresponding packet's datalength (or just simply+eg 1*SMSS . . . etc).
2. Intercept Software keeps track of present Total In-Flight-Bytes (ie largest SentSeqNo−largest ReceivedACKNo). Optionally, all resident RFC's TCP packets may or may not be first enqueued in a ‘TCP transmit buffer’ before being forwarded onwards.

Only upon the very 1st packet drop event eg 3rd DUP ACKs fast retransmit request or RTO Timeout, Intercept Software does not ‘spoof next ack’ to pre-empt resident RFC's TCP from noticing & react to such packet drop/s event==>MSTCP thereafter always ‘linear increment CWND by 1*SMSS per RTT if all the RTT's packets are all acked==>Intercept Software could now easily ‘step in’ to effect any ‘increment sizes’ via ‘immediate spoof ack/s’ whenever required eg after resident RFC's TCP fast retransmit & halves its own CWND size . . . &/or RTO Timeout resetting its own CWND size to 1*SMSS (after this initial 1st drop, Intercept Software thereafter ‘always’ continue with its usual 3rd DUP ACK &/or 850 ms ‘spoof next ack’, to always ‘totally’ prevent resident RFC's TCP from further noticing any subsequent packet drop/s event/s whatsoever). On receiving the resident RFC's TCP's retransmission packet/s in response to the only very initial 1^{st} packet drop/s event that it would ever be ‘allowed’ to notice & react to, Intercept Software could simply ‘discard’ them & not forward them onwards at all, since Intercept Software could & would have ‘performed’ all necessary fast retransmissions &/or RTO Timeout retransmissions from the existing maintained Packet Copies list.
2. Intercept Software now tracks min(RTT) ie latest best estimate of actual uncongested RTT of the source-destination pair (min(RTT) initialised to very large eg 30,000 ms & set min(RTT)=latest returning RTT if latest returning RTT<min(RTT)), & examine every returning ACK packet's RTT if=<min(RTT)+eg 10 ms variance (window's &/or network's real time variance allowance) THEN forward returning ACK packet to resident RFC's TCP & ensures present Total In-Flight-Bytes is incremented by an ‘extra’ packet's worth by immediately ‘spoof next ack’ the present 1st smallest sent ‘unacked’ packet's SeqNo (looking up the maintained ‘unacked’ sent Packet Copies list) with ACKNo set to the very next packet's SeqNo on the ‘maintained’ Packet Copies list or with ACKNo set to the 1^{st} smallest ‘unacked’ sent Packet Copy's SeqNo+its data length (or if none on the list, then as soon as possible immediately ‘spoof next ack’ any new resident RFC's TCP's packet received in response to the latest forwarded returning ACK which only shifts Sliding Window's left ledge which may or may not have immediately increment CWND if received after the initial Fast Retransmit ie if resident RFC's TCP is currently in ‘linear increment per RTT’ mode). ie if returning ACK's RTT is ‘uncongested’ then could increment present Total-In-Flight-Bytes by 1 packet's worth, in addition to the ‘basic’ stroking one out for every one returning ACK==>this is equivalent to Exponential Increase (can further be usefully adapted to eg ‘one tenth’ increment per RTT eg increment inject 1 ‘extra’ packet for every 10 returning ACKs with ‘uncongested’ RTTs). Intercept Software may optionally further ‘overrule’/prevents (whenever required, or useful ‘ eg if the current returning ACK's RTT>‘uncongested’ RTT or min(RTT)+tolerance variance . . . etc) the total in-flight-bytes from being incremented effects due to resident RFC TCP's own CWND ‘linear increment per RTT’, eg by introducing a TCP transmit queue where any such incremented ‘extra’ undesired TCP packet/s could be enqueued for later forwarding onwards when ‘convenient’, &/or eg by generating ‘0’ receiver window size update packet &/or modifying all incoming packets' RWND field value to ‘0’ during the required period.

Optionally, if returning ACK packet's RTT>min(RTT)+eg 10 ms variance (ie onset of congestions) THEN Intercept Software could just forward returning ACK packet/s to resident RFC's TCP &‘ do nothing’, since MSTCP would now generate a new packet in response to shift of Sliding Window's left edge & only increment CWND by 1*SMSS if all this RTT's packets are all acked: ie during congestions Intercept Software does not ‘extra’ increment present Total-In-Flight-Bytes on its own (resident RFC's TCP will only generate a new packet to take the place of the ACKed packet which has now left the network, maintaining the same present Total-In-Flight-Bytes)==>equivalent to Linear additive 1*SMSS increment per RTT if all this RTT's packets all acked.
3. Whenever after exiting fast retransmit recovery phase or after an RTO Timeout, will want to ensure Total In-Flight-Bytes is subsequently proportionally reduced to, & at the same time subsequently also able to be ‘kept up’ (Note: Total In-Flight-Bytes could be different from resident RFC's TCP's own CWND size!) to be the same as (but not more than) the Total In-Flight-Bytes at the instant when the packet drop event occurs*[1,000 ms/(1,000 ms+(latest returning ACK's RTT−min(RTT): since 1 second is always the bottleneck link's equivalent bandwidth, & the latest Total In-flight-Bytes' equivalent in milliseconds is 1,000 ms+(latest returning ACK's RTT−min(RTT)). This is accomplished by eg generate & forward a ‘0’ window update packet (& also modifying all incoming network packets' Receiver Window Size field to ‘0’) to resident RFC's TCP during the required period of time, &/or enqueuing a number of resident RFC's TCP's newly generated packet/s in ‘TCP transmit queue’ UNTIL Total In-flight-Bytes=<Total In-Flight-Bytes at the instant when the packet drop event occurs*[1,000 ms/(1,000 ms+(latest returning ACK's RTT−min(RTT))]
4. Intercept Software here simply needs to continuous track the ‘total’ number of outstanding in-flight-bytes (&/or in-flight-packet) at any time (ie largest SentSeqNo−largest ReceivedACKNo, &/or track &record the number of outstanding in-flight-packets eg by looking up the maintained ‘unacked’ sent Packet Copies list structure or eg approximate by tracking running total of all packets sent—running total of all ‘new’ ACKs received (ACK/s with Delay ACKs enabled may at times ‘count’ as 2 ‘new’ ACKs)), & ensures that after completion of packet/s drop/s events handling (ie after exiting fast retransmit recovery phase, &/or after completing RTO Timeout retransmission: note after exiting fast retransmit recovery phase, resident RFC's TCPs will normally halve its CWND value thus will normally reduce/restrict the subsequent total number of outstanding in-flight-bytes possible, & after completing RTO Timeout retransmission resident RFC's TCPs will normally reset CWND to 1*SMSS thus will normally reduce/restrict the total number of outstanding in-flight-bytes possible) subsequently the total number of outstanding in-flight-bytes (or in-flight-packets) could be allowed to be of same number (but not more) as this ‘calculated’ total number of In-Flight-Bytes at the instant when the packet drop event occurs*[1,000 ms/(1,000 ms+(latest returning ACK's RTT−min(RTT))]) (see preceding page's Paragraph 4), OR the total number of outstanding in-flight-packets could be allowed to be of same number (but not more) as this total number of In-Flight-Packets at the instant when the packet drop event occurs*[1,000 ms/(1,000 ms+(latest returning ACK's RTT−min(RTT))]), by immediately ‘Spoofing’ an ACK to resident RFC's TCPs with ACKNo=the present smallest ‘unacked’ sent SeqNo+total number of In-Flight-Bytes at the instant when the packet drop event occurs*[1,000 ms/(1,000 ms+(latest returning ACK's RTT−min(RTT))]
   (&/or alternatively successively immediately ‘Spoofing’ ACK to resident RFC's TCP with ACKNo=the present smallest sent ‘unacked’ SeqNo+this corresponding packet's datalength (a packet here would be considered to be ‘acked’ if ‘spoof acked’), UNTIL the present total number of in-flight-bytes (or in-flight-packet) had been ‘restored’ to total number of In-Flight-Bytes (or In-Flight-Packets) at the instant when the packet drop event occurs*[1,000 ms/(1,000 ms+(latest returning ACK's RTT−min(RTT))] (see preceding page's Paragraph 4).

Note this implementation keeps track of the total number of outstanding in-flight-bytes (&/or in-flight-packets) at the instant of packet drop/s event, to calculate the ‘allowed’ total in-flight-bytes subsequent to resident RFC's TCPs exiting fast retransmit recovery phase &/or after completing RTO Timeout retransmission & decrementing the CWND value (after packet drop/s event), & ensure after completion of packet drop/s event handling phase subsequently the total outstanding in-flight-bytes (or in-flight-packets) is ‘adjusted’ to be able to be ‘kept up’ to be the same number as the ‘calculated’ size eg by ‘spoofing an ‘algorithmically derived’ ACKNo’ to shift resident RFC’s TCP's own Sliding Window's left edge &/or to allow resident RFC's TCP to be able to increment its own CWND value, or successive ‘spoof next ack/s’ . . . etc.

Note the total in-flight-bytes may further subsequently be incremented by resident RFC's TCP increasing its own CWND size, & also by Intercept Software ‘injecting’ extra packets (eg in response to returning ACK's RTT=<‘uncongested’ RTT or min(RTT)+tolerance variance): Intercept Software may ‘track’ & record the largest observed in-flight-bytes size &/or largest observed in-flight-packets (Max-In-Flight-Bytes, &/or Max-In-Flight-Packets) since subsequent to the latest ‘calculation’ of ‘allowed’ total-in-flight-bytes (‘calculated’ after exiting fast retransmit recovery phase, &/or after RTO Timeout retransmission), and could optionally if desired further ‘always’ ensure the total in-flight-bytes (or total in-flight-packets) is ‘always’ ‘kept up’ to be same as (but not to ‘actively’ cause to be more than) this Max-In-Flight-Bytes (or Max-In-Flight-Packets) size eg via ‘spoofing an ‘algorithmically derived’ ACKNo’, to shift resident RFC's TCP's own Sliding Window's left edge &/or to allow resident RFC's TCP to be able to increment its own CWND value, or successive ‘spoof next ack/s’ . . . etc. Note this ‘tracked’/recorded Max-In-Flight-Bytes (&/or Max-In-Flight-Packets) subsequent to every new calculation of ‘allowed’ total in-flight-bytes (&/or in-flight-packets) may dynamically increments beyond the new ‘calculated allowed size, due to resident RFC's TCP increasing its own CWND size, & also due to Intercept Software's increment algorithm ‘injecting’ extra packets.
1. Optionally, during 3^{rd} DUP ACK fast retransmit recovery phase, Intercept Software tracks/records the number of returning multiple DUP ACKs with same ACKNo as the original 3^{rd} DUP ACK triggering the fast retransmit, & could ensure that there is a packet ‘injected’ back into the network correspondingly for every one of these multiple DUP ACK/s (or where there are sufficient cumulative bytes freed by the returning multiple ACK/s). This could be achieved eg:
   Immediately after the initial 3^{rd} DUP ACK triggering the fast retransmit is forwarded onwards to resident RFC's TCP, Intercept Software to then now immediately follow-on generate & forward to resident RFC's TCP an exact total number of multiple DUP ACKs with same ACKNo as the original 3^{rd} DUP ACK triggering the fast retransmit recovery phase. This exact number could eg be the total number of In-Flight-Packets at the instant of the initial 3^{rd} DUP ACK triggering the fast retransmit request/2 . . . OR this exact number could be eg such that it is a largest possible integer number*remote sender's TCP's SMSS=<total in-flight-bytes at the instant of the initial 3^{rd} DUP ACK triggering fast retransmit request being forwarded to resident RFC's TCP/2 (note SMSS is the negotiated sender maximum segment size, which should have been ‘recorded’ by Receiver Side Intercept Software during the 3-way handshake TCP establishment stage) . . . OR various other algorithmically derived number (this ensures resident RFC's TCP's already halved CWND size is now again ‘restored’ immediately to approximately its CWND size prior to fast retransmit halving), such as to enable resident RFC's TCP's own fast retransmit mechanism to be able to now immediately ‘stroke’ out a new retransmission packet for every subsequent returning multiple DUP ACK/s.

NOTE: In all, or some, earlier descriptions, the total number of outstanding in-flight-bytes were sometimes calculated as largest SentSeqNo−largest ReceivedACKNo, but note that in this particular context of total in-flight-bytes calculations largest SentSeqNo here should where appropriate really be referring to the actual largest sent byte's SeqNo (not the latest sent packet's SeqNo field's value! ie should really be [latest sent packet's SeqNo field's value+this packet's datalength]−largest ReceivedACKNo).

### Here is a Further Simplified Implementation Outline:

### VERSION SIMPLIFICATION

TCPAccelerator does not ever need to ‘spoof ack’ to pre-empt MSTCP from noticing 3rd DUP ACK fast retransmit request/RTO Timeout whatsoever, only continues to do all actual retransmissions at the same rate as the returning multiple DUP ACKs:
MSTCP halves its CWND/resets CWND to 1*SMSS and retransmit as usual BUT TCPAccelerator ‘discards’ all MSTCP retransmission packets (ie ‘discards’ all MSTCP packets with SeqNo=<largest recorded SentSeqNo)
==>TCPAccelerator continues to do all actual retransmission packets at the same rate as the returning multiple DUP ACKs+MSTCP's CWND halved/resets thus TCPAccelerator could now ‘spoof ack/s’ successively (starting from the smallest SeqNo packet in the Packet Copies list, to the largest SeqNo packet) to ensure/UNTIL total in-flight-bytes (thus MSTCP's CWND) at any time is ‘incremented kept up ’ to calculated ‘allowed’ size:
   At the beginning immediately after 3rd DUP ACK triggering MSTCP fast retransmit, TCPAccelerator immediately continuously ‘spoof ack’ successively (starting from the smallest SeqNo packet in the Packet Copies list, to the largest SeqNo packet) UNTIL MSTCP's now halved CWND value is ‘restored’ to (largest recorded SentSeqNo+its packet's data length)−largest recorded ReceivedACKNo at the time of the 3rd DUP ACK triggering fast retransmit==>MSTCP could ‘stroke’ out new packet/s for each returning multiple DUP ACK, if there is no other enqueued fast retransmit packet/s (eg when only 1 sent packet was dropped).
Note TCP Accelerator may not want to ‘spoof ack’ if doing so would result in total in-flight-bytes incremented to be >calculated ‘allowed’ in-flight-bytes (note each ‘spoof ack’ packets would cause MSTCP's own CWND to be incremented by 1*SMSS). Also alternatively instead of ‘spoof ack’ successively, TCP Accelerator could just spoof a single ACK packet with ACKNo field value set to eg (largest recorded SentSeqNo+its packet's data length at the time of the 3rd DUP ACK triggering fast retransmit−latest largest recorded ReceivedACKNo at the time of the 3rd DUP ACK triggering fast retransmit)/2, or rounded to the nearest integer multiple of 1*SMSS increment value/s which is eg=<calculated ‘allowed’ in-flight-bytes+latest largest recorded ReceivedACKNo.
   Upon exiting fast retransmit recovery phase, MSTCP sets CWND to SStresh (halved CWND)==>TCPAccelerator now continuously ‘spoof ack’ successively (starting from the smallest SeqNo packet in the Packet Copies list, to the largest SeqNo packet) UNTIL MSTCP's now halved CWND value is ‘restored’ to total in-flights-bytes when 3rd DUP ACK received*1,000 ms/(1,000 ms+(latest returning ACK's RTT when very 1st of the DUP ACKs received−recorded min(RTT))
Note TCP Accelerator may not want to ‘spoof ack’ if doing so would result in total in-flight-bytes incremented to be >calculated ‘allowed’ in-flight-bytes (note each ‘spoof ack’ packets would cause MSTCP's own CWND to be incremented by 1*SMSS). Also alternatively instead of ‘spoof ack’ successively, TCP Accelerator could just spoof a single ACK packet with ACKNo field value set to eg (largest recorded SentSeqNo+its packet's data length at the time of the 3rd DUP ACK triggering fast retransmit−latest largest recorded ReceivedACKNo at the time of the 3rd DUP ACK triggering fast retransmit)/2, or rounded to the nearest integer multiple of 1*SMSS increment value/s which is eg=<calculated ‘allowed’ in-flight-bytes+latest largest recorded ReceivedACKNo.
   Upon receiving MSTCP packet with SeqNo=<largest recorded SentSeqNo, in absence of 3rd DUP ACK triggering MSTCP fast retransmit, TCP Accelerator knows this to be RTO Timeouted retransmission==>TCPAccelerator immediately now continuously ‘spoof ack’ successively (starting from the smallest SeqNo packet in the Packet Copies list, to the largest SeqNo packet) UNTIL MSTCP's resetted CWND value is ‘restored’ to total in-flights-bytes when RTO Timeouted retransmission packet received*1,000 ms/(1,000 ms+(latest returning ACK's RTT prior to when RTO Timeouted retransmission packet ‘received−recorded min(RTT))
Note TCP Accelerator may not want to ‘spoof ack’ if doing so would result in total in-flight-bytes incremented to be >calculated ‘allowed’ in-flight-bytes (note each ‘spoof ack’ packets would cause MSTCP's own CWND to be incremented by 1*SMSS). Also alternatively instead of ‘spoof ack’ successively, TCP Accelerator could just spoof a single ACK packet with ACKNo field value set to eg (largest recorded SentSeqNo+its packet's data length at the time of the 3rd DUP ACK triggering fast retransmit−latest largest recorded ReceivedACKNo at the time of the 3rd DUP ACK triggering fast retransmit)/2, or rounded to the nearest integer multiple of 1*SMSS increment value/s which is eg=<calculated ‘allowed’ in-flight-bytes+latest largest recorded ReceivedACKNo
At all times (except during fast retransmit recovery phase) calculated ‘allowed’ in-flight-bytes size (thus MSTCP's CWND size) could be incremented by 1 if latest returning ACK packet's RTT<min(RTT)+eg 10 ms variance==>exponential CWND increments if ‘uncongested’ RTT, linear increment of 1*SMSS per RTT if ‘congested’ RTT.

Of course, TCPAccelerator should also at all times always ‘update’ calculated ‘allowed’ in-flight-size=Max [present calculated ‘allowed’ size’, (largest recorded SentSeqNo+datalength)−largest recorded ReceivedACKNo], since MSTCP may introduce ‘extra’ in-flight-bytes on its own. TCP Accelerator should also at all times immediately ‘spoof ack’ successively to ensure total-in-flight-bytes at all times is ‘kept up’ to the calculated ‘allowed’ in-flight-bytes.

Note a ‘Receiver Side’ Intercept Software could be implemented, adapting the above preceding ‘Sender Side’ implementations, & based on any of the various earlier described Receiver Side TCP implementations in the Description Body: with Receiver Side Intercept Software now able to adjust sender rates & able to control in-flight-bytes size (via eg ‘0’ window updates & generate ‘extra’ multiple DUP ACKs, withholding delay forwarding ACKs to sender TCP . . . etc)

Receiver Side Intercept Software needs also monitor/‘estimate’ the sender TCP's CWND size &/or monitor/‘estimate’ the total in-flight-bytes size &/or monitor/‘estimate’ the RTTs (or OTTs), using various methods as described earlier in the Description Body, or as follows:

1. ‘Receiver Side’ Intercept Module first needs to dynamically track the TCP's total in-flights-bytes per RTT (&/or alternatively in units of in-flights-packets per RTT), this can be achieved as follows (note in-flight-bytes per RTT is usually synonymous with CWND size):
(a)
see http://www.ieee-infocom.org/2004/Papers/33_{—}5.PDF “passive measurement methodology to infer and keep track of the values of two important variables associated with a TCP connection: the sender's congestion window (cwnd) and the connection round trip time (RTT)”
see http://www.cs.unc.edu/˜jasleen/notes/TCP-char.html “Infer a sender's congestion window (CWND) by observing passive TCP traces collected somewhere in the middle of the network. Estimate RTT (one estimate per window transmission) based on estimate of CWND. Motivation: Knowledge of CWND and RTT”
see http://www.pam2005.org/PDF/34310124.pdf “New Methods for Passive Estimation of TCP Round-Trip Times” where two methods to passively measure and monitor changes in round-trip times (RTTs) throughout the lifetime of a TCP connection are explained: first method associates data segments with the acknowledgments (ACKs) that trigger them by leveraging the bi-directional TCP timestamp echo option, second method infers TCP RTT by observing the repeating patterns of segment clusters where the pattern is caused by TCP self-clocking”
see Google Search term “tcp in flight estimation”

### &/OR

(b)
(i). simultaneous with the normal TCP connection establishment negotiation, Receiver Side Intercept Module negotiates & establishes another ‘RTT marker’ TCP connection to the remote Sender TCP, using ‘unused port numbers’ on both ends, & notes the initial ACKNo (InitMarkerACKNo) & SeqNo (InitMarkerSeqNo) of the established TCP connection (ie before receiving any data payload packet). This attempted ‘RTT maker’ TCP connection could even be to an ‘invalid port’ of at the remote sender (in which case Receiver Side Intercept Software would expect auto-reply from remote sender of ‘invalid port’), or further may even be to the same remote sender's port as the normal TCP connection itself (which Receiver Side Intercept Software should ‘refrain’ from sending any ‘ACK’ back if receiving data payload packet/s from remote sender TCP). Receiver Side Intercept Software notes the negotiated ACKNo (ie the next expected SeqNo from remote sender) & SeqNo (ie the present SeqNo of local receiver) contained in the 3^{rd} ‘ACK’ packet (which was generated & forwarded to remote sender) in the ‘sync-sync ack-ACK’ ‘RTT marker’ TCP connection establishment sequence, as MarkerInitACKNo & MarkerInitSeqNo respectively.
(ii). after the normal TCP connection handshake is established, Receiver Side Intercept Module records the ACKNo & SeqNo of the subsequent 1^{st} data packet received from remote sender's normal TCP connection when the 1^{st} data payload packet next arrives on the normal TCP connection (as InitACKNo & SeqNo). Receiver Side Intercept Module then generates an ‘RTT Marker’ packet with 1 byte ‘garbage’ data with this packet's Sequence Number field set to MarkerInitSeqNo+2 (or +3/+4/+5 . . . +n) to the remote ‘RTT marker’ TCP connection (Optionally, but not necessarily required, with this packet's Acknowledgement field value optionally set to MarkerInitACKNo).
(iii). Receiver Side Intercept Software continuously examine the ACKNo & SeqNo of all subsequent data packet/s received from remote sender's normal TCP connection when the data payload packet/s subsequently arrives on the normal TCP connection, and update records of the largest ACKNo value & SeqNo value observed so far (as MaxACKNo & MaxSeqNo), UNTIL it receives an ACK packet back on the ‘RTT marker’ TCP connection from the remote sender ie in response to the ‘RTT Marker’ packet sent in above paragraph:
   whereupon the total in-flight-bytes during this RTT could be ascertained from MaxACKNo+this latest arrived ACK packet's datalength−InitACKNo (which would usually be synonymous as the remote sender TCP's own CWND value), & whereupon Receiver Side Intercept Software now resets InitACKNo=MaxACKNo+this latest arrived ACK packet's datalength & generates an ‘RTT Marker’ packet with 1 byte ‘garbage’ data with this packet's Sequence Number field set to MarkerInitSeqNo+2 (or +3/+4/+5 . . . +n) to the remote ‘RTT marker’ TCP connection (Optionally, but not necessarily required, with this packet's Acknowledgement field value optionally set to MarkerInitACKNo) ie in similar adapted manner as described in Paragraph 1 of page 197 & page 198 of the Description Body & then again repeat the procedure flow loop at preceding Paragraph (iii) above.

Obviously the ‘RTT Marker’ packet could get ‘dropped’ before reaching remote sender or the remote sender's ACK in response to this ‘out-of-sequence’ received ‘RTT Marker’ packet could get ‘dropped’ on its way from remote sender to local receiver's ‘RTT Marker’ TCP, thus Receiver Side Intercept Software should be alert to such possibilities eg indicated by much lengthened time period than previous estimated RTT without receiving ACK back for the previous sent ‘RTT Marker packet to then again immediately generate an immediate replacement ‘RTT Marker’ packet with 1 byte ‘garbage’ data with this packet's Sequence Number field set to MarkerInitSeqNo+2 (or +3/+4/+5 . . . +n) to the remote ‘RTT marker’ TCP connection . . . etc.

The ‘RTT Marker’ TCP connection could further optionally have Timestamp Echo option enabled in both directions, to further improve RTT &/or OTT, sender TCP's CWND tracking &/or in-flight-bytes tracking . . . Etc.

Above Sender Based Intercept Software/s could easily be adapted to be Receiver Based, using various combinations of earlier described Receiver Based techniques &methods in the Description Body.

Here is one example outline among many possible implementations of a Receiver Based Intercept Software, adapted from above described Sender Based Intercept Software/s:

1. Receiver's resident TCP initiates TCP establishment by sending a ‘SYNC’ packet to remote sender TCP, & generates an ‘ACK’ packet to remote sender upon receiving a ‘SYNC ACK’ reply packet from remote sender. Its preferred but not always mandatory that large window scaled option &/or SACK option &/or Timestamp Echo option &/or NO-DELAY-ACK be negotiated during TCP establishment. The negotiated max sender window size, max receiver window size, max segment size, initial SeqNo & ACKNo used by sender TCP, initial SeqNo & ACKNo used by receiver TCP, and various chosen options are recorded/noted by Receiver Side Intercept Software.
1. Upon receiving the very 1^{st} data packet from remote sender TCP, Receiver Side Intercept Software records/notes this very initial 1^{st} data packet's SeqNo value Sender1stDataSeqNo, ACKNo value Sender1stDataACKNo, the datalength Sender1stDataLength. When receiver's resident TCP generates an ACK to remote sender acknowledging this very 1^{st} data packet, Receiver Side Intercept Software will ‘optionally discard’ this ACK packet if it is a ‘pure ACK’ or will modify this ACK packet's ACKNo field value (if it's a ‘piggyback’ ACK, &/or also even if it's a ‘pure ACK’) to the initial negotiated ACKNo used by receiver TCP (alternatively Receiver Side Intercept Software could modify this ACK packet's ACKNo to be ACKNo-1 if it's a ‘pure ACK’ or will modify this ACK packet's ACKNo (if it's a ‘piggyback’ ACK) to be ACKNo-1 (this very particular very 1^{st} ACK packet's ACK field's modified value of ACKNo-1, will be recorded/noted as Receiver1stACKNo: thus the costs to the sender TCP will be just ‘a single byte’ of potential retransmissions instead of ‘a packet's worth’ of potential retransmissions).
   All subsequent ACK packets generated by receiver's resident TCP to remote sender TCP will be intercepted Receiver Side Intercept Software to modify the ACK packet's ACKNo to be the initial negotiated ACKNo used by receiver TCP (alternatively to be Receiver1stACKNo) [symbol] thus it can be seen that after 3 such modified ACK packets (all with ACKNo field value all of initial negotiated ACKNo used by receiver TCP, or alternatively all of Receiver1stACKNo), sender TCP will now enters fast retransmit recover phase & incurs ‘costs’ retransmitting the requested packet or alternatively the requested byte.
   Receiver Side Intercept Software upon detecting this 3^{rd} DUP ACK being forwarded to remote sender will now generate an exact number of ‘pure’ multiple DUP ACKs (all with ACKNo field value all of initial negotiated ACKNo used by receiver TCP, or alternatively all of Receiver1stACKNo) to the remote sender TCP. This exact number could eg be the total number of In-Flight-Packets at the instant of the initial 3^{rd} DUP ACK being forwarded to remote sender TCP/2 . . . OR this exact number could be eg such that it is a largest possible integer number*remote sender's TCP's negotiated SMSS=<total in-flight-bytes at the instant of the initial 3^{rd} DUP ACK being forwarded to remote sender TCP/2 (note SMSS is the negotiated sender maximum segment size, which should have been ‘recorded’ by Receiver Side Intercept Software during the 3-way handshake TCP establishment stage) . . . OR various other algorithmically derived number (this ensures remote sender TCP's halved CWND size upon entering fast retransmit recovery on 3^{rd} DUP ACK is now again ‘restored’ immediately to approximately its CWND size prior to entering fast retransmit halving), such as to enable remote sender TCP's own fast retransmit recovery phase mechanism to be able to now immediately ‘stroke’ out a ‘brand new’ generated packet/s &/or retransmission packet/s for every subsequent returning multiple DUP ACK/s (or where sufficient cumulative ‘bytes’ freed by the multiple DUP ACK/s).
   Similar Receiver Side Intercept Software upon detecting/receiving retransmission packet (ie with SeqNo<latest largest recorded received packet's SeqNo from remote sender) from remote sender TCP, while remote sender TCP is not in fast retransmit recovery phase (ie this will correspond to the scenario of remote sender TCP RTO Timedout retransmit), will similarly now generate an exact number of ‘pure’ multiple DUP ACKs (all with ACKNo field value all of initial negotiated ACKNo used by receiver TCP, or alternatively all of Receiver1stACKNo) to the remote sender TCP. This exact number could eg be the total number of In-Flight-Packets at the instant of the retransmission packet being received from remote sender TCP−remote TCP's CWND reset value in packet/s (usually 1 packet, ie 1*SMSS bytes)*eg 1,000 ms/(1,000 ms+(RTT of the latest received RTO Timedout retransmission packet from remote sender TCP−latest recorded min(RTT)) . . . OR this exact number could be eg such that it is a largest possible integer number*remote sender's TCP's negotiated SMSS=<total in-flight-bytes at the instant of the retransmission packet being received from remote sender TCP*eg 1,000 ms/(1,000 ms+(RTT of the latest received packet from remote sender TCP which ‘caused’ this ‘new’ ACK from receiver TCP−latest recorded min(RTT)) (note SMSS is the negotiated sender maximum segment size, which should have been ‘recorded’ by Receiver Side Intercept Software during the 3-way handshake TCP establishment stage) . . . OR various other algorithmically derived number (this ensures remote sender TCP's reset CWND size upon RTO Timedout retransmit is now again ‘restored’ immediately to a calculated ‘allowed’ value), such as to enable remote sender TCP's own subsequent fast retransmit recovery phase mechanism to continue to be able to ensure subsequent total in-flight-bytes could be ‘kept up’ to the calculated ‘allowed’ value while removing bufferings in the nodes along the path, & thereafter once the bufferings in the nodes along the path have been eliminated to now enable receiver TCP to immediately ‘stroke’ out a ‘brand new’ generated packet/s &/or retransmission packet/s for every subsequent returning multiple DUP ACK/s (or where sufficient cumulative ‘bytes’ freed by the multiple DUP ACK/s). Optionally, Receiver Side Intercept Software may want to subsequently now use this received RTO Timedout retransmitted packet's SeqNo+its datalength as the new incremented ‘clamped’ ACKNo.

After the 3^{rd} DUP ACK has been forwarded to remote sender TCP to trigger fast retransmit recovery phase, subsequently Receiver Side Intercept Software upon generating/detecting a ‘new’ ACK packet (ie not a ‘partial’ ACK) forwarded to remote sender TCP (which when received at remote sender TCP would cause remote sender TCP to exit fast retransmit recovery phase), will now immediately generate an exact number of ‘pure’ multiple DUP ACKs (all with ACKNo field value all of initial negotiated ACKNo used by receiver TCP, or alternatively all of Receiver1stACKNo) to the remote sender TCP. This exact number could eg be the [{total inFlight packets (or trackedCWND in bytes/sender SMSS in bytes)/(1+curRTT in seconds eg RTT of the latest received packet from remote sender TCP which ‘caused’ this ‘new’ ACK from receiver resident TCP−latest recorded minRTT in seconds)}−total inFlight packets (or trackedCWND in bytes/sender SMSS in bytes)/2]
ie target inFlights or CWND in packets to be ‘restored’ to—remote sender TCP's halved CWND size on exiting fast retransmit (or various similar derived formulations) (note SMSS is the negotiated sender maximum segment size, which should have been ‘recorded’ by Receiver Side Intercept Software during the 3-way handshake TCP establishment stage) . . . OR various other algorithmically derived number (this ensures remote sender TCP's CWND size which is set to Sstresh value (ie halved original CWND value) upon exiting fast retransmit recovery on receiving ‘new’ ACK is now again ‘restored’ immediately to a calculated ‘allowed’ value), such as to enable remote sender TCP's own subsequent fast retransmit recovery phase mechanism to continue to be able to ensure subsequent total in-flight-bytes could be ‘kept up’ to the calculated ‘allowed’ value while removing bufferings in the nodes along the path, & thereafter once the bufferings in the nodes along the path have been eliminated to now enable receiver TCP to immediately ‘stroke’ out a ‘brand new’ generated packet/s &/or retransmission packet/s for every subsequent returning multiple DUP ACK/s (or where sufficient cumulative ‘bytes’ freed by the multiple DUP ACK/s).
Thereafter each forwarded modified ACK packet to the remote sender, will increment remote sender TCP's own CWND value by 1*SMSS, enabling ‘brand new’ generated packet/s &/or retransmission packet/s to be ‘stroked’ out correspondingly for every subsequent returning multiple DUP ACK/s (or where sufficient cumulative ‘bytes’ freed by the multiple DUP ACK/s) [symbol] ACKs Clocking is preserved, while remote sender TCP continuously stays in fast retransmit recovery phase. With sufficiently large negotiated window sizes, whole Gigabyte worth of data transfer could be completed staying in this fast retransmit recovery phase (Receiver Side Intercept Software here ‘clamps’ all ACK packets' ACKNo field value to all be of initial negotiated ACKNo used by receiver TCP, or alternatively all be of Receiver1stACKNo)
Further, instead of just forwarding each receiver TCP generated ACK packet/s modifying their ACKNo field value to all be the same ‘clamped’ value, Receiver TCP should only forward 1 single packet only when the cumulative ‘bytes’ (including residual carried forward since the previous forwarded 1 single packet) freed by the number of ACK packet/s is equal to or exceed the recorded negotiated remote sender TCP's max segment size SMSS. Note each multiple DUP ACK received by remote sender TCP will cause an increment of 1*SMSS to remote sender TCP's own CWND value. This 1 single packet should contain/concatenate all the data payload/s of the corresponding cumulative packet/s' data payload, incidentally also necessitating ‘checksums’ . . . etc to be recomputed & the 1 single packet to be re-constituted usually based on the latest largest SeqNo packet's various appropriate TCP field values (eg flags, SeqNo, Timestamp Echo values, options . . . etc).
Upon detecting that the cumulative number of ‘bytes’ remote sender TCP's CWND has been progressively incremented (each multiple DUP ACKs increments remote sender TCP's CWND by 1*SMSS) getting close to (or getting close to eg half . . . etc) the remote sender TCP's negotiated max window size, &/or getting close to Min [negotiated remote sender TCP's max window size (ie present largest received packet's SeqNo from remote sender+its data length−the last ‘clamped’ ACKNo field value used to modify all receiver TCP generated ACK packets' ACKNo field value, now getting close to (or getting close to eg half . . . etc) of the remote sender TCP's negotiated max window size), negotiated receiver TCP's max window size], Receiver Based Intercept Software will thereafter always use this present largest received packet's SeqNo from remote sender, or alternatively will thereafter always use this present largest received packet's SeqNo from remote sender+its datalength−1, as the new ‘clamped’ clamped’ ACKNo field value to be used to modify all receiver TCP/Intercept Software generated ACK packets' ACKNo field value . . . & so forth . . . repeatedly [symbol] upon receiving this initial first new ‘clamped’ ACKNo DUP ACKs remote sender TCP will exit present fast retransmit recovery phase setting its CWND value to Sstresh (ie halved CWND) thus Receiver Based Intercept Software will hereby immediately generate an ‘exact’ number of multiple DUP ACKs to ‘restore’ remote sender TCP's CWND value to be ‘unhalved’, & subsequently upon remote sender TCP receiving the ‘follow-on’ new ‘clamped’ ACKNo 3 DUP ACKs it will again immediately enter into another new fast retransmit recovery phase . . . & so forth . . . repeatedly.
Similarly, upon Receiver Side Intercept Software detecting that 3 new packets with out-of-order SeqNo have been received from remote sender (ie there is a ‘missing’ earlier SeqNo) Receiver Based Intercept Software will thereafter always use this present ‘missing’ SeqNo (BUT not to use this present largest received packet's SeqNo from remote sender+its datalength), as the new ‘clamped’ clamped’ ACKNo field value to be used subsequently to modify all receiver TCP/Intercept Software generated ACK packets' ACKNo field value . . . & so forth . . . repeatedly. Note Receiver Based Intercept Software will thereafter always use only this present ‘missing’ SeqNo as the new ‘clamped’ clamped’ ACKNo field value to be used subsequently to modify all receiver TCP/Intercept Software generated ACK packets' ACKNo field value, since Receiver Based Intercept Software here now wants the remote sender TCP to retransmit the corresponding whole complete packet indicated by this starting ‘missing’ SeqNo.
Note that DUP ACK/s generated by Receiver Side Intercept Software to remote sender TCP may be either ‘pure’ DUP ACK without data payload, or ‘piggyback’ DUP ACK ie modifying outgoing packet/s' ACKNo field value to present ‘clamped’ ACKNo value & recomputed checksum value.
Also while Receiver Side Intercept Software ‘clamped’ the ACKNo/s sent to remote sender TCP to ensure remote sender TCP is almost ‘continuously in fast retransmit recovery phase, Receiver Side Intercept Software should also ensure that remote sender TCP does not RTO Timedout because some received segment/s' with SeqNo >=‘clamped’ ACKNo would not be ACKed to the remote sender TCP:
Thus Receiver Side Intercept software should always ensure a new incremented ‘clamped’ ACKNo is utilised such that remote sender TCP does not unnecessarily RTO Timedout retransmit, eg by maintaining a list structure recording entries of all received segment SeqNo/datalength/local systime when received. Receiver Side Intercept Software would eg utilise a new incremented ‘clamped’ ACKNo, which is to be equal to the largest recorded segment's SeqNo on the list structure+this segment's datalength, & which not incidentally cause any ‘missing’ segment/s' SeqNo to be erroneously included/erroneously ACKed (this ‘missing’ segment/s' SeqNo is detectable on the list structure), whenever eg an entry's local systime when the segment is received+eg the latest ‘estimated’ RTT/2 (ie approx the one-way-trip time from local receiver to remote sender) becomes>=eg 700 ms (ie long before RFC TCPs' minimum RTO Timeout ‘floor’ value of 1,000 ms) . . . or according to various derived algorithm/s etc. All entries on the maintained received segments SeqNo/datalength/local systime when received list structure with SeqNo<this ‘new’ incremented’ ACKNo could now be removed from the list structure.
It is preferred that the TCP connection initially negotiated SACK option, so that remote TCP would not ‘unnecessarily’ RTO Timedout retransmit (even if the above ‘new’ incremented ACKNo scheme to pre-empt remote sender TCP from RTO Timedout retransmit scheme is not implemented): Receiver Side Intercept Software could ‘clamp’ to same old ‘unincremented’ ACKNo & not modify any of the outgoing packets' SACK fields/blocks whatsoever . . . .
2. Various of the earlier described RTT/OTT estimation techniques, &/or CWND estimation techniques (including Timestamp Echo option, parallel ‘Marker TCP’ connection establishment, inter-packet-arrivals, synchronisation packets . . . etc) could be utilised to detect/infer ‘uncongested’ RTT/OTT. Eg if parallel ‘Marker TCP’ connection technique is utilised ie eg periodically sending ‘marker’ garbage 1 byte packet with out-of-order successively incremented SeqNo to ‘elicit’ DUP ACKs back from remote sender TCP thus obtained ‘parallel’ RTT estimation [symbol] Receiver Based Intercept Software could now exert congestion controls eg increments calculated ‘allowed’ in-flight-bytes by eg 1*SMSS, and thus correspondingly inject ‘extra’ 1 single multiple ‘pure’ DUP ACK packet whenever 1 single ‘normal’ multiple ACK packet is generated (or whenever a number of ‘normal’ multiple ACK/s cumulatively ACKed 1*SMSS bytes ie corresponding to the received segment/s' total datalength/s on the maintained list structure of received segments/datalength/local systime when received) & forwarded to remote sender (as in Paragraph 2 above, or inject 1 single ‘extra’ multiple pure DUP ACK packet for every N ‘normal’ ACK packets/M*cumulative SMSS bytes forwarded to remote sender TCP . . . etc) & the RTTs/OTTs of all the packet/s (or eg the RTT/OTT of the ‘Marker TCP’ during this time period . . . etc) causing the generation of the 1 single ‘normal ACK are all ‘uncongested’ ie eg each of the RTTs=<min(RTT)+eg 10 ms variance.
   Of course, remote sender TCP may also on its own increments total in-flight-bytes (eg exponential increments prior to very initial 1^{st} packet loss event, thereafter linear increment of 1*SMSS per RTT if all sent packets within the RTT all ACKed), thus Receiver Side Intercept Software will always update calculated ‘allowed’ in-flight-bytes=Max[latest largest recorded ReceivedSeqNo+its datalength−latest new ‘clamped’ ACKNo], and could inject a number of extra’ DUP ACK packet/s during any ‘estimated’ RTT period to ensure the total in-flight-bytes is ‘kept up’ to the calculated ‘allowed’ in-flight-bytes.
   If Timestamp Echo option is also enabled in the ‘Marker TCP’ connection this would further enabled OTT from the remote sender to receiver TCP, also OTT from receiver TCP to remote sender TCP, to be obtained & also knowledge of whether any ‘Marker’ packet/s sent are lost. If SACK option is enabled in the ‘Marker TCP’ connection (without above Timestamp Echo option) this would enabled Receiver Based Intercept Software to have knowledge of whether any ‘Marker’ packet/s sent are lost, since the largest SACKed SeqNo indicated in the returning ‘Marker’ ACK packet's SACK Blocks will always indicate the latest largest received ‘Marker’ SeqNo from Receiver Based Intercept Software. Note however since there could only be up to 4 contiguous SACK blocks, may want to immediately use the indicated ‘missing’ gap ACKNo as the next scheduled ‘Marker’ packet's SeqNo whenever such ‘missing’ gap SACKNo is noticed, & continue using this first noticed indicated ‘missing’ gap ACKNo repeatedly alternately in next scheduled ‘Marker’ packet's SeqNo field (instead of, or alternately with the usual successively incremented larger SeqNo), UNTIL this ‘missing’ gap ACKNo is finally ACKed/SACKed in a returning packet from remote sender TCP.

The parallel ‘Marker TCP’ connection could be established to the very same remote sender TCP IP address & port from same receiver TCP address but different port, or even to an invalid port at remote sender TCP.

Note the calculated ‘allowed’ in-flight-bytes (ie based on 1,000 ms/1,000 ms+(RTT of the latest received packet from remote sender TCP which ‘caused’ this ‘new’ ACK from receiver TCP−latest recorded min(RTT))) could be adjusted in many ways eg*fraction multiplier (such as 0.9, 1.1 . . . etc), eg subtracted or added by some values algorithmically derived . . . etc. This calculated ‘allowed’ in-flight-bytes could be used in any of the described methods/sub-component methods in the Description Body as the Congestion Avoidance CWND's ‘multiplicative decrement’ algorithm on packet drop/s events (instead of existing RFC's CWND halving). Further this calculated ‘allowed’ in-flight-size/or CWND value could simply be fixed to be eg ⅔ (which would correspond to assuming fixed 500 ms buffer delays upon packet drop/s events), or simply be fixed to eg 1,000 ms/(1,000 ms+eg 300 ms) ie would here correspond to assuming fixed eg 300 ms buffer delays upon packet drop/s events.

Similarly many different adaptations could be implemented utilising earlier described ‘continuous receiver window size increments' techniques . . . , &/or utilising Divisional ACKs techniques &/or utilising ‘synchronising’ packets techniques, ‘inter-packets-arrival’ techniques, &/or large ‘scaled’ window size techniques, &/or Receiver Based ACKs Pacing techniques . . . etc, or various combinations/subsets therein. Direct modification of resident TCP source code would obviously renders the implementation much easier, instead of implementing as Intercept Software.

Were all, or a majority, of all TCPs within a geographical subset all implement simple modified TCP Congestion Avoidance algorithm (eg to increment calculated/updated ‘allowed’ in-flight-bytes & thus modified TCP to then increment inject ‘extra’ packet/bytes when latest RTT or OTT=<min(RTT)+variance, &/or to ‘do nothing additional’ when RTT or OTT>min(RTT)+variance, &/or to further decrement the calculated/updated calculated ‘allowed’ in-flight-bytes thus modified TCP to then subsequently ensure total in-flight-bytes does not exceed the calculated/updated ‘allowed’ in-flight-bytes . . . etc), then all TCPs within the geographical subset, including those unmodified RFC TCPs, could all experience better performances.

Further, all the modified TCP could all ‘refrain’ from any increment of calculated/updated allowed total in-flight-bytes when latest RTT or OTT value is between min(RTT)+variance and min(RTT)+variance+eg 50 ms ‘refrained buffer delay (or algorithmically derived period), then close to PSTN real time guaranteed service transmission quality could be experience by all TCP flows within the geographical subset/network (even for those unmodified RFC TCPs). Modified TCPs could optionally be allowed to no longer ‘refrain’ from incrementing calculated ‘allowed’ total in-flight-bytes if eg latest RTT becomes>eg min(RTT)+variance and min(RTT)+variance+eg 50 ms ‘refrained buffer delay (or algorithmically derived period), since this likely signify that there are sizeable proportion of existing unmodified RFC TCP flows within the geographical subset.

### Post March 2006

### VARIOUS IMPROVEMENTS & NOTES

### Sample Window Os TCPAcceleration Intercept Software Specifications:

SPECIFICATIONS just 2 simple stage: (once this straight forward 1ST STAGE coded & FTP confirmed working normally with this, 2ND STAGE Allowed In-Flights algorithm to be added will be next forwarded & very much easier)
1ST STAGE (only code to take over all RTO retransmit & fast retransmit): implement eg RawEther/NDIS/Winpkfilter Intercept to forward packets, maintaining all forwarded packets in Packet Copies list structure (in well ordered SeqNo sequence+SentTime field+bit field to mark the Packet Copy as having been retransmitted during any single particular fast retransmit phase). Only incoming actual ACKs (not SACK) will cause all Packet Copies with SeqNo<ACKNo to be removed
all incoming & all outgoing packets are forwarded onwards to MSTCP/Network COMPLETELY UNMODIFIED whatsoever
Upon detecting incoming 3rd DUPACK, immediately ‘spoof ack’ MSTCP with ACKNo=the SeqNo on Packet Copies list with the immediate next higher SeqNo (equiv to incoming ACKNo+the corresponding packet's datalength) BEFORE forwarding onwards the 3rd DUP ACK packet to MSTCP, so MSTCP never fast retransmit since never noticed any 3rd DUPACK (such 3rd DUP ACK when received by MSTCP will already be outside of sliding window's left edge, RFC specifies in such case for MSTCP to generate ‘0’ size data ACK packet to remote TCP)
   NOTE: during each single particular fast retransmit phase is triggered once incoming 3rd DUP ACK detected causing the DUPACKed SeqNo packet copy to be immediately retransmitted (+retransmit bit marked), IF SACK option enabled subsequent multiple DUP ACKs' (after the 3rd DUP ACK) SACK blocks will be examined to construct SACK gaps SeqNos list (new SACK gaps SeqNo to be added to this list) & cause any as yet unmarked Packet Copies to be retransmit forwarded immediately. When new ACK with higher ACKNo (than previous 3rd/multiple DUPACKNo) arrives, this will cause present particular fast retransmit phase to be EXITED (incidentally at the same time necessarily causing all Packet Copies with SeqNo<present new higher ACKNo to be removed, & all retransmit bit markers RESET)
NOTE (USEFUL SIMPLIFICATION): handling the very very rare RTO events (ie so MSTCP never needs RTO retransmit, nor ever notices them) would simply be to ‘spoof ack’ to MSTCP whenever Present Systime>any Packet Copies' SentTime+eg 0.8 seconds & immediately retransmit forward the Packet Copy, THEN resets the retransmit forwarded Packet Copies' SentTime to Present Systime (in case retransmitted RTOpacket lost again). 99.999% of the time fast retransmit will be triggered before the very very rare RTO. ==>this way subsequent to initial RTO retransmission, if RTO retransmit Packet again lost, TCPAccel with very conveniently (simplified) retransmit every 1 second expirations UNTIL acked!

ESSENTIAL: needs SeqNo wraparound checks throughout, & Time wraparound by simple referencing time from eg 1 Jan. 2006 00:00 hrs HERE is the complete 2ND STAGE Allowed—InFlights Algorithm (conceptually only 3 very simple rules) SPECIFICATIONS:
(preferable to also usefully have earlier Packet Copies list entry contains the packet datalength field)
   keeps track of latest largest SentSeqNo & latest largest ReceivedACKNo, InFlights_bytes=(latest largest SentSeqNo+this sent packet's datalength)−latest largest ReceivedACKNo
   latest best estimate of uncongested RTT, min(RTT), initialised to very large eg 99999 ms, & continually updated to be MINIMUM (min(RTT), latest incoming ACK's RTT)
   AI (Allowed_InFlights) upon TCP negotiated establishment initialised to 4*SMSS (as in latest experimental RFC, instead of 1*SMSS)
BEFORE any very 1st packet drops event (fast retransmit/RTO), AI=AI+number of bytes acked by incoming ACK (# acked=incoming ACKNo−latest largest previously recorded ReceivedACKNo) {this is equiv to existing RFC's exponential increment, before any very 1st packet drops event}
(AFTER very 1st packet drops event above): during normal mode (ie not fast retransmit phase or RTO retransmit), whenever incoming ACK's RTT<min(RTT)+eg 25 ms tolerance variance THEN
AI=AI+number of bytes ACKed by incoming ACK {this is equiv to exponential increment, whenever returning RTT close to the uncongested RTT value} ELSE AI=AI+bytes acked/AI) (this is equiv to linear increment per RTT}
during any fast retransmit phase, IF SACK option enabled then whenever latest incoming new higher SACKNo's RTT (higher than largest recorded previous SACKNo)<min(RTT)+eg 25 ms tolerance variance THEN AI=AI+number of bytes ACKed by incoming ACK {this is equiv to exponential increment, whenever returning new higher SACKNo's RTT value close to the uncongested RTT value}.
NOTE: if all 3 SACK blocks used up, then any further multiple DUPACKs will not convey any new higher SACKNo, THUS thereafter for every returning multiple DUPACKs AI should be conservatively incremented by SMSS/4 (equiv to exponential/4), ONLY IF AI was previously exponential incremented ie the very last new incoming SACKNo's RTT value was close to the uncongested RTT value.
   Immediately after exiting fast retransmit mode (ie triggered by a new incoming ACKNo>previous DUPACKNo), then set AI=MAXIMUM [4*SMSS, MINIMUM[InFlight_bytes at this time, AI/(1+latest RTT value−min(RTT))] {this works beautiful, exactly clearing all buffered packets along path, before resuming transmission==>ensured TCP FRIENDLINESS}
NOTE: should set AI (calculated allowed inFlights variable) to be lesser of inFlights at the time of exiting fast retransmit phase Or AI/(1+latest RTT value−minRTT), also ensures no sudden surge in packets forwarding caused immediately after exit fast retransmit phase. And latest RTT value may be chosen as either the recorded very 1^{st} DUPACK's RTT, or the recorded very 3^{rd} DUPACK's RTT, or even the recorded latest available incoming packet's RTT possible before exiting fast retransmit phase.
   Whenever AI>inFlights_bytes+to be forwarded packet's datalength THEN cause new packets to be injected into network {one implementation will be to have all packets to be forwarded (new MSTCP generated packets & also retransmit Packet Copies packet) first placed in a Transmit Queue in well ordered SeqNo (so lower SeqNo retransmission PacketCopies packet always placed at front).
IF Transmit Queue empty THEN ‘spoof ack’ MSTCP (with SPOOF ACKNo=the lowest as yet ‘unspoofed’ SeqNo from the Packet Copies list} to get MSTCP generate new higher SeqNo into Transmit Queue [BUT PREFERS using alternative specified methods ensuring eg min of 500 packets or CAI # of bytes . . . (or even have the entire source file's data all already in Transmit Queue doing away with need to spoof ack to generate new data packets) etc. . . . ALWAYS in Transmit Queue ready to be forwarded thus ensuring no spoof ack time delay issue arises]
Whenever AI=<inFlights+to be forwarded packet's datalength THEN do not allow any packets to be forwarded (keep them in Transmit Queue)
   from very beginning of fast retransmit 3rd DUPACK onwards, whether SACK option used or not:
(MOST ESSENTIAL) EXCEPTION: during fast retransmit throughout until exit (from very beginning & even after all 3 SACK blocks used up), MUST ALWAYS allows ensures 1 packet is forwarded (regardless of CAI value) from front of Transmit Queue for every returning multiple DUPACKs AND upon ensuring 1 packet is forwarded from front of Transmit Queue to then immediately now increment CAI by the data size of this forwarded packet! this way we get round the problem of not knowing actual # of bytes acked by each DUPACKs
this is correct since the very fundamental first principle is 1-for-1 stroking out (NOTE: when not in fast retransmit mode, returning higher ACKNo would reduce inFlights size causing corresponding number of bytes to be now allowed forwarded regardless of same CAI value). This 1-for-1 should be ensured throughout the whole period of fast retransmit (even if SACK option used & when all 3 SACK blocks subsequently used up)

OPTIONAL: 1 for 1 forwarding scheme during fast retransmit above may cause mass unnecessary retransmission packets drops at remote receiver TCP buffer, due to receiver TCP DUPACKing every arriving packets (even if dropped by remote's exhausted TCP buffer) [symbol] SOLUTION can be SIMPLY to SUSPEND 1 for 1 scheme operation IF remote's advertised RWND size stays <max negotiated rwnd*Div2

In some TCP implementations, looks like receiver TCP could possibly dupacks every arriving packets! even if dropped by ‘exhausted’ remote TCP buffer (completely filled by disjoint chunks)=>too many DUPACKs arriving back than expected (was expecting only DUPACKs to arrive only for packets non-dropped by receiver TCP buffer!?)
and also looks like even if remote tcp buffer completely filled exhausted (by disjoint chunks), arriving lower SeqNo retransmission packets needs be/would indeed be ‘specially received’ not discarded! otherwise no further packets could ever be accepted
At the same time IF SACK option used, then at the same time from very beginning of 3rd DUPACK onwards:
during any fast retransmit phase, IF SACK option enabled then whenever latest incoming new higher SACKNo's RTT (higher than largest recorded previous SACKNo)<min(RTT)+eg 25 ms tolerance variance THEN AI=AI+number of bytes ACKed by incoming ACK {this is equiv to exponential increment, whenever returning new higher SACKNo's RTT value close to the uncongested RTT value}.
NOTE: if subsequently all 3 SACK blocks used up, then any further multiple DUPACKs will not convey any new higher SACKNo, THUS thereafter for every returning multiple DUPACKs AI should be conservatively incremented by SMSS/4 (equiv to exponential/4), ONLY IF AI was previously exponential incremented ie the very last new incoming SACKNo's RTT value was close to the uncongested RTT value (this was already specified somewhere in earlier preceding sections . . . .)
Yes, we should exponential increment CAI to inject more inFlights if RTT near uncongested, this is in addition to the 1-for-1 incrementing CAI by size of front of Transmit Queue packet forwarded
EXTRA: could incorporate ‘rates pacing’ final layer (just prior to forwarding from Transmit Queue when CAI allows), which just ensures before next packet gets forwarded there is an interval elapsed=eg this packet's size in bytes*[minRTT/max recorded CAI in bytes]. Its well documented packets pacing does wonder pre-empts bunched packets surge causing mass drops.
AI increment unit size could be varied instead of AI=AI+bytes acked ie ‘exponential’ doubling every RTT, to instead be AI=AI+bytes acked/eg 2 (or 3 or 4 . . . etc) . . . etc according to some defined algorithms/various dynamic varying algorithms eg. states dependent variables dependent etc.
Further AI could be pre-empt from incrementing IF eg latest receiver advertised RWND<negotiated max RWND/eg 1.5 (or 1.05 or 2.0 or 4.0 etc) [symbol] this setting helps prevent received packets from being dropped at remote receiver TCP buffer due to remote TCP buffer exhaustions (could be over-filled buffering ‘disjoint packets chunks’ due to eg 1 in 10 packets dropped in network)
The tolerance variance value eg 25 ms, could be varied to eg 50 ms or 100 ms etc. This additional extra tolerance period could also be utilised to allow certain amount of bufferings to be introduced into the network path eg an extra 50 ms of tolerance value settings could introduce/allow 50 ms equiv of cumulative bufferings of packets along the path's nodes [symbol] this flow's ‘packets buffering along path’s nodes' is well known documented to help in improving end to end throughputs for the flow.

NOTE: TCPAccelerator could accept user input settings eg Div1 Div2 Var Var1 . . . etc, eg Div1 of 25% modifies exponential increment unit size to be 25% of existing CWND/CAI value per RTT, eg Div2 of 80% specifies that no CWND/CAI increments will be allowed whatsoever whenever remote tcp advertised RWND size stays <80%*max negotiated RWND, eg Var of 25 ms specifies that whenever returning ACK's RTT value<minRTT+eg 25 ms then increment CWND/CAI by # of bytes acked (ie equivalent to exponential increment per RTT), eg Var1 of 50 ms (Var1 commonly only used in proprietary network scenario) specifies that whenever returning ACK's RTT>minRTT+25 ms Var+50 ms Var1 then immediately reduce CWND or CAI to be =CWND or CAI/(1+curRTT−minRTT) to ensure source flows reduces rates to exactly clear all buffered packets along paths before resume sending again thus helps maintain PSTN transmission qualities within proprietary LAN/WAN.

Also particular flow/group of flows/type of flows could be assigned priority by setting their Var &/or Var1 values: eg smaller Var value settings implies lower priority assignment (since flows with higher Var value eg 40 ms would exponential increase their sending rates much faster than flows with lower Var value eg 25 ms). Also flows with higher Var1 value eg 100 ms has higher priority than flows with lower Var1 value eg 75 ms (since flows with lower 75 ms Var1 value would reduce their CWND/CAI value much sooner & much more often than flows with higher 100 ms Var1 value.

It already ‘perfectly’ distinguishes all congestion caused drops & physical non-congestion causes, ie for non-congestion drops NextGenTCP/FTP here simply does not reduce transmission rates as in existing RFC's TCP

In fact it helps avoids congestions by helping maintain all TCP flows to maintain constant near 100% bottleneck bandwidth usage at all times (instead of present AIMD which causes constant wasteful drops to 50% bottleneck bandwidth usage level & subsequent long slow climb back 100%)

VPN/IPSec, Firewalls, all pre-existing many specific web server/TCP customised optimisations . . . etc are no problem whatsoever & preserved, this fundamental TCP breakthroughs is completely transparent from their effects & works on a totally independent upper layer wrapper.

NextGenTCP/FTP overcomes existing 20 years old TCP protocol basic design flaws completely & very fundamentally (& not requiring any other network hardware component/s re-configurations or modification whatsoever), not complex cumbersome ways such as QoS/MPLS

one-click upgradesoftware here is increment deployable & TCP friendly, with immediate immense benefits even if yours is the only PC worldwide using NextGenTCP/FTP: moreover where subsequently there exists a majority of PCs within any geographical subset/s using NextGenTCP, the data transmissions within the subset/s could be made to become same as PSTN transmissions quality even for other non-adopters!

NextGenTCP Technology summary characteristics: could enable all packets (both raw data & audio-visual) to arrive well within perception tolerance time period 200 ms max from source to destination on Internet, not a single packet ever gets congested dropped

NextGenTCP is also about enabling next generation networks today—the ‘disruptive’ enabling technology will allow guaranteed PSTN quality voice, video and data to run across one converged proprietary LAN/WAN networks literally within minutes or just one-click installs overnight, NOT NEEDING multimillion pounds expensive new hardware devices and complicated softwares at each & every locations and 6 months timeframe QOS/MPLS complexed planning . . . etc

A very simplified crude implementation of above TCPAcceleration version could be to:
just set AI (calculated allowed inFlights) to constantly be eg 64 Kbytes/16 Kbytes . . . etc. This is based on/utilise the new discovery that CWND size once attained, no matter how arbitrary large, will not cause congestion packet drops (it's the momentary accelerative CWND increments like when CWND momentarily eg exponentially/linearly incremented that cause congestion drops).

This would only possibly incur very initial early congestion drops, but immediately after this initial early stage will not cause possible packets drop anymore. If required, could make AI to be growing from initial 1 Kbytes/4 Kbytes (experimental RFC initial CWND size) completely equivalent as in step with RFC CWND size algorithm, up to arbitrary size & always make AI to be same as the recorded latest largest attained value (optionally restricted to eg 64 Kbytes/16 Kbytes etc as required) [symbol] AI size will not now cause congestion packets drop on its own

This simplified implementation can do away with needs for many of the specified component implementation features.

### Sample Linux Source Code Implementation of Intercept Software: Outline Specifications

### Linux TCP Source Code Modifications

1. CWND is now never ever decremented (EXCEPT ONLY 1 special instance in paragraph 3)
   Note existing normal RFC TCP halves CWND upon 3^{rd} DUP ACK fast retransmit request, & resets CWND to 1*SMSS upon RTO Timeout.
   Its easy enough to use Windows desktop folder search string facility to show each & every
   occurrences of CWND variable in all the sub-folders, to make sure you don't miss any o these (there may be some similar folder search editing facility on Linux).
   Accomplishing this simply involves removing/commenting out all source code lines which decrements CWND variable.
   Note upon entering 3^{rd} DUP ACK fast retransmit mode (&/or upon RTO Timeout), normal TCP incidentally also sets SSThresh to eg ½*CWND, & we do not interfere with these Sstresh reductions whatsoever.
2. Normal RFC TCP only increments CWND upon

### While not in Fast Retransmit Mode:

(a) returned ACKs, which doubles CWND every RTT (ie increase CWND by latest returned ACKNo−recorded previous largest ACKNo, these values can be obtained from existing TCP source code implementation) if Ssthresh>CWND ie if before any very 1st occurrence of fast retransmit request or any very 1^{st} RTO Timeout

### OR

(b) returned ACKs, which linear increments CWND by 1*SMSS (sender's initial

negotiated Maximum Segment Size) per RTT if each & every sent SeqNo during this

RTT all returned ACKed: sometimes this linear increment is implemented in TCP source

code as eg [latest number of bytes ACKed/CWND or total in-flight-bytes before this latest

returning ACK)*SMSS] if Ssthresh=<CWND ie if after any very 1st occurrence of fast

retransmit request or any very 1^{st} RTO Timeout

/*NOTE: this is equivalent to linear increment of 1*negotiated SMSS per RTT*/

### While in Fast Retransmit Mode

(c) during fast retransmit phase, every returning multiple DUP ACKs (subsequent to the initial 3^{rd} DUP ACK triggering the current fast retransmit phase) increments CWND by 1*SMSS (some implementations assume Delay_ACK option activated, & increments by 2*SMSS instead)
   WE DO NOT ALTER (c) WHATSOEVER.

### (a) & (b) ARE TO BE COMPLETELY REPLACED BY:

IF latest returning ACK's RTT=<min(RTT)+eg 25 ms variance THEN CWND=
CWND+bytes ACKed by returning ACK packet
   /*NOTE this is equivalent to exponential increment per RTT*/
ELSE CWND incremented by (latest number of bytes ACKed/CWND or total in-flight-bytes
before this latest returning ACK)*SMSS
   /*NOTE this is equivalent to linear increment of 1*negotiated SMSS per RTT*/
NOTES:
   eg in the case of (a) this may simply just involve adding a test condition to existing source
   code lines before allowing CWND to be incremented as in the existing TCP source code, &
   in the case of (b) perhaps the existing source code really doesn't even needs any changes/
   modifications
      perhaps best to also ensure Sstresh initialised to arbitrary largest possible value & stays
      there throughout, ie Sstresh now never ever decremented/never ever changed at all, since
   modified CWND increment/decrement algorithm now never ever dependent on Sstresh
   value instead depends only on RTTs & min(RTT).
Needs make sure SSThresh value now does not ever interfere with CWND
increments/decrements logic, in normal RFC TCP Sstresh switches
program flows to linear increment/exponential increment code sections (?)
needs keeps track of min(RTT) ie smallest RTT observed in the particular per connection
flow so far, as current best estimate of actual ‘uncongested RTT’ of the particular per
connection flow.
This is simply accomplished by initialising min(RTT) to be 0 &
updating min(RTT)=MIN[min(RTT, latest returned ACK's RTT]
Needs not strictly use DOUBLE floating point accuracy (in deriving new CWND value
multiplied by floating point variable), possible to do so but could present some ‘extra’
work within Linux Kernel to do so. Other ways such as fixed fraction/fixed single floating
point . . . etc will do, & when deriving new CWND value always round to nearest Integer
TESTS on modifications should use SACK option enabled, & ‘NO DELAY ACK’ option.
3. WHENEVER exiting fast retransmit mode (ie a returned ACKNo which acknowledges a SeqNo sent or retransmitted after the initial 3^{rd} DUP ACK triggering current fast retransmit),
   SET CWND=1+/(RTT of the 3^{rd} DUP ACK which triggered current fast retransmit−Min(RTT))]
      THIS IS THE ONLY OCCASION IN MODIFIED LINUX TCP WHERE CWND IS EVER DECREMENTED
4. ONLY AFTER 1-3 above completed & made to be fully functioning Optional But Prefers:
   EVEN DURING FAST RETRANSMIT MODE:
   One packet must be forwarded for every subsequent returning multiple DUPACK packet/s, maintaining same inFlights bytes & ACKs Clocking, REGARDLESS of CWND value whatsoever. Note while in normal mode, every returning normal ACK would shift existing Sliding Window mechanism's left edge by # of bytes acked, thus allowing same # of bytes to now be forwarded maintaining inFlights bytes & ACKs clocking
   OPTIONAL: 1 for 1 forwarding scheme during fast retransmit above may cause mass unnecessary retransmission packets drops at remote receiver TCP buffer, due to receiver TCP DUPACKing every arriving packets (even if dropped by remote's exhausted TCP buffer) [symbol] SOLUTION can be SIMPLY to SUSPEND 1 for 1 scheme operation IF remote's advertised RWND size stays<max negotiated rwnd*Div2

In some TCP implementations, looks like receiver TCP could possibly dupacks every arriving packets! even if dropped by ‘exhausted’ remote TCP buffer (completely filled by disjoint chunks)=>too many DUPACKs arriving back than expected (was expecting only DUPACKs to arrive only for packets non-dropped by receiver TCP buffer!?)

and also looks like even if remote tcp buffer completely filled exhausted (by disjoint chunks), arriving lower SeqNo retransmission packets needs be/would indeed be ‘specially received’ not discarded! otherwise no further packets could ever be accepted

### FURTHER:

IF latest new largest SACKed packet's RTT=<min(RTT)+eg 25 ms variance THEN
CWND=CWND+bytes SACKed by returning multiple DUP ACK packet
   /*NOTE this is equivalent to exponential increment per RTT*/
[Optional] ELSE CWND incremented by (latest new largest SACKed packet's SeqNo−previous
Largest SACKed packet's SeqNo/CWND or total in-flight-bytes before this latest returning
ACK)*SMSS
   /*NOTE this is equivalent to linear increment of 1*negotiated SMSS per RTT*/
largest SACKed packet's SeqNo here should always be >=largest ACKed packet's SeqNo

NOTE: some TCP versions may implement algorithm ‘halving of CWND on entering fast retransmit’ by allowing forwarding of packets on every other incoming subsequent DUPACK, this is near equivalent BUT differs from usual implementation of actual halving of CWND immediately on entering fast retransmit phase.

### Miscellaneous:

Its very simplified compact, only about 3 very simple rules of thumbs all together

On exiting fast retransmit/completed RTO Timeout Retransmission: CWND=CWND*1/[1+(latest 3rd DUP ACK's RTT triggering current fast retransmit OR latest recorded RTT prior to RTO Timeout−min(RTT)]
works beautiful, ensuring modified TCP not transmitting exactly allows any buffered packets to be cleared up, before resumes sending out new packets.

RTT in units of seconds, ie RTT of 150 ms gives 0.150 in equation.

background to equation: 1 second ie 1 in equation corresponds to the bottleneck link's actual real physical bandwidth capacity, thus latest RTT of 0.6 & min(RTT) of 0.1 signifies path's cumulative buffer delays of 0.5 seconds
The equation used in implementation can be CWND=CWND*(1000/1000+(dupAckNo3_rtt_min_rtt) which is equivalent only that it uses units in milliseconds because they are easier to use inside the kernel.

### Overcome Remote Receiver Tcp Buffer Restriction on Throughputs

Even when the network path's bandwidth has not been fully utilised & more inFlights packets could be injected into link per RTT, remote receiver TCP buffer could already be placing upper limit on maximum TCP (& TCP like protocols RTP/RTSP/SCPS . . . etc) throughputs achievable long before, this is further REGARDLESS of arbitrary large settings of remote receiver TCP buffer size (negotiated max RWND size during TCP establishment phase).

In a scenario of 10% packet drops eg 1 packet gets dropped along network path for every 9 packets received at remote TCP, remote receiver TCP buffer would now need to buffer ‘disjoint SeqNo chunks’ each chunk here consisting of 9 continuous SeqNo packets & none of these chunks could be ‘removed’ from the TCP buffer onto receiver user applications UNTIL sender TCP fast retransmit the missing ‘gap’ SeqNos packets & then correctly received now at the receiver TCP (this takes at least 1 RTT time eg 200 ms) [symbol] maximum throughputs here would be limited to at most 3 disjoint chunks*9 packets per chunk*1/RTT of 0.2 sec+max of 3 received retransmission packets per RTT=137 packets per second, since existing RFC TCP's fast retransmission ONLY allows at most 3 SACK BLOCKS in SACK fields thus only at most 3 missing SACK Gaps SeqNo/SeqNo blocks retransmissions could requested for in a single RTT or in a single fast retransmit phase.

Remote receiver TCP buffering of ‘disjoint packets chunks’ (each chunk contains non-gap continuous SeqNo packets) here placed ‘very very low’ uppermost maximum possible throughputs along the path, REGARDLESS of arbitrary high unused bandwidths of the link/s, arbitrary high negotiated window sizes, arbitrary high remote receiver TCP buffer sizes, arbitrary high NIC forwarding rates . . . etc

To overcome above remote receiver TCP buffer's throughputs restrictions:

1. TCP SACK mechanism should be modified to have unlimited SACK BLOCKS in SACK field, so within each RTT/each fast retransmit phase ALL missing SACK Gaps SeqNo/SeqNo blocks could be fast retransmit requested. OR could be modified so that ALL missing SACK Gaps SeqNo/SeqNo blocks could be contained within pre-agreed formatted packet/s' data payload transmitted to sender TCP for fast retransmissions. OR existing max 3 blocks SACK mechanism could be modified so that ALL missing SACK Gaps SeqNos/SeqNo blocks could cyclical sequentially be indicated within a number of consecutive DUPACKs (each containing progressively larger value yet unindicated missing SACK Gaps SeqNos/SeqNo blocks) ie a necessary number of DUPACKs would be forwarded sufficiently to request all the missing SACK SeqNos/SeqNo blocks, each DUPACK packets repeatedly uses the existing 3 SACK block fields to request as yet unrequested progressively larger SACK Gaps SeqNos/SeqNo blocks for retransmission WITHIN same fast retransmit phase/same RTT period.

### AND/OR

2 Optional but preferable TCP be also modified to have very large (or unlimited linked list structure, size of which may be incremented dynamically allocated as & when needed) receiver buffer. OR all receiver TCP buffered packets/all receiver TCP buffered ‘disjoint chunks’ should all be moved from receiver buffer into dynamic arbitrary large size allocated as needed ‘temporary space’, while in this ‘temporary space’ awaits missing gap packets to be fast retransmit received filling the holes before forwarding onwards non-gap continuous SeqNo packets onwards to end user application/s.

### OR

Instead of above direct TCP source code modifications, an independent ‘intermediate buffer’ intercept software can be implemented sitting between the incoming network & receiver TCP to give effects to above foregoing (1) & (2).

A further sample example implementation of ‘intermediate buffer’ method but working in cooperation with earlier sender based TCPAccelerator software is as follows:
implement an unlimited linked list holding all arriving packets in well ordered SeqNo, this sits at remote PC situated between the sender TCPAccel & remote receiver TCP, does all 3rd DUP ACKs processing towards sender TCP (which could even just be notifying sender TCPAccel of all gaps/gap blocks, or unlimited normal SACK blocks) THEN forward continuous SeqNo packets to remote receiver MSTCP when packets non-disjointed)==>remote MSTCP now appears to have unlimited TCP buffer & mass drops problem now completely disappear.

For HEP (high energy physics) 100% utilisation receiver unlimited buffer (OUTLINE ONLY): needs ‘intermediate’ buffer which forwards ONLY continuous SeqNo to receiver TCP (thus receiver TCP would never notice any ‘drop packet/s’ whatsoever), & VERY SIMPLY generate all missing gap SeqNo in ‘special created packet’ towards sender TCPAccel (sender TCPAccel will ‘listen’ on eg special port 9999, or existing established TCP port using packet's with unique special identification field value, for such list of all missing gap SeqNo & retransmit ALL notified missing gap SeqNo from Packet Copies in one go) eg EVERY 1 second==>no complicated mechanism like 3rd DUPACK . . . etc.

Optional ‘Intermediate buffer’ should only forward continuous SeqNo towards receiver TCP, if receiver TCP's advertised rwnd>max negotiated rwnd/eg 1.25 to prevent any forwarding packets drops
an outline of efficient SeqNos well ordered ‘intermediate buffer’ (if needed to not impact performance for very large buffer):
1. STRCTURE: Intermediate Packets buffer, unlimited linked list. And Missing Gap SeqNos unlimited linked list each of which also contains ‘pointer’ to corresponding ‘insert’ location into Intermediate Packets buffer
2. keeps record of LargestBufferedSeqNo, arriving packets' SeqNo first checked if >LargestBufferedSeqNo (TRUE most of the times)
THEN to just straight away append to end of linked list (& if present LargestBufferedSeqNo+datasize<incoming SeqNo then ‘append insert’ value of LargestBiufferedSeqNo+datasize into end of MissingGapSeqNo list, update LargestBufferedSeqNo)
ELSE iterate through Missing Gap SeqNos list (most of the times would match the very front's SeqNo) place into pointed to Intermediate buffer location & ‘remove’ this Missing Gap SeqNos entry [EXCEPTION: if at anytime time while iterating, previous Missing Gap SeqNo<incoming SeqNo<next Missing Gap SeqNo (triggered when incoming SeqNo<current Missing Gap SeqNo) then ‘insert before’ into pointed to Intermediate buffer location BUT do not remove Missing Gap SeqNo. Also if incoming SeqNo>end largest Missing Gap SeqNo then ‘insert after’ pointed to Intermediate buffer location BUT also do not remove Missing Gap SeqNo. [eg scenario when there is a block of multiple missing gap SeqNos]
(LATER optional: check for erroneous/‘corrupted’ incoming SeqNo eg<smallest Missing Gap SeqNo) Similarly TCPAccel could Retransmit requested SeqNos iterating SeqNo values starting from front of Packets Copies (to first match smallest RequestedSeqNos) then continue iterating down from present Packet Copies entry location to match next RequestedSeqNo . . . & so forth UNTIL list of RequestedSeqNos all processed.
(Note: TCPAccel would only receive a ‘special created’ packet with ‘special identification’ field & all the RequestedSeqNos within data payload, every 1 second interval)
Its simpler for ‘intermediate buffer’ to generate packet with unique identification field value eg ‘intbuf’, containing list of all missing ‘gap’ SeqNos/SeqNo blocks using already established TCP connections, there are several port #s for a single FTP (control/data etc) & control channel may also drop packets requiring retransmissions.
the data payload could be just a variable number of 4 byte blocks each containing ascending missing SeqNos (or each could be preceded by a bit flag 0-single 4 byte SeqNo, 1-starting SeqNo & ending
   SeqNo for missing SeqNos block)
With TCPAccel & remote ‘intermediary buffer working together, path's throughputs will now ALWAYS show constant near 100% regardless of high drops long latencies combinations, ALSO ‘perfect’ retransmission SeqNo resolution granularity regardless of CAI/inFlights attained size eg 1 Gbytes etc:
   this is further expected to be usable without users needing to do anything reScaled Window Sizes registry settings whatsoever, it will cope appropriate & expertly with various bottleneck link's bandwidth sizes (from 56 Kbs to even 100000 Gbs! ie far larger than even large window scaled max size of 1 Gbytes settings could cope!) automatically, YET retains same perfect retransmission SeqNo resolution as when no scaled window size utilised eg usual default 64 Kbytes ie it can retransmit ONLY the exact 1 Kbytes lost segments instead of existing RFC1323 TCP/FTP which always need to retransmit eg 64,000×1 Kbytes when just a single 1 Kbyte segment is lost (assume max window scale utilised).
With ‘intermediate buffer’ incorporated at remote receiver & modified TCPAccel, sending TCP never noticed any drops & remote receiver TCP's rWnd buffer now never receives any disjoint chunks (thus remote receiver TCP now never sends 3rd DUP ACK whatsoever to sender TCPAccel).
Instead remote ‘intermediate buffer’ now should very simply just generate (at every 1 sec period) list of all gap SeqNos/SeqNo blocks>latest smallest receivedSeqNo to then generate list of all ‘gap’ SeqNo (in a special created packet's data content, whether via same already established TCP with special ‘identification’ field, or just straight forward UDP packet to special port # for sender TCPAccel)
seems like even when receiver TCP's advertised rwnd<max negotiated rwnd/eg 1.25 intermediate buffer then needs to at least forward just 1 packet every eg 100 ms (so intermediate buffer will not be stuck waiting for next rWnd update, which would otherwise never arrives again) to get update of rWnd>max negotiated rWnd/eg 1.25 for forwarding of continuous buffered SeqNo packets?
BUT not really, best ie can just at constant periodic 1 sec interval to simply forward all continuous buffered SeqNo packets, it doesn't matter if some or even majority gets dropped since this is internal PC bus forwarding & every 1 second forwarding of unacked continuous SeqNo packets will do very well (needs intercept remote TCP's outgoing packet to examine ACKNo field, to remove all acked SeqNo packets from ‘intermediate buffer’
   Yes, ‘intermediate buffer’ needs not eg detect 2 new incoming packets to send out list of all missing gap SeqNos: every 1 second is more than sufficient (since intermediate buffer could accommodate unlimited disjoint chunks)
   TCPAccel now needs not handle 3rd DUPACK (since remote MSTCP never noticed any ‘disjoint chunks’). TCPAccel will continue waits for remote TCP's usual ACK packets to then remove acked Packet Copies.

It should be noted that above remote receiver TCP buffer restricting maximum throughputs possible scenario (due to high packets drop rates eg 2%-50% scenario, which would be further excaberated with increasing path's RTT latencies eg 100 ms-500 ms) would likely ever only occurs over external public Internet very occasionally, BUT unlikely to be a restricting factor within proprietary LAN/WAN where all the TCP flows/UDP flows/RTP/RTSP/DCCP had been modified accordingly OR where any unmodified such flows had been shielded within the networks (eg link/s given appropriately lower/lowest priority QoS forwarding, smaller ‘pause’ timeout threshold value settings, smaller tolerance variance values settings, smaller AI Allowed InFlights increments unit size . . . etc). Such modified proprietary LAN/WAN/external Internet segments would not likely experience drop rates higher than 0.1% to 1% at any time, & could easily not need to implement above described ‘intermediate buffer’ scheme at remote receiver TCP/remote receiver Intercept Software.

Adapting External Public Internet Increment Deployable AI (Allowed inFlights Scheme) Scheme's Windows TCPAccelearation/Linux Modifications, To Provide Proprietary LAN/WAN/External Internet Segments with Instant Guaranteed PSTN Transmission Qualities

The various earlier described external public Internet increment deployable TCP modifications (AI: allowed inFlights scheme, with or without ‘intermediate buffer’ scheme) could very readily be adapted to be install in all network nodes/TCP sources within proprietary LAN/WAN/external Internet segments, providing instant guaranteed PSTN transmission qualities among all nodes requiring real time critical deliveries, requires only one additional refinement here (also assuming all, or majority of sending traffics sources' protocols are so modified:

at all times (during fast retransmit phase, or normal phase, if incoming ACK's/DUPACAK's RTT (or OTT)>min RTT (or minOTT)+tolerance variance eg 25 ms+optionally additional threshold eg 50 ms THEN immediately reduce AI size to AI/(1+latest RTT or latest OTT where appropriate−minRTT or minOTT where appropriate) [symbol] total AI allowed inFlights bytes from all modified TCP traffic sources most of the times would never ever cause additional packet delivery latency (of eg 25 ms+optional 50 ms here) BEYOND the absolute minimum uncongested RTT/uncongested OTT. After reduction CAI will stop forwarding UNTIL sufficient number of returning ACKs sufficiently shift sliding window's left edge! We do not want to overly continuously reduce CAI, so this should happen only if total extra buffer delays>eg 25 ms+50 ms.

Also CAI algorithm should be further modified to now not allow to ‘linear increment’ (eg previously when ACKs return late thus ‘linear increment’ only not ‘exponential 8increment’) WHATSOEVER AT ANYTIME if curRTT>minRTT+eg 25 ms, thus enabling proprietary LAN/WAN network flows to STABILISE utilise near 100% bandwidths BUT not to cause buffer delays to grow beyond eg 25 ms.

Allowing linear increments (whenever ACK returns even if very very late) would invariably cause network buffer delays to approach maximum, destroys realtime critical deliveries.

NOTE: THIS IS SIMPLE ADAPTATION OF external Internet increment deployable earlier software, BUT simple adapted to ENABLE immediate PSTN quality transmission quality (no longer just good throughputs over external Internet as in earlier software) in proprietary LAN/WAN for eg realtime critical Telemedicine/VoIP. Needs to install in all or majority of PCs within proprietary LAN/WAN/Test Subnet.

Above AI allowed inFlights threshold tests, or other devised threshold dynamic algorithm based in part on above, could very usefully be adopted to improve streaming RTP/RTSP/SCPS/DCCP/Reliable UDP/or within user streaming/VoIP applications, to enable adjustment switching to lower encoding/sending rates according to network conditions ENABLING much better congestion controls with much less packets drops much closer to PSTN transmission qualities deliveries of packets . . . etc, clearly much much better than existing proposed self-regulating congestion control proposal scheme based on eg TFRC (TCP friendly RealTime Congestion Control) type. The effects will be astounding were all or majority of existing UDP/RTP/RTSP/SCPS/DCCP external public Internet streamers adopt AI schemes. Various priorities hierarchy could be achieved by setting different

NextGenTCP/FTP TCPAccelerator methods can also be adapted/applied to other protocols:
in particular the concept of CAI (calculated allowed in-Flights) can be applied to all flows eg TCP & UDP & DCCP & RTP/RTSP & SCPS . . . etc together at the same time (data, VoIP, Movie Streams/Downloads . . . etc) where application can increase CAI/inFlights as in TCPAccelerator (optional not increment CAI/inFlights once RTT/OTT shows initial onset of buffering congestion delay component of eg 25 ms, if all traffics so adapted, &/OR re-allows CAI/inFlights increments once buffer congestion delay components further exceeds a higher upper threshold eg >75 ms which indicates strong presence of other unmodified traffics).

Hence all UDPs can now utilise constant near 100% bandwidths, no drops or much less drops & fair to all traffics, nearer PSTN quality most of the times. AND increment deployable over external Internet. Were all or majority of sending traffic sources' protocols (UDP/DCCP/RTP/RTSP/SCPS/TCP over UDP/TCP etc) so modified adapted re Allowed InFlights control/management, all traffics within network/LAN/WAN/external Internet/Internet subsets will STABILISE at near 100% bandwidths utilisations &/or PSTN transmission quality packets delivery. Were there strong presence of illegal aggressive UDPs on the external Internet path, could just not relinquished recorded historical attained max CAI/inFlights size which had been attained under any of earlier non-congested eg introduced buffer delays <25 ms (OR non-drop eg introduced buffer delays could be arbitrary large so long as packet/s were not dropped) periods similar to

existing TCPAccelerator scheme which could very easily just ADDITIONALLY at all times continuously detect curRTT>minRTT+eg var 25 ms (&/or +eg 35 ms threshold) ie initial very onset of packets being buffered events to then instantly immediately reduce CAI/inflights to eg CAI/1+curRTT−minRTT (as in TCPAccelerator on exiting fast retransmit)=>with all LAN/WAN/Network traffics thus modified attained instant guaranteed service capable PSTN quality networks. OR similar to existing TCPAccelerator scheme which could very easily just ADDITIONALLY at all times continuously detect ‘congestion caused’ packet drops event (ie buffer exhaustion drops of physical transmissions bits error), usually indicated by 3^{rd} DUP ACKs fast retransmission requests &/or RTO retransmission timeout, to then reduce CAI/actual inFlights sizes/CWND values.

CAI/actual inFlights sizes/CWND values above could be incremented were above returning RTTs' within specified threshold value/s, eg incremented by # of bytes acked (exponential) OR by 1*SMSS per RTT (linear) OR according various devised dynamic algorithms [symbol] total of all flows CAIs/actual inFlights sizes/CWNDs will together STABILISE giving constant near 100% network's bandwidths utilisations (hence ideal throughputs performances for all flows)

Depending on the desired network performance or increment deployable individual flow's performance, the inFlights/CWND congestion control scheme to be added to all conformant flows (UDP/DCCP/RTP/RTSP/SCPS/TCP/TCP over UDP etc) may specify eg:

1. to enable just constant near 100% bottleneck link utilisation throughputs, CAI/actual inFlights/CWND could be reduced to eg CAI/1+curRTT−minRTT whenever packet drops events (usually indicated by 3^{rd} DUP ACKs fast retransmit requests or RTO timeout retransmission or NACK or SNACK etc)
2. to enable constant near 100% bottleneck link utilisation throughputs AND PSTN transmission quality packets deliveries, CAI/actual inFlights/CWND could be instantly immediately reduced to eg CAI/1+curRTT−minRTT whenever very initial onset of packets buffering detected (introduced packet buffer delay>eg 25 ms &/or +eg 35 ms . . . etc according various devised dynamic algorithms).
3. As in either (1) or (2) above, but whenever CAI/actual inFlights sizes/CWND gets reduced accordingly as in (1) or (2) above, the resultant reduced CAI/actual inFlights sizes/CWND will not be reduced below their recorded attained historical maximum size values (can be specified to be either attained during any earlier non-congested periods eg introduced buffer delays <25 ms, Or during any earlier non-drops periods ie periods where all packets delivered without being dropped), or their recorded attained historical maximum sizes*eg 90% etc according to some devised dynamic algorithms (to allow subsequent new flows to slowly obtains/increases their required bandwidths in orderly manner) [symbol] this helps maintain ‘already pre-established earlier flow’ to maintain their attained fair-share of network's bandwidth, subsequent new flows will need to ‘cab rank’ in orderly manner, similar to existing PSTN telephone ‘cab rank’ systems familiar to all.

NOTE: TCPAccelerator could accept user input settings eg Div1 Div2 Var Var1 . . . etc, eg Div1 of 25% modifies exponential increment unit size to be 25% of existing CWND/CAI value per RTT, eg Div2 of 80% specifies that no CWND/CAI increments will be allowed whatsoever whenever remote tcp advertised RWND size stays <80%*max negotiated RWND, eg Var of 25 ms specifies that whenever returning ACK's RTT value<minRTT+eg 25 ms then increment CWND/CAI by # of bytes acked (ie equivalent to exponential increment per RTT), eg Var1 of 50 ms (Var1 commonly only used in proprietary network scenario) specifies that whenever returning ACK's RTT>minRTT+25 ms Var+50 ms Var1 then immediately reduce CWND or CAI to be =CWND or CAI/(1+curRTT−minRTT) to ensure source flows reduces rates to exactly clear all buffered packets along paths before resume sending again thus helps maintain PSTN transmission qualities within proprietary LAN/WAN.

Also particular flow/group of flows/type of flows could be assigned priority by setting their Var &/or Var1 values: eg smaller Var value settings implies lower priority assignment (since flows with higher Var value eg 40 ms would exponential increase their sending rates much faster than flows with lower Var value eg 25 ms). Also flows with higher Var1 value eg 100 ms has higher priority than flows with lower Var1 value eg 75 ms (since flows with lower 75 ms Var1 value would reduce their CWND/CAI value much sooner & much more often than flows with higher 100 ms Var1 value. Eg time critical VoIP/streamings could be assigned higher priority settings than non-critical TCP/UDP data flows.

TCP Offloads, LAN/WAN Ethernet switches, Internet Ingress Edge routers could implement above Allowed inFlight size scheme for each & every flows, thus end applications could be relieved of implementing the same.

UDP on itself & some other protocols doesn't provide ACK/SACK/NACK/SACK/SNACK etc (unlike TCP/DCCP/RTP/RTSP/SCPS/TCP over UDP etc), but many end applications which utilise UDP . . . etc as underlying transport already does routinely incorporate within receiver side end applications ACK/NACK/SACK/SNACK etc as some added congestion control controls ie its now possible to determine total inFlights packets/bytes for each of such flows with added congestion controls. Further its very common for time critical (VoIP/real time streaming etc/progressive movie downloads) end applications to dynamically adjust sending rates (eg reduce VoIP codec/frame rates) based on knowledge of congestion parameters such as inFlights, packet loss rates & percentages, RTT/OTT . . . etc.

Thus latest returning ACKs' RTT or OTT value/latest estimate of uncongested RTT minRTT/total inFlights size parameters . . . etc necessary to control CAI Allowed InFlights/actual inFlights size/CWND will be available, similar to as in TCPAcceeration CAI allowed inFlights management scheme, enabling similar benefits of near 100% link's bandwidth utilisation &/or PSTN transmission quality packets deliveries.

Its very easy to monitor non-conforming ‘illegally aggressive’ UDP flow within Internet routers, & toss them to the ‘bin’, to help maintain constant near 100% throughputs and PSTN transmission quality within LAN/WAN &/or external Internet/Internet subsets.

It is very likely when existing experimental long latency GRID/HEP networks start becoming heavily used & network packet drop rates increases to eg 1% onwards, they will experience very severe throughputs restrictions due to earlier described remote receiver TCP buffer exhaustions over-filled with ‘disjoint SeqNo chunks’. Existing Grid/HEP networks further excaberate this because they pre-dominant utilise ‘multiple TCP flows’ methods to achieve high throughputs & quicker recovery from packet drops AIMD algorithm, which magnitude order multiplicatively increases # of individual TCP flows when # of users gets larger THUS causing increasingly much more frequent congestion drops events (ie packets drops percentage increases to be very large).

Likewise TCP variants eg High-Speed TCP/FAST TCP which works well achieving very good throughputs when it is the only flow along path, but already performs very much worse compared to standard TCP in the presence of other background traffic flows, will see throughputs performances drastically drop to only ‘trickles’ due to afore-mentioned severe upper limit very low throughputs restrictions arises from described ‘remote receiver TCP buffer exhaustions’ in the face of increased competing usages by multiple sub-flows methods background TCP traffics

### Post October 2006: Various Improvements & Notes

In earlier preceding section titled, ADAPTING EXTERNAL PUBLIC INTERNET INCREMENT DEPLOYABLE AI (allowed inFlights scheme) scheme's windows TCPAccelearation/Linux modifications, TO PROVIDE PROPRIETARY LAN/WAN/EXTERNAL INTERNET SEGMENTS WITH INSTANT GUARANTEED PSTN TRANSMISSION QUALITIES:

when enabling constant near 100% bottleneck link utilisation throughputs AND PSTN transmission quality packets deliveries, CAI/actual inFlights/CWND could be instantly immediately reduced to eg CAI/1+curRTT−minRTT whenever very initial onset of packets buffering detected (introduced packet buffer delay>eg 25 ms &/or +eg 35 ms . . . etc according various devised dynamic algorithms), BUT only if a period equal to at least eg 1.5*curRTT (or smooth SRTT . . . etc) at the precise time of previous latest CAI/actual inFlights/CWND reduction has elapsed since the of previous latest CAI/actual inFlights/CWND reduction ie so such reductions does not occur many times successively with 1 RTT due to many returning ACKs all with curRTT>minRTT+eg 25 ms Var1+eg 35 ms Var2. OR only if a new packet SeqNo sent after the previous previous latest CAI/actual inFlights/CWND reduction, has now been returned ACK ie similar equivalent to 1 RTT has now elapsed.

Outline of Proprietary guaranteed PSTN transmission quality windows intercept LAN/WAN software (could also be direct TCP source code modifications eg Linux/FreeBSD/or when windows TCP source code available . . . etc):
(1). simplest version as is: this software here will only be activated on all PCs within proprietary network which only requires non-time critical normal TCP service [specifiable as software user-inputs parameters, but now default eg 5% Div1, eg 50% Div2, eg 25 ms Var1, eg 50 ms Var2], not activated on PCs hosting time-critical VoIP/Video streaming applications==>PCs with software activated will always reduce rates to ensure VoIP applications on other PCs always experience guaranteed PSTN transmissions
eg 5% Div1 to ensure even when link exactly at 100% utilisation flows do not within just 1 RTT to suddenly cause substantial hundreds of ms equiv buffering/overflow drops.
Eg 5% Div1 allows only at most sudden 50 ms equiv buffer delays to occur.
could adjust default values as needed, perhaps best allows 100% Div1 when CAI/minRTT in seconds <64 Kbytes/second (each flows guaranteed to attain 0.5 Mbits/s quickly) thereafter uses default 5% Div1 (to not cause sudden buffer delays >50 ms)

Yes, could optionally use 100% Div1 (thereafter 5% Div1) until the very moment max recorded CAI/latest minRTT in seconds <64 Kbytes/sec ie all existing non-critical TCPs will reduce CAI to allow new flow to quickly reach transmit speed of 64 Kbytes/sec BUT immediately thereafter reverts to 5% Div1 (ie new small transfers gets completed fast, while background large transfers hold back slightly) . . . or various other devised dynamic algorithms . . . etc
(2). as in (1) above, except software now further monitor to regulate VoIP/Video streaming TCP flows different ie if flows are VoIP/Streaming standard common port numbers (also RTP/RTSP/SCTP common port numbers, but do not regulate VoIP UDP flows), then if VoIP flows to assign default 25 ms Var1 50 ms Var2 & if Video streaming/RTP/RTSP/SCTP flows to assign default 25 ms Var1 75 ms Var2
==>can easier install on every PCs within network regardless, software here distinguishes time critical flows on each PC, & reduces normal TCP flows' rate first then Video streaming flows' rate LAST VoIP flows' rate
   other commonly used VoIP/Streaming ports could be included in Table of well known time-critical ports, eg MS Media Player/RealPlayer/NetMeeting/Vonage/Skype/Google Talk/Yahoo IM et5

Default values could be adjusted/initialised differently as needed. Priority ports numbers may also be specified as software activation user-inputs parameters VoIP can actually tolerate 200 ms-400 ms total cumulative latencies! (?) can optionally do: (2) . . . if VoIP flows to assign default 25 ms Var1 350 ms Var2 & if Video streaming/RTP/RTSP/SCTP flows to assign default 25 ms Var1 75 ms Var2 . . . or various devised schemes . . . etc
this would benefit from requiring/implementing separate Transmit Queues for VoIP/Video/Data or separate Transmit Queues for each TCP flows, priority forward all packets to NIC first from higher priority Transmit Queues (VoIP then Video then other flows) ie Data Transmit Queue forwarding should ‘stop’ immediately even when just a single new packet now appears in VoIP/Video Transmit queue (instantly check this after each Data Transmit Queue packet forwarded)==>proprietary guaranteed PSTN transmission quality LAN/WAN software should now work, OR at least the ‘Port Capture factor’ no longer relevant nor distorts adapted continuous CAI-ration reductions on curRTT>minRTT+eg 25 ms Var1+eg 35 ms Var2 functions
LATER: will further want to incorporate rates pacing within each PCs' application flows, especially when connected to ethernet's exponential collision back-off ‘port captures’, ie a Period of each application flow's max recorded (or could be current) CAI values/latest minimum recorded (or could be current) minRTT must have elapsed before next packet from this particular flow (priority VoIP/Video or lowest priority data) could be forwarded to NIC

However this could much simpler be achieved just by incorporating a final ‘rates paced’ layer, ensuring for each flow previous forwarded packet's data payload size*this flow's current (not max recorded) CAI in bytes/minRTT in seconds must have elapsed before next packet from this flow could be forwarded to NIC
not only ‘burst packet drops’ prevented, but also returning ACKs Clock evenly spread out, thus no flow will monopolise capture port (there is sufficient milliseconds ‘halt’ between each flow's packet forwarding preventing ethernet LAN ‘port capture’: this is important with many PCs on ethernet LAN)

For flows with VoIP ports, can optionally (doing without final ‘rates pace’ layer) further simply just avail of fact that VoIP codecs generate packet at most once every 10 ms, & ALWAYS forward VoIP flows' packets immediately ‘non-stop’

Video & data flows should be rates paced

In earlier previous preceding section re:

NextGenTCP Linux modified TCP source code outline, & similar equivalent windows intercept software . . . etc (applicable also to subsequent proprietary guaranteed PSTN transmission quality LAN/WAN adapted software from above)

The exponential increment unit size, instead of doubling per RTT when all packets sent during preceding RTT interval period were acked ie with increment unit size of 1.0 where CWND/CAI incremented by bytes acked, the increment unit size could be dynamically changed to eg 0.5/0.25/0.05 etc ie CWND/CAI now changed to be incremented by bytes acked*0.5 or 0.25 or 0.05 etc depending on dynamic specified criteria eg when the flow has attained total of eg 64 Kbytes transmission/has attained CWND or CAI size of eg 64 Kbytes/has attained CWND or CAI size divided by latest recorded minRTT of eg 64 Kbytes . . . etc, or according to various devised dynamic criteria.

In earlier previous preceding section re

### Overcome Remote Receiver Tcp Buffer Restriction on Throughputs:

Here are further described various possible refinements/improvements & implementations outlines, based on/adapted from the earlier described preceding Description Body.

(A) adaptations/refinements/improvements & implementations, with combinations/subsets/combination subsets of following (I) to ( ):
(I) TCP receiver side ‘modifications’ to work together with existing sender side NextGenTCP appropriate modifications=>100% ‘real throughput’ utilisation of bottleneck link's bandwidth regardless of any high drops high latencies combinations whatsoever
1. modify receiver TCP buffer to now always be ‘unlimited’ in size, regardless of TCP establishment negotiated max windows sizes. Immediately generate ACK for all new arriving higher SeqNo packets, regardless of ‘disjoint’ or contiguous SeqNo in receiver TCP buffer.
2. only ever forward ‘contiguous’ ie continuous SeqNo packets/chunks from receive buffer onto receiver TCP, ie receiver TCP now will not ever notice any drop events & thus never ever generate a single DUPACK whatsoever. Ie all forwarded packets should have SeqNo=previous SeqNo+previous packet's data size.
3. (needs have access to receiver buffer structure & contents) at eg every 1 second interval (or various specified/derived intervals), iterate through buffered packets & generate a ‘special’ packet (eg with special TCP identification field ‘rtxm’ containing all buffered SeqNos/SeqNo blocks present in the ‘unlimited receiver TCP buffer (or alternatively could be missing gap SeqNo packets, ie from the very 1^{st} buffered packet's SeqNo1 the next buffered packet's SeqNo2 should be SeqNo1+this packet's data payload size . . . & so forth, ELSE include this missing SeqNo in the ‘special’ generated packet's data payload (2 bytes/16 bits?)) THEN loop back to next buffered packet iteration above (doesn't matter if this single missing SeqNo+max 1,500 bytes data size<next buffered packet's SeqNo, ie there could actually be unknown number of consecutive missing packets in this gap: these subsequent consecutive missing SeqNo could be requested again after the 1^{st} transmission arrives).
4. modify sender's NextGenTCP to ‘intercept’ this ‘special’ ‘rtxm’ packet, iterate through all 16 bits requested/inferred rtxm missing gap SeqNos & retransmit them all.

### Alternative:

1. insert a process ‘intermediate buffer’ between network & receiver TCP. This implements sufficient arbitrary large initialised arrays (2 array parts) with entries in 1^{st} part holds only the arriving packet's header contents together with associated fields packet SeqNo & data payload size. 2nd part holds only the actual payload bytes [symbol] thus all consecutive missing bytes (which could span an unknown number of missing packets) is readily seen. Note this 2^{nd} part array's byte index [ ] correspond to SeqNo (offset by flow's initial negotiated SeqNo)
2. ‘intermediate buffer’ process only ever forward contiguous SeqNo packets (when missing gaps filled by arriving retransmission packets) to receiver TCP.
3. Generate ‘special’ ‘rtxm’ packet eg every 1 second or various specified/derived intervals, containing all buffered SeqNpos/SeqNo blocks present in unlimited receiver TCP (alternatively missing bytes' SeqNos in 2^{nd} part, here each of the disjoint gap's starting bytes' SeqNo=1^{st} part's packet SeqNo, ending with disjoint gap's end byte's SeqNo=1^{st} part's packet SeqNo+‘total bytes size of the disjoint data payload gap’). Ie special rtxm packet now contains a number of pairs of SeqNos: start of buffered block's SeqNo & end of block's SeqNo (alternatively start of missing block's SeqNo & end missing block's SeqNo)
4. Modify sender NextGenTCP to now intercept special rtxm packet, examine each pair of SeqNo successively, retransmit ALL requested/inferred missing SeqNos/SeqNo blocks (alternatively the associated missing start SeqNo packet, & IF end SeqNo>above latest retransmitted packet's SeqNo+data payload size THEN loop to next retransmit next packet with SeqNo=above latest retransmitted packet's SeqNo+datasize+1 (which would have been stored within present Sliding Window, note also the ‘+1’ here added to point to next packet's SeqNo)

ITS ALSO POSSIBLE TO JUST MODIFY RECEIVER TCP TO GENERATE SACK FIELDS WHICH ‘CIRCULARLY’ RE-USE THE MAX 3 SACK BLOCKS, ie if 3 blocks not enough to request all missing gaps retransmission then after the 1^{st} 3 missing gaps SACKed to now have the 4^{th} gap's start SeqNo now as the very 1^{st} SACKed block start SeqNo (thus can further indicate another 2 missing gaps again cyclically re-use, note RFC TCP fortunately here does not advance its internal ACKNo even when SACKed!). HERE THERE IS NO NEED WHATSOEVER TO MODIFY EXISTING SENDER'S NEXTGENTCP & this CIRCULAR CYCLICAL SACK blocks re-use receiver based modification scheme could immediately works with all pre-existing RFC TCP SACKs.

will want to ensure ‘intermediate buffer’ implementation codes against possible SeqNo wraprounds/time wraprounds.

### Notes:

(a) Receiver TCP now doesn't ever generate DUPACKs but continues to generate ACKs as usual, all DUPACKs needed to request packets retransmission is now completely handled by Intermediate Buffer Software more efficiently not allowing ‘disjoint chunks’ to limit throughputs.
Receiver RFC TCP here only ACKs lowest received contiguous SeqNo packets (not largest disjoint buffered SeqNo packets) as usual

Earlier described external Internet increment deployable TCPAcceleration.exe gives TCP friendly fairness but it errs on safe side assuming ‘loss rates always equates congestions’ (eg not so in mobile wireless, or unusually small duration large bursts loss . . . etc)==>there could be scenarios where link under-utilised (eg could also be existing receiver buffer limiting transfer rates, wireless/mobile/satellites fadings high drops . . . etc) ‘unlimited receiver TCP Intermediate Buffer’/cyclical re-use, &/or together with NextGenTCP, further enables 100% link utilisations even under above under-utilised scenarios.

This ‘intermediate buffer’/‘cyclical re-use intermediate buffer’ do not auto-ACK every incoming packet at all, this could be left to existing RFC receiver TCP's existing RFC mechanism

existing NextGenTCP's could be modified to use exponential increment unit size of eg ¼ (0.25) or various algorithmic dynamic specified/dynamic derived increment unit sizes instead of existing unit size of 1.0 (now only increment CAI by eg bytes acked/4 whenever subsequent curRTT<minRTT+25 ms) eg after the very 1st drop event (record this event & check this condition if true to then use ¼ exponential increment unit).

This should allow NextGenTCP to continue fast exponential increment to link's bandwidth initially (as RFC TCP), thereafter very 1st drop to exponential increment only by eg ¼ if subsequent curRTT<minRTT+25 ms (prevents repeated occurrences of when utilisation near 100% to then within 1 RTT cause repeated drops due to CAI doubling within just this 1 RTT).

existing Internet TCP is like 1950's 4-lane highway where cars travel at 20 miles/h on slow lane 40 miles/h on fastest lane, there are many over-wide spaces between cars in all lanes (1950's drivers prefer scenic views when driving, not bothered about things like overall highway's cars throughputs)
NextGenTCP, &/or together with ‘unlimited receiver TCP intermediate buffer’/cyclical re-use, allow new 21st century cars to switch lane overtake constantly ie improves throughputs, but only when highway not already filled ‘bumper to bumper’ throughout ie 100% utilised (whether by old cards or new). Allowing applications to maintain constant 100% link utilisation all the time actually alleviates congestions over time as applications complete faster lessen number of applications requiring the net. When 100% utilisation achieved NextGenTCP only ever then increment 1 segment per RTT, unlike new RFC TCP flows which continues exponential increments causing over-large latencies for audio-video & drops.
you can only be TCP friendly so far: ie old cars here continue to travel on their own speeds completely as before ‘unhindered’, but new cars travel better able to ‘switch lane overtake’ when safe to do so (when utilisation under 100%)
(b) with ‘intermediate buffer’ generating special rtxm packet every second to include SACK gap blocks/SeqNos for all missing packets, existing sender
NextGenTCP needs to be modified to respond to this special rtmx packet, to retransmit all indicated SACK gap blocks/SeqNos (Note: here ‘intermediate buffer’ needs reconstruct the special rtxm ‘packet’s header field eg with ACK field set to current latest ACK sent by receiver TCP)
BUT its preferable to proceed with using ‘cyclical SACK blocks re-use’ straight away, & existing SACK enabled NextGenTCP needs not be modified at all. After max 3 SACK blocks (not SACK gap) used up, can send further packet with 1st SACK block now encompassing all previous SACK blocks ranges (pesudo-SACK, despite some actual missing SeqNos in this new 1st SACK block range==>could indicate 2 more SACK blocks if needed & existing RFC sender TCP/existing NextGenTCP already automatically be very helpful allowing any number of inferred SACK gaps SeqNos retransmissions!)
(Note: here ‘cyclical re-use intermediate buffer’ needs reconstruct the ‘extra’ generated packet's header field eg with ACK field set to current latest ACK sent by receiver TCP. These ‘extra’ normal packet/s, as many as needed, is generated to indicate all SACK blocks/SeqNo (not SACK gaps). YES, its not every second here, but these ‘extra’ normal packet are generated if needed during each single fast retransmit phase ie existing RFC fast retransmit only allows missing packets to be retransmitted only once during each particular fast retransmit phase)
[combining ‘intermediate buffer & ‘cyclical-re-use’] implementing ‘combination intermediate buffer’ sitting between network & receiver buffer, with sufficient arbitrary large buffer array initialised, only forward contiguous SeqNos to receiver TCP immediately as arriving retransmission packets fill front/s of buffer (note: front missing SeqNo=latest ACKNo sent), now once every second to now instead of ‘special rtxm packet’ just generate needed number of normal DUPACK packet/s to cyclical re-use SACK blocks to SACK all ‘disjoint’ SeqNo chunks in the arbitrary large buffer array (preceded by generating 2 pure ACKs with no SACK fields, ACKNo=recorded intercepted latest ACKNo from receiver to to sender): no need to modify existing sender NextGenTCP
can immediately transfer simulation modifications into windows intercept software (between network & receiver TCP), works immediately with existing TCPAccelerator.exe & existing RFC TCPs
   ‘intermediate buffer’ can simply be just unlimited linked list (or sufficiently arbitrary large array initialised) holding each buffered arrived packets in well ordered SeqNos. Every second iterates from 1st buffered packet to last & simply just include each present ‘continuous SeqNo chunks’ (ie next SeqNo=previous SeqNo+datalength) into cyclical re-use SACK blocks in required number of generated DUPACK SACK packets
   (c) existing window TCPAccelerator.exe (ie NextGenTCP intercept software, sitting between sender RFC MSTCP & network) at present already if required always ‘spoof ack’ ensures MSTCP never notice any drop events (dupacks/rto timeout), thus takes over complete retransmission functionalities totally (maintained transmitted packets copies list, remove packet copies with SeqNo <latest largest received ACKNo, retransmit from packet copies list).
   there is a variable AI (max Allowed inFlights) which very accurately & very fast tracking the available bandwidth: when link underutilised ie curRTT<minRTT+25 ms var, AI incremented by bytes acked. Whenever inFlights<AI then then ‘spoof ack’ shifting MSTCP's sliding window left edge to get MSTCP generates arbitrary large number of new packet/s ON-DEMAND not limited by negotiated max window size nor limited by present CWND size (in fact MSTCP's CWND grows to be stabilised constant at max window size, since MSTCP never notices drops)
   when intercepted 3 DUPACKs, retransmit & upon exiting fast retransmit phase reduce AI to be AI/(1+curRTT-minRTT)==>packets transmission now completely paused until a number of returning ACKs exactly make up for the reduction amount=>buffered packets along path exactly cleared before resuming transmissions
   existing window's TCPAccelerator/NextGenTCP already handles DUPACK's SACK blocks very well, (like all other existing RFC TCPs & flavours) need no modification to immediately works even better with ‘cyclical re-use unlimited receiver TCP intermediate buffer’ software
   (d) in each fast retransmit phase RFC TCP only retransmit each packet/s once only, the sliding window's retransmitted packet is ‘marked retransmitted’ & not sent again during this particular fast retransmit phase. After existing fast retransmit (any of retransmitted packet/s, subsequent to 3rd DUPACK triggering fast retransmit, now return ACKed? or simplify as when ACKNo incremented ?) in next fast retransmit phase all sliding window packets can be retransmitted, again just once each. SACKNo received will not ever be used to ‘remove’ sliding window packet copies, because receiver may SACK buffered packet/s . . . & possible but rare subsequently flush discard all buffered packets==>ACKNo RULES here
Above ‘unlimited receiver TCP cyclical SACK’ specs (simplification) sure works if at eg 1 second delay cost (+not preserving 100% semantics: generating extra DUPACKs==>sender increments CWND!)
yes IF using ‘every 1 second’ here ‘cyclical re-use intermediate buffer’ needs insert SACK fields continuously in all ACKs (n as in RFC) . . . eventually rare but possible causing ‘pseudo-SACKs’ even during normal transmission phase
BUT prior to 3rd DUPACK fast retransmit triggered (ie while not in fast retransmit phase) can/prefers ONLY SACK ‘normally’ not more than 3 SACK blocks total (not pseudo-SACK, else sender TCP can't retransmit sliding window's earlier pseudo-SACKed packets) . . . or something like this
Far better implement either of 100% semantics methods below, receiver TCP already has this SACK mechanism ‘pat’ & methods here just cyclical re-use SACK blocks onto receiver TCP's multiple DupAcks ONLY during fast retransmit phase (during normal phase receiver TCP already inserts SACKs in all ACKs)
NOTE: LATER could have ‘intermediate buffer’ just maintain copy of all received packets BUT immediately forward all received packets (missing SeqNo or not) onto receiver TCP's own receive buffer (subject to highest forwarded SeqNo+datalength−latest intercepted ACKNo=<max negotiated receiver window size)! & remove all maintained intermediate packets copies<latest intercepted largest ACKNo.
this way, receiver TCP generates own DUPACKs with max 3 SACK blocks ever: when receiver TCP then again generates ‘extra’ multiple DUPACKs (in response to continuing arriving out-of-order SeqNo packets), (& previously all 3 SACK blocks all used up) ‘cyclical re-use intermediate buffer’ software could insert more SACK blocks (max 2 more new SACK blocks in each subsequent DUPACK from receiver TCP)
==>RFC semantics 100% maintained
OR could continue to have ‘cyclical re-use intermediate buffer’ forwards only contiguous SeqNo packets to receiver TCP, & does exactly what receiver TCP will do with DUPACKs/SACK mechanisms IDENTICALLY==>receiver TCP will now not ever advertise smaller receive window size (if receiving & needs buffer non-contiguous packets) thus achieve best throughputs
previously sender TCP may throttle back by small receiver advertised window size, under-utilising available bandwidth
Its very clear now, a simple enough example implementation among many possibles:
1. ‘unlimited intermediate buffer’ REALLY should SACK (not 10× less items SACK gaps, since with SACK items sender NextGenTCP could infer if each SACK SeqNo's curRTT<minRTT+eg 25 ms), ie includes all latest SACK SeqNo/blocks present in the unlimited receiver buffer when generating ‘rtxm packet’, & rtxm packet now generated not 1 second nor 50 ms . . . etc BUT ‘immediately’ ie to ensure sender TCP can now infer if each SACK SeqNo's curRTT<minRTT+eg 25 ms
‘intermediate buffer’ sitting between network & receiver RFC TCP only forwards contiguous SeqNo packets to receiver RFC TCP, keeps track of very last known missing SeqNo (<largest last SACK SeqNo/block in the unlimited receiver buffer: which may or may not also be the very 1st front missing SeqNo) & if 2 extra new packets arrives without receiving retransmit (? or re-ordered delayed) packet filling this very last known missing gap SeqNo THEN to immediately without delay generates ‘special rtxm packet’ containing all SACK SeqNo/blocks present in the unlimited receiver buffer at this very moment SUBJECT ONLY to an RTT having elapsed since last ‘special rtxm’packet was generated ie once latest special rtxm packet sent ‘intermediate buffer’ software needs only check that a new retransmission packet has now been received filling any one of the indicated missing gap SeqNo to THEN henceforth allow next ‘special rtxm packet’ to be generated
   detecting a new retransmission packet has now been received filling any of the indicated/inferred missing gap SeqNo, will simply be:
keeps track of largest SACK SeqNo indicated in initial generated ‘rtxm packet’ (unlimited ‘buffer packet’ may very again buffers new disjoint higher SeqNo block/s, before 1 RTT elapsed)
   (LOOP: once a new retransmission packet has now been received filling any one of the indicated missing gap SeqNo, then ‘intermediate buffer’ will now wait for a number eg 1 or 2 e or 3 extra new packets arrives without receiving retransmit (? or re-ordered delayed) packet filling any one of the indicated missing gap SeqNo THEN to immediately without delay generates ‘special rtxm packet’ containing all SACK SeqNo/blocks present in the unlimited receiver buffer at this very moment)

### Important:

CWND NEEDS BE REDUCED (to CWND/(1+curRTT of RTXM's largest SACK SeqNo−minRTT)), but now ONLY whenever rtxm packet arrives with SACK SeqNo/blocks ie packet drops occurred & presumed to be congestion caused curRTT of rtxm's largest ACK SeqNo is simply the recorded SeqNo packet's SentTime−the rtxm's arrival time (similar to SentTime−ACK time). These code locations could easily be found by looking for wherever CWND is checked against inFlights just before decision to allow new packets into network

Further Generalised & even further simplified:
(perhaps also instead of increasing sender's window size/increasing CWND depending on curRTTs whatsoever?) ALSO needs modify make sender TCP conceptually takes/records inFlights (initialised ‘0’) to just be largest SentSeqNo−latest largest received ACKNo−total # of bytes in ALL the very latest last received rtxm's indicated SACK SeqNos/blocks (previously it continuously regards inFlights as largest SentSeqNo−latest largest received ACKNo)
   [this will now give correct inFlights even if 0% drop scenario . . . etc]

REALLY rtxm generation needs not be periodic eg every 1 sec or every 50 ms at all, next rtxm could only be generated after at least 1 RTT ie 700 ms here OR after eg 1.25*curRTT as expired since last RTXM packet was generated, whichever occurs earlier. Once receiver TCP detected a retransmission packet has now been received filling any one of the indicated missing gap SeqNo in previous last sent rtxm packet & followed by at least one brand new highest SeqNo packet being received (OR after eg 1.25*curRTT as expired since last RTXM packet was generated) THEN ONLY could a new rtxm packet be generated again (now containing all SACK blocks present in the unlimited receiver buffer, filled contiguous packets must 1st be ‘removed’). After approx 1 RTT, the last sent rtxm packet would now cause retransmission packets to now be received filling all requested missing gaps (if not again dropped). Note this chain of retransmission packets will follow one after another without any ‘brand new’ data packet between them.

After ‘filled’ contiguous SeqNo/blocks ‘removed’ from unlimited receive buffer, only then can a new rtxm packet be generated containing all remaining SACK blocks (+any new SACK blocks formed by new data packets) present in the unlimited receive buffer (similar to the 1st rtxm packet)
Incrementing (exponential) CWND by the total # of bytes of all the SACK SeqNos/blocks contained within rtxm packet, IF curRTT of the highest last SACK SeqNo in the rtxm packet<minRTT+eg 25 ms (try 100 ms also) should have very quickly incremented CWND filling pipe???
   2. sender NextGenTCP should intercept examine special identification rtxm packet's SACK SeqNos/blocks, retransmit ‘inferred’ missing gaps SeqNo/blocks, to THEN reduce existing actual inFlights variable by the total # of bytes in all SACK SeqNo/blocks indicated within the rtxm packet (ie CWND now certainly>reduced inFlight variable, since SACKed packets left the network stored within unlimited receiver buffer, thus new packets could be injected into network maintaining ACKs Clock & ensures there is now CWND # of inFlights in network links)
(NOTE: sender NextGenTCP should now further have incorporated CWND increments, ie & if curRTT of the largest SACK SeqNo/block (within the rtxm packet)<minRTT+eg 25 ms to THEN increment CWND by the total # of bytes in all SACK SeqNo/blocks indicated within the rtxm packet: not only has the indicated SACK SeqNo/blocks left network links into unlimited receiver buffer allows inFlights variable to be reduced, but we should now additionally increment CWND by the total # of bytes in all SACK SeqNo/blocks indicated within the rtxm packet IF curRTT of the largest SACK SeqNo/block (within the rtxm packet)<minRTT+eg 25 ms
   sender TCP here can be modified so CWND can be arbitrary large incremented & inFlights can reach arbitrary large CWND, now NOT constrained by eg 64K max sender window size at all.
   there is no retransmission SeqNo resolution granularity degradation (as when RFC 1323 large scale window used), since sender TCP here would now keep up to arbitrary large CWND # of sliding window worth of packet copies for retransmission purpose (up to 2̂32−2)
   but its still best to incorporate ‘reduce inFlights variable’ by the total # of bytes of all the indicated rtxm's SACK SeqNo/blocks (these now left the network links into ‘unlimited’ receive buffer BELOW (ie makes sure NS2 sender TCP no longer treats inFlights as largest SentSeaNo—latest received ACKNo, this is always checked against CWND in allowing new packets forwarding):
very good & essential, to additionally make sure sender TCP now modified to update its inFlights variable to be reduced by the total # of bytes of all the indicated rtxm's SACK SeqNo/blocks (these now left the network links into ‘unlimited’ receive buffer, & regardless of largest SACK SeqNo's curRTT value . . . )==>this way CWND always becomes >inFlights when rtxm received & new packets allowed into network (especially useful when CWND reached 64 Kbytes max sender window size limitations . . . incrementing CWND even when beyond 64K has no effect will still be constrained by max sender window of 64K)=
=>this helps alleviates cases when ACKNo remained ‘pegged’ very low, for unusually long time period, if repeated rtxm requested retransmission for 1st front missing SeqNo in unlimited’ receive buffer kept being repeatedly lost again
   the part here reducing actual inFlights variable is redundant & OPTIONAL (by the total # of bytes in all SACK SeqNo/blocks indicated within the rtxm packet) ie NOT NECESSARY, sender TCP here only needs be modified to transmit all ‘inferred’ missing gaps SeqNos/blocks ‘all in one go’.
   TCP usually defines actual inFlights differently: as latest largest SentSeqNo+its datapayload size−latest received largest ACKNo
   we assume here max negotiated window size eg 64K etc is sufficient to fill link's eg 10 mbs bandwidth, for the given RTT settings.
   we can't simply make sender TCP here to have ‘send window size’=arbitrary incremented CWND size, unrestricted by max negotiated 64K send window size, SINCE sender TCP here only retains 64 Kbytes data for retransmissions (UNLESS we modify sender TCP to now retains up to CWND size of data for retransamissions)
   Note: in windows TCPAccelerator.exe, a seperate arbitrary large Packet Copies list is maintained for retransmissions, thus AI (allowed inFlights) can grow arbitrary large to fill arbitrary large links, at the same time maintain same as ‘normal’ usual 64K retransmission SeqNo resolution granularity.
(II)
   just needs set TCP receive buffer size to be unlimited, or sufficient very large (bytes size at least eg 4 or 8 or 16*link's bandwidth eg (10 mbs/8)/uncongested minRTT in seconds eg 0.7), REGARDLESS of max negotiated window size & INDEPENDENT of sender's max window size eg 16K or 64K: this could be accomplished easily in simulation CC scripts, or in real life by using receiver Linux & window's sender NextGenTCP.

Sender TCP needs not be modified whatsoever, can work immediately with all existing RFC TCPs.

Under high drops with great number of disjoint SeqNo packets chunks at receiver buffer (cf RFC's max 3 SACK blocks per RTT), sender TCP's will successively RTO Timeouts a great number of times (all usually spread out within at most a single RTT, or several RTTs) & retransmit all these ‘gaps’ SeqNo packets==>even though max 3 SACK blocks per RTT, these quick successive RTO retransmissions ensures great number of ‘gaps’ will be filled by RTO retransmission packets (within RFC RTO default minimum floor of 1 seconds, or if some RTO retransmission packet/s dropped then within RFC's exponential backoffs time periods. Note could also optionally conveniently just modify sender TCP to not use exponential RTO backoff timers ie here all successive backoff RTO timers to use same constant 1 second, OR progressively incremented successively by 0.5 sec OR various algorithmic dynamic derived increments . . . etc)
results should now show TCPAcceleration.exe attains constant near 100% link utilisation regardless, REGARDLESS of high drops+high latency (needs not use any ‘unlimited receiver TCP intermediate buffer’/cyclical SACK re-use modifications whatsover)
yes the ‘Barest Simplest’ attempt quick confirmation of 100% via RTO timeout retransmit all missing gap SeqNo/blocks (not sufficiently fast retransmitted limited by exiting RFC's max 3 SACK blocks)+simply setting receiver buffer unlimited, BUT should here further ensures sender TCP does not resets CWND size on RTO timeouts &/or OPTIONALLY sender TCP's transmission is made NOT limited by negotiated sender's max window size . . . thus no throughputs degradation
   can make upon completing RTO timeout setting CWND=CWND/(1+curRTT−minRTT), BUT to leave CWND unchanged in following successive RTO timeouts UNTIL curRTT time period has expired (otherwise CWND−>0 very fast)
   with sender NextGenTCP's 3 DUPACKs fast retransmit made not operational, this RTO timeout will be the only occasion CWND gets reduced if at all (at most once every curRTT, & very likely continuously once every curRTT: very large buffered ‘disjoint’ packets in unlimited receiver buffer ensures this).
   and every RTT CWND may or may not get incremented by rtxm packet.

Further OPTIONAL but could be preferred to not even change CWND (not change CWND to CWND/(1+curRTT−minRT), when RTO timeout. CurRTT may equates to curRTXM's RTT (ie curRTT of the highest SACKed SeqNo in current latest received RTXM packet).

eg in scenario negotiated 64 Kbytes window size for both sender & receiver, now receiver buffer size modified to instead be set to unlimited/sufficient large receive buffer size REGARDLESS of sender's 64 Kbytes window size (& now needs ensure receiver TCP now always advertise constant unchanged 64 Kbytes receiver window size to sender TCP, not the real ‘unlimited size!)

NOW needs ensure periodic time period (at present every 1 second) for generating ‘special rtxm SACK gaps' packet toward sender TCP, should be such that:

sender's window size/RTT>bottleneck link's bandwidth ie on present 10 mbs link 700 ms RTT, the very best throughput will be limited to just sender's 64 Kbytes window/0.7 sec=91 Kbytes/sec or 728 Kbits/sec (under-utilising only 1/14th of available 10 mbs)
==>should set periodic time period for generating ‘special rtxm SACK gaps’ packets sufficiently frequent eg every 50 ms in above scenario, ONLY then sender's 64 Kbytes/0.05=here best throughputs achievable assuming unlimited bottleneck bandwidth is 1,280 Kbytes/sec or 10,240 kbits/sec (10.24 mbits/sec)
look forward to NS2 results for existing NS2 NextGenTCP script+unlimited receive buffer size (&/or every 50 ms ‘special rtxm SACK gaps’ packets, if needed)
Yes, can disable sender TCP's fast retransmission entirely. sender just ignore any number DUPACKs, ie not triggering fast retransmit any more, but
continues to shift sliding window's left edge with each new incoming higher ACKNo
Yes, can insert code sections in sender TCP to intercept special identification field ‘rtxm packet’, retransmit all requested missing retransmit packets in one go before forwarding before forwarding onwards any brand new higher SeqNo data packets
indicated missing gap SeqNo packets (simplify: all retransmitted in one go, not restrained by CWND)
This simplification ‘all in one go’ retransmissions may now cause CWND to become <actual inFlights, & subsequently needs wait an equivalent same amount of returning ACKs=‘all-in-one-go’ retransmitted amount to have arrived back before next new packet could be sent, BUT this is OK for now
NextGenTCP should already be able to fill 100% of available bandwidths UNLESS
constrained by max 3 SACK blocks per RTT (can overcome using unlimited receive buffer &/or 1 second or more frequent rtxm packet generations),
&/OR constrained by either by sender's CWND/CAI or max window size (can overcome by much more frequent than every 1 second rtxm packet OR making sender TCP transmissions to now not be constrained whatsoever by sender TCP max negotiated window size) . . . .
NOTE: window's TCPAccelerator.exe already has CAI tracking available bandwidth, spoof ack MSTCP to generate new packets on demand not constrained by CWND/max send window size==>
needs not bother with more frequent rtmx generation intervals
   NextGenTCP now incorporates AI mechanism (allowed inFlights) tracking available bandwidth+generates new packets whenever actual inFlights<AI (needs not spoof ack to generate new packets on-demand as in window's TCPAccelerator.exe, since no access to window TCP source codes, & needs not maintain Packet Copies list structure) but not incrementing CWND when doing so (else retransmission SeqNo resolution granularity degrades) . . . something like this . . . .
INITIALLY with unlimited receiver buffer should immediately shows near 100% utilisations, needs not STRICTLY requires rtmx to be generated more frequently (1 sec or 50 ms or whatsoever)

### Notes:

sender TCP at present does not already incorporate codes incrementing CWND during fast retransmit phase (eg with 10% drops sender TCP certainly will constantly be in repetitive successive fast retransmit phases, interrupted by 2 DUPACKs between repetitive successive fast retransmit phases
IF present sender TCP could only increment CWND during normal data transmission phase (if curRTT<minRTT+eg 25 ms) for CWND to accurately tracks available bandwidth to fill pipe, BUT with sender TCP now almost entirely in successive fast retransmit phase CWND now may or may not be able to increment sufficiently fast to track available bandwidth.
THUS needs to allow CWND to be incremented even during fast retransmit phase, if the curRTT of the latest received packet (with SeqNo>the ‘pegged’ ACKNo) at the time rtxm was generated (ie the largest SACK SeqNo contained within rtxm packet when rtxm packet was generated) ie if curRTT of largest SACK SeqNo packet<minRTT+25 ms THEN should now increment CWND (BY TOTAL # of all indicated SACK blocks bytes within rtxm packet, as we should now impute a ‘congestion free’ link for all indicated SACKed SeqNo/blocks since the latest largest SACK SeqNo has been fast SACKed equiv to ‘uncongested link’ at this very moment)
NOTE: during normal data transmissions its the curRTT of returning ACK that decides whether to increment CWND, in fast retransmit phase ACKNo is pegged to the ‘very 1st missing gap SeqNo’ & fortunately sender can get prompt notification of new higher SACKNo==>can decide to increment CWND depending on curRTT of this newest largest SACKNo packet
‘Fast retransmit’ terminology/context above really refers to ‘RTXM packet’ retransmit . . . .

### (III)

further refinements/improvements to immediately preceding (I) &/or (II) above:
sender TCP CWND increment algorithm should already use/compare using the ‘extra’ 1 out-of-order new highest SeqNo's curRTT which should already be included in the arriving rtxm packet (NOT the previous highest, before this 1 extra new higher SeqNo packet which triggered rtxm)
its very clear when CWND size/inFlights is insufficiently incremented, it will cause raw throughputs below available bottleneck's bandwidth. it had been thought waiting for 1 out-of-order higher-SeqNo packet arrival >latest highest disjoint SACK SeqNo formed (after rtxm allowed to be generated) would only cause RTXM to be delayed generated (from time when became allowed) only sub-millisecond at most (far far less than 25 ms variance). BUT this did not take into account the ‘intervening’ requested train of retransmission packets (could number tens of them easily) in-between which could easily always cause largest SACK SeqNo's curRTT to be always >minRTT+25 ms thus CWND erroneously not incremented to fill bandwidth!
SOLUTION: keeps record of ‘arrival time’ of latest highest newly formed disjoint SeqNo in unlimited receiver buffer, append OFFSET value of rtxm generation time (ie when 1 new highest SeqNo packet next arrives, following/delayed by this interspersed ‘burst’ train of requested retransmission packets)-recorded previous highest disjoint SeqNo's arrival time in the rtxm packet to be generated, sender TCP must now adjust/take the curRTT of largest SACK SeqNo to be =rtxm's arrival time−OFFSET . . . .
==>should see CWND size incremented sufficient to fill available bottleneck link's bandwidth

### Notes:

(a) sending packets transmissions ALWAYS limited by attained CWND size ie check inFlights (largest SentSeqNo−largest receivedACKNo−previous rtxm's total # of SACKed SeqNo) always<CWND.
CWND can grow arbitrary large, even far greater than negotiated max sender window size. ONLY negotiated max sender window size (eg 64K) now plays no role anymore, previously in RFC TCP it was check inFlights always <min[negotiated max sender window size, CWND]

CWND is decreased to CWND/(1+curRTXM_RTT−minRTXM_RTT) whenever rtxm packet arrives (rtxm packet generated/arrives ONLY when there is packet drop/s during previous RTT):

curRTXM_RTT=RTT of the largest SACK SeqNo's in rtxm packet, minRTXM_RTT is min[all previous curRTXM_RTT] CWND is exponentially incremented by total # of bytes SACked in arriving rtxm packet IF curRTXM_RTT<minRTXM_RTT+eg 25 ms
ELSE (OPTIONAL) IF curRTXM_RTT<minRTXM_RTT+eg 25 ms THEN increment CWND linearly per RTXM_RTT
(b) Sender TCP can estimate curRTXM's RTT (ie RTXM's highest SACKed SeqNo's RTT) as follows:
sender sent brand new higher packet SeqNo S
receiver receives packet SeqNo S, assumes>previous highest SACK SeqNo in unlimited receiver buffer==>immediately generates rtxm with highest SACK SeqNo S contained therein+all other lower SACK blocks/lower SeqNos (it is effectively ‘ACKing’ SeqNo S immediately . . . .)
sender compares SeqNo S's SentTime—this RTXM packet's arrival time (ie equivalent to SeqNo's real RTT or its normal ACK's return time, in traditional sense & semantics), this effectively gives ‘RTT’ for the highest SACKed SeqNo
sometimes there could be extended periods of time when no RTXM generated at all (ie 0% drops) . . . etc. . . . or both ACKs & RTXM generated to then able to update CWND faster & more often than once every RTXM's RTT etc==>needs to increment CWND when small curACK_RTT as well as small curRTXM_RTT
   yes, both ACKs and RTXM's RTT is calculated [NOW−time when DATA packet (which triggered ACK/RTXM generation) was sent].
RTXM may be sent in several packets, as many as needed, to completely include ALL SeqNos/SeqNo blocks present in the ‘unlimited receiver TCP buffer’.
   (c) we decrease inFlights value by the total # of SACKed bytes in RTXM, since these SACKed bytes now resides in unlimited receiver buffer NO LONGER in transit along network links ie these total # of SACKed packets have now left the network link AND THUS no longer considered to be inFlights/in-transit anymore (now received in unlimited receiver buffer).
inFlights is continuously dynamically updated as =present highest SentSeqNo−present highest receivedACKNo−latest RTXM's total # of SACK bytes when next RTXM arrives, we use this RTXM's total # of SACK bytes in above equation, likewise whenever SentSeqNo/receivedACKNo updated.
   inFlights is continuously updated, ie if assuming present SentSeqNo & present receivedACKNo unchanged then inFlights variable value remains same UNTIL next RTXM arrives (NOT RESET at all, but continuously changed with new SentSeqNo/receivedACKNo/RTXM)
Above inFlights formulations is perfect More correct is:
   inFlights always=highest_SeqNo−highest_ackno−present latest RTXM's total sacked bytes which are >highest_ackno
   ie latest RTXM copy is kept (until next new one arrives), so total sacked bytes which are >new updated highest_ackno can be derived
   (d) IF using timestamp option would allow one-way-latency (ie OTT) to be available, provides better resolutions than RTT. As in Karn's algorithm retransmitted SeqNo's RTT/OTT should preferably not be used in modified TCP algorithm, if used at all should always update SeqNo's SentTime to be the latest retransmitted SentTime.
   (e) There can be many modifications “types”—eg type1 and type2 here, the only difference between them is how CWND is changed when RTXM packet is received:

Type1:
if (rtxm_rtt_>min_rtxm_rtt_{—}+25 ms)
cwnd_=cwnd_/(1.0+(rtxm_rtt_−min_rtxm_rtt_);

Type2:
if (rtxm_rtt_>min_rtxm_rtt_{—}+25 ms)
cwnd_=cwnd_/(1.0+(rtxm_rtt_−min_rtxm_rtt_);
if (rtxm_rtt_<=min_rtxm_rtt_{—}+25 ms)
cwnd_+=total_SACKed_bytes_; //exponentional increase
else
cwnd_+=total_SACKed_bytes_/cwnd_; //linear increase
   there could be various workable subsets, eg TYPE3 same as TYPE2 but inFlights not reduced by RTXM's total SACKed bytes at all . . . etc, could be useful to use only the most basic minimum workable subsets . . . & perhaps the link should really stabilise 100% utilisations & delivered packets' deltaRTT never >eg 25 ms+eg 50 ms . . . (eg using small increment size 0.5/0.2/0.05 after attained 64K CWND)!

### (IV) Further Refinements/Improvements to Immediately Preceding (I) &/or (II) &/or (III) Above

will want to insert at sender TCP ‘final RATES PACE layer’: next packet all to be held in ‘final network transmit buffer’, not to be forwarded UNTIL previous forwarded packet's total size in bytes/[current (not max recorded) CWND in bytes/minRTT in seconds] must have elapsed [in seconds] before next packet could be forwarded to NIC this smoothes out sudden surge caused by inFlights reduced by total # of RTXM's SACKed bytes (especially when unlimited receiver buffer queue very very large), causing followed on brand new higher SeqNo packet (which would cause receiver to generate next RTXM) to be ‘queued delayed’ in the router (now buffering the retransmit packets surge)==>sender when receiving next RTXM will continuously notice ‘abnormal’ large ‘delayed’ RTXM_RTT (ie highest SeqNo's RTT) UNTIL unlimited receiver buffer size subsides from previous very very large . . . .

Every arriving RTXM_RTT>min_RTXM_RTT+25 ms will cause ALL link's routers to COMPLETELY clear ALL link routers' buffered packets totally ALREADY (excepting the unlimited receiver TCP buffer),

& if sender TCP now rates pace ALL the RTXM requested retransmission packets THEN when the next brand new higher SeqNo following packet gets sent (triggering receiver TCP to generate next RTXM) sender TCP will notice next RTXM_RTT to be <min_RTXM_RTT+25 ms.
packet's SeqNo recorded SentTime is now referenced to time when SeqNo gets forwarded from ‘final RATES PACED layer’ onto network (cf time when placed into final transmit to network buffer queue)==>brand new higher SeqNo packet's RTT (ie next RTXM_RTT) now should be <minRTXM_RTT+25 ms (since link routers' buffer now all completely cleared whenever each previous individual RTXM_RTT<minRTXM_RTT+25 ms)
   CORRECTION: this assumes sender TCP's CWND reduced to CWND/(1+a−b) thus ‘pauses’ UNTIL corresponding # of reduced bytes then returns INSTEAD of immediately retransmitting all requested missing packets (which would cause link routers' buffers NOT to completely ‘emptied’, especially when unlimited receiver buffered size grows very large & minRTT very large) thus CAUSING consecutive successive RTXM_RTTs to be all >minRTXM_RTT+25 ms & successive reductions from 460 to 20
   ==>[with rates pace final layer] should modify sender TCP WITHOUT reducing inFlights by total # of RTXM SACKed bytes, OR only reduce inFlights after ‘pauses’ ie after corresponding # of reduced bytes have returned (when link's routers buffers now all completely ‘emptied’) . . . . OR even with only inFlights reduction (?) etc
AND expected there should not be 2 consecutive RTXM_RTTs>minRTXM_RTT+25 ms with RATES PACED
BUT once link's routers buffers completely cleared (after not transmitting at all during ‘pause’ ie wait UNTIL corresponding reduced # of bytes returned ACKed (&/or RTXM SACKed)) & sender TCP starts transmitting again, this may cause link to be underutilised eg it takes eg 75 ms to reach the 1st link router & this ‘buffer cleared’ 1st router not be forwarding anything onto the 2nd link's router or the receiver TCP . . . .
   ==>a really very closer to 100% utilisation scheme would be to allow sender TCP to immediately retransmit/transmit when reducing CWND &/or reducing inFlights variable by ‘extra’ new REGULATE RATES PACE:
   here the original CWND is noted (before reduction)+curRTXM_RTT, next packet (RTXM retransmission packets or brand new higher SeqNo packet) all to be held in ‘final network transmit buffer’, not to be forwarded UNTIL previous forwarded packet's total size in bytes/[(current (not max recorded) CWND in bytes—corresponding # of bytes CWND reduced)/curRTXM_RTT in seconds] must have elapsed [in seconds] before next packet could be forwarded to NIC . . . there can be various other similar formulations . . . .

Further this new regulate RATES PACE scheme to operate ONLY for the duration of at most curRTXM_RTT (then terminates & wait for next RTXM), which could be terminated earlier when next RTXM_RTT again arrives . . . which would repeat the new regulate RATES PACE process anew again . . . .

If curRTXM_RTT period has elapsed, sender TCP can revert to usual CWND regulated &/or usual RATES PACE, if next RTXM_RTT does not trigger CWND reduction or has not again arrives . . . .

NOTE: (current (not max recorded) CWND in bytes−corresponding # of bytes CWND reduced by)/curRTXM_RTT in seconds GIVES the rates sender TCP should immediately transmit IN ORDER after curRTXM_RTT REGULATE RATES PACE period has elapsed link's routers buffers will have been all completely ‘cleared’ AND FURTHER does not cause any of link's routers buffers to ‘cease’ forwarding due to temporary delay in receiving traffics from preceding node or from sender TCP . . . .

can immediately implement this with pre-existing simulation (ie inFlights immediately reduced & immediate retransmit requested packets, no ‘pause’ waiting), SIMPLY NEEDS
‘extra’ new REGULATE RATES PACE (pre-existing RATES PACE continues to function, when REGULATE RATES PACE not in operation):
here the original CWND is noted (before reduction) & curRTXM_RTT, next packet (RTXM retransmission packets or brand new higher SeqNo packet) all to be held in ‘final network transmit buffer’, not to be forwarded UNTIL previous forwarded packet's total size in bytes/[(current (not max recorded, nor updated) original CWND in bytes−corresponding # of bytes CWND reduced by)/curRTXM_RTT in seconds must have elapsed [in seconds] before next packet could be forwarded to NIC . . . there can be various other similar formulations . . . .
THIS ENSURE LINK CONTINUOUSLY 100% FORWARDING+ROUTERS BUFFERS ALL CLEARED when curRTXM_RTT next elapsed
can further adjust formula so eg 25 ms equiv of all routers' cumulative buffered packets REMAINS thus helps improves to have some packets always available for forwarding onwards at link's router/s=>useful in real life eg to compensate windows OS non-real time FORWARDING natures
   CAN FURTHER ensure next packet can get forwarded when EITHER above formulation/s condition TRUE, OR a certain computed # of bytes at present time should have been allowed at present to have been forwarded onwards (since the previous RTXM arrival time which triggers new REGULATE RATRES PACE)=>useful in real life eg to compensate windows OS non-real time FORWARDING natures
Earlier described CWND INCREMENT/DECREMENT ALGORITHMS could be modified further such that DO NOT increment &/or decrement at all IF curRTT (or curRTXM_RTT)<minRTT (or minRTXM_RTT)+eg 25 ms var+eg 50 ms (or eg 0.5*curRTT or eg 0.5*minRTT . . . or algorithmic dynamic devised etc)==>keeps cumulative buffered packets at least 50 ms equiv along link's routers AT STEADY STATE (ie ACKs Clock here keeps bottleneck 100% utilised AT STEADY STATE)

### Refinements: Concepts Work in Progress Outlines Only (for Later Implementation, if Needed):

### (A)

BUT once link's routers buffers completely cleared (after not transmitting at all during ‘pause’ ie wait UNTIL corresponding reduced # of bytes returned ACKed (&/or RTXM SACKed)) & sender TCP starts transmitting again, this may cause link to be underutilised eg it takes eg 75 ms to reach the 1st link router & this ‘buffer cleared’ 1st router not be forwarding anything onto the 2nd link's router or the receiver TCP . . . .

=>a really very closer to 100% utilisation scheme would be to allow sender TCP to immediately retransmit/transmit when reducing CWND &/or reducing inFlights variable by ‘extra’ new REGULATE RATES PACE:
here the original CWND is noted (before reduction)+curRTXM_RTT, next packet (RTXM retransmission packets or brand new higher SeqNo packet) all to be held in ‘final network transmit buffer’, not to be forwarded UNTIL previous forwarded packet's total size in bytes/[(current (not max recorded) CWND in bytes−corresponding # of bytes CWND reduced by)/curRTXM_RTT in seconds] must have elapsed [in seconds] before next packet could be forwarded to NIC . . . there can be various other similar formulations . . . .

Further this new regulate RATES PACE scheme to operate ONLY for the duration of at most curRTXM_RTT (then terminates & wait for next RTXM), which could be terminated earlier when next RTXM_RTT again arrives . . . which would repeat the new regulate RATES PACE process anew again . . . .

If curRTXM_RTT period has elapsed, sender TCP can revert to usual CWND regulated &/or usual RATES PACE, if next RTXM_RTT does not trigger CWND reduction or has not again arrives . . . .

NOTE: (current (not max recorded) CWND in bytes−corresponding # of bytes CWND reduced by)/curRTXM_RTT in seconds GIVES the rates sender TCP should immediately transmit IN ORDER after curRTXM_RTT REGULATE RATES PACE period has elapsed link's routers buffers will have been all completely ‘cleared’ AND FURTHER does not cause any of link's routers buffers to ‘cease’ forwarding due to temporary delay in receiving traffics from preceding node or from sender TCP . . . .

### (B)

REALLY MUCH better now, with final REGULATE RATES PACE layer, to not have AI reductions by any of earlier devised algorithms at all (reducing AI would have caused ‘undesirable’ pause interferes with REGULATE RATES PACE). BUT to SIMPLY sets AI to actual inFlights whenever RTXM arrives (previous REGULATE RATES PACE period would have caused inFlights <CWND because packets were forwarded ‘slower’). Or some similar schemes

### (C)

AI (Allowed inFlights, similar to CWND) needs:
1. make sure modified TCP now does not decrement AI or CWND, SIMPLY sets AI to actual inFlights whenever RTXM arrives (previous REGULATE RATES PACE period would have caused inFlights to now be <CWND because packets were forwarded ‘slower’ during previous RTT) ie SIMPLY sets AI/CWND to largest SentSeqNo+its data payload length−largest ReceivedACKNo at the instant when RTXM arrives (since this is the total forwarded bytes during previous RTT. & REGULATE Rates Pace now deduct total # of SACKed bytes (which left network) from this figure in computation algorithm
   AND the ‘extra’ new REGULATE RATES PACE (pre-existing RATES PACE continues to function, when REGULATE RATES PACE not in operation) should SIMPLY be:
   here the current AI/CWND is now set to largest SentSeqNo+its data payload length−largest ReceivedACKNo at the instant when RTXM arrives since this is the total forwarded bytes during previous RTT when RTXM arrives, next packet (RTXM retransmission packets or brand new higher SeqNo Packet) all to be held in ‘final network transmit buffer’, not to be forwarded UNTIL previous forwarded packet's total size in bytes/[(this current All CWND in bytes−total # of bytes SACKed in arriving RTXM)/curRTXM_RTT in seconds] must have elapsed [in seconds] before next Packet could be forwarded to NIC . . . there can be various other similar formulations . . . .
2. incorporate usual Rates Pace layer, to smooth surge
3. further incorporate REGULATE Rates Pace layer, to ensure link's nodes cleared of buffered packets within next RTT+ensure closer to 100% ie no nodes needs be idle waiting for incoming traffics

### (D)

CLEARER MATHS: (Note various earlier formulations not correct!)

1. YES, make sure modified TCP now does not decrement AI or CWND, SIMPLY sets AI to actual inFlights whenever RTXM arrives (previous REGULATE RATES PACE period would have caused inFlights <CWND because packets were forwarded ‘slower’) ie SIMPLY sets AI/CWND to largest SentSeqNo+its data payload length−largest ReceivedACKNo at the instant when RTXM arrives (since this is the total forwarded bytes during previous RTT)+total retransmitted bytes since last RTXM arrival (=total # of missing SACK gap bytes indicated in last RTXM)
(BUT double-check if should just leave CWND unchanged whatsoever: CWND size once attained couldn't cause packet drops . . . .)
2. incorporate REGULATE Rates Pace layer, to ensure link's nodes cleared of buffered packets within next RTT+ensure closer to 100% ie no nodes needs be idle waiting for incoming traffics:
REGULATE RATES PACE (no need usual Rates Pace at all in this Simulation, may need in real life OS) should SIMPLY be:
we want Allowed inFlights (CWND) to cause equivalent to 100% link utilisation but with no buffered packets after 1 RTT=>ie after 1 RTT rates should be [TARGET_AI] ie present inFlights (largest SentSeqNo+its data payload length−largest ReceivedACKNo at the instant when RTXM arrives)/(1+RTXM_RTT−minRTXM_RTT)
BUT there was inferred (by RTXM_RTT−minRTXM_RTT) buffered packets along routers nodes equivalent to [BUFFERED] ie present inFlights−present inFlights/(1+RTXM_RTT−minRTXM_RTT)
   =>REGULATE Rates Pace should allow these to be ALL forwarded cleared after 1 RTT (by reducing transmit rates via REGULATE Rates Pace)
   =>next packet (RTXM retransmission packets or brand new higher SeqNo packet) all to be held in ‘final network Transmit Queue’, not to be forwarded UNTIL previous forwarded packet's total size in bytes/[(TARGET_AI−BUFFERED)/curRTXM_RTT in seconds 1 must have elapsed [in seconds] before next packet could be forwarded to NIC . . . there can be various other similar formulations . . . (in real life non-real time OS, can implement allowing up to cumulative # of bytes referencing from systime when RTXM arrives)
   3. Allowed inFlights/CWND now should be incremented as usual IF RTXM_RTT<minRTXM_RTT+25 ms, BUT NEVER DECREMENTED EVEN IF OTHERWISE
   4. retransmit ALL requested missing SACK gap SeqNos/SeqNo blocks REGARDLESS of CWND/AI values, placed into network Transmit Queue subject to REGULATE Rates Pace
   5. reduce inFlights (here=largest SentSeqNo+data payload length−largest
   ReceivedACKNo−total # of bytes of SACKed SeqNos/SeqNo blocks)
   subsequently dynamic updated inFlights value ALWAYS=[Neither of our inFlights formulations is perfect. More correct is: inFlights always=highest_SeqNo−highest_ackno−present latest RTXM's total sacked bytes which are >highest_ackno ie latest RTXM copy is kept (until next new one arrives), so total sacked bytes which are >new updated highest_ackno can be derived]
   /***PERHAPS CAN INSTEAD ESTIMATE inFlights AS present arriving RTXM's highest SACKNo (+its data payload length)−previous RTXM's highest SACKNo (+its data payload length)?! ***see Paragraph (E) below***/

### (E)

More accurate estimate of [actual present inFlights] should be present arriving RTXM's highest SACKNo (+its data payload length)−previous RTXM's highest SACKNo (+its data payload length)+all retransmitted packets since last RTXM arrival (=total # of missing SACK gap bytes), since this reflects actual forwarded bytes in last RTT more accurate (window's worth of bytes in last RTT, & latest ReceivedACKNo could be ‘pegged’ very low . . . .

ie
1. YES, make sure modified TCP now does not decrement AI or CWND, SIMPLY sets AI to actual inFlights whenever RTXM arrives (previous REGULATE RATES PACE period would have caused inFlights <CWND because packets were forwarded ‘slower’) ie SIMPLY sets AI/CWND to present arriving RTXM's highest SACKNo (+its data payload length)−previous RTXM's highest SACKNo (+its data payload length)

### Note:

earlier reducing CWND/Allowed_inFlights value to CWND/(1+curRTXM_RTT−minRTXM_RTT) when RTXM arrives CERTAINLY completely removed all routers buffered packets BUT this also ‘unexpected’ subsequently caused routers to be ‘idle’ waiting for incoming traffics to forward onwards==>inability to achieve EXACT 100% utilisation ALL THE TIMES for ver large RTTs! this is because once all buffered packets cleared & sender TCP starts transmitting again it still takes eg 300 ms (assuming 300 ms latency & this router located very close to just before receiver TCP) for the first packet to arrive at router with 0.5 s equiv buffer THUS the link would be ‘idle wasteful . . . especially so with increasing link latency
SOLUTION: REGULATE rates pace layer forwarding at an ‘slower but exact rate’ so after 1 RTT all buffered packets completely cleared & AT THE SAME TIME (after exactly 1 RTT) the router now at this very instant gets incoming packets (incidentally at exact rates of 10 mbs, assuming 10 mbs link) to forward onwards not ‘idle’ waiting . . . very smart here

REGULATE Rates Pace Delays to achieve the purpose above should be: next packet (RTXM retransmission packets or brand new higher SeqNo packet) all to be held in ‘final network Transmit Queue’, not to be forwarded UNTIL previous forwarded packet's total size in bytes/[(TARGET AI−BUFFERED)/curRTXM_RTT in seconds 1 must have elapsed [in seconds] before next packet could be forwarded to NIC . . . there can be various other similar formulations . . . .

### (F)

### Even More Accurate:

### Correction:

more correct is to set CWND/Allowed inFlights to present arriving RTXM's highest SACKNo (+its data payload length)−previous RTXM's highest SACKNo (+its data payload length)+total data payload bytes of ALL retransmitted packets (between previous RTXM arrival triggering retransmission & present arriving RTXM) ie equivalent to total # of SACKed bytes in previous RTXM
1. YES, make sure simulation now does not decrement AI or CWND, SIMPLY sets AI to actual inFlights whenever RTXM arrives (previous REGULATE RATES PACE period would have caused inFlights<CWND because packets were forwarded ‘slower’) ie SIMPLY sets AI/CWND to present arriving RTXM's highest SACKNo (+its data payload length)−previous RTXM's highest SACKNo (+its data payload length)+previous RTXM total # of SACKed bytes
(BUT double-check if should just leave CWND unchanged whatsoever: CWND size once attained couldn't cause packet drops . . . .)
2. incorporate REGULATE Rates Pace layer, to ensure link's nodes cleared of buffered packets within next RTT+ensure closer to 100% ie no nodes needs be idle waiting for incoming traffics:
REGULATE RATES PACE (no need usual Rates Pace at all in this Simulation, may need in real life OS) should SIMPLY be:
   we want Allowed inFlights (CWND) to cause equivalent to 100% link utilisation but with no buffered packets after 1 RTT==>ie after 1 RTT rates should be [TARGET_AI] ie present inFlights (largest SentSeqNo+its data payload length−largest ReceivedACKNo at the instant when RTXM arrives)/(1+RTXM_RTT−minRTXM_RTT) NOTE this is TARGETED All CWND value, after 1 RTT elapsed, which would correspond to 100% utilisation & at the same time all nodes ‘uncongested non-buffered’
   BUT there was inferred (by RTXM_RTT−minRTXM_RTT) buffered packets along routers nodes equivalent to [BUFFERED] ie present inFlights−present inFlights/(1+RTXM_RTT−minRTXM_RTT)
==>REGULATE Rates Pace should allow these to be ALL forwarded cleared after 1 RTT (by reducing transmit rates via REGULATE Rates Pace)
==>next packet (RTXM retransmission packets or brand new higher SeqNo packet) all to be held in ‘final network Transmit Queue’, not to be forwarded UNTIL previous forwarded packet's total size in bytes/[(TARGET_AI−BUFFERED)/curRTXM_RTT in seconds] must have elapsed [in seconds] before next packet could be forwarded to NIC . . . there can be various other similar formulations . . . .
(in real life non-real time OS, can implement allowing up to cumulative # of bytes referencing from systime when RTXM arrives)

### (G)

the Target Rate for use in REGULATE rates pace computation, alternatively, could be derived based on size value of [present CWND or AI/(1+curRTXM_RTT−minRTXM_RTT)]−[amount of CWND or AI reduction here ie present CWND or AI−(present CWND or AI/(1+curRTXM_RTT−minRTXM_RTT))], OR various similarly derived formulae
any of earlier Target Rates formulation/s for use in REGULATE Rates Pace computation may further be modified/tweaked eg to ensure there is always some ‘desired’ small tolerable’ level of buffered packets along the path to attain closer to 100% link utilisations & throughputs, eg the Target Rate for use in REGULATE rates pace computation, alternatively, could be derived based on size value of [present CWND or AI/(1+curRTXM_RTT−minRTXM_RTT)]−[amount of CWND or AI reduction here ie present CWND or AI−(present CWND or AI/(1+curRTXM_RTT−minRTXM_RTT))]+eg 5% of newly reduced CWND or AI value (or various other formulae, or just fixed value of 3 Kbytes . . . etc)

### (H)

NOTE: any of these formulae could be adapted implemented to work with UDPs/DCCP . . . etc, principle difference is these protocol usually indicate missing SeqNos via NACK . . . etc mechanisms instead

NOTE: immediately above described REGULATE Rates Pace methods could be utilised by earlier described method/s in the Description Body, in place of step of reducing CWND/trackedCWND/Allowed inFlights to be =CWND/trackedCWND/Allowed inFlights/(1+curRTT−minRTT).

Note also this earlier described method/s' step in Description Body could have been formulated differently as reducing CWND/trackedCWND/Allowed inFlights to be =CWND/trackedCWND/Allowed inFlights/(1+(curRTT+allowed buffer level eg 50−minRTT) . . . etc, this allowed buffer level could be based algorithmically derived formula eg 0.5*curRTT, or 0.5*minRTT . . . etc
Note also instead of basing on curRTT, earlier described method/s' step in Description Body of reducing CWND/trackedCWND/Allowed inFlights to be =CWND/trackedCWND/Allowed inFlights (1+curRTT−minRTT) could be replaced by reducing CWND/trackedCWND/Allowed inFlights to be =CWND/trackedCWND/Allowed inFlights−total # of dropped packets in/during previous RTT (or its total estimate)

NOTE: earlier reducing CWND/Allowed_inFlights value to CWND/(1+curRTXM_RTT−minRTXM_RTT) when RTXM arrives CERTAINLY completely removed all routers buffered packets BUT this also ‘unexpected’ subsequently caused routers to be ‘idle’ waiting for incoming traffics to forward onwards=>inability to achieve EXACT 100% utilisation observed so far! this is because once all buffered packets cleared & sender TCP starts transmitting again it still takes eg 300 ms (assuming 300 ms latency & this router located very close to just before receiver TCP) for the first packet to arrive at router with 0.5 s equiv buffer THUS the link would be ‘idle wasteful . . . especially so with increasing link latency, as observed so far

SOLUTION: REGULATE rates pace layer forwarding at an ‘slower but exact rate’ so after 1 RTT all buffered packets completely cleared & AT THE SAME TIME (after exactly 1 RTT) the router now at this very instant gets incoming packets (incidentally at exact rates of 10 mbs, assuming 10 mbs link) to forward onwards not ‘idle’ waiting . . . .

Any combination of the methods/any combination of various sub-component/s of the methods (also any combination of various other existing state of art methods)/any combination of method ‘steps’ or sub-component steps, described in the Description Body, may be combined/interchanged/adapted/modified/replaced/added/improved upon to give many different implementations.

Those skilled in the arts could make various modifications & changes, but will fall within the scope of the principles

1. Methods for improving TCP &/or TCP like protocols &/or other protocols, which could be capable of Increment Deployable TCP Friendly completely implemented directly via TCP/Protocol stack software modifications without requiring any other changes/re-configurations of any other network components whatsoever and which could enable immediate ready guaranteed service PSTN transmissions quality capable networks and without a single packet ever gets congestion dropped, said methods avoid &/or prevent &/or recover from network congestions via complete or partial ‘pause’/‘halt’ in sender's data transmissions, OR algorithmic derived dynamic reduction of CWND or Allowed inFlights values to clear all traversed nodes' buffered packets (or to clear certain levels of traversed nodes' buffered packets), when congestion events are detected such as congestion packet drops &/or returning ACK's round trip time RTT/one way trip time OTT comes close to or exceeded certain threshold value eg known value of the flow path's uncongested RTT/OTT or their latest available best estimate min(RTT)/min(OTT).

2. Methods for improving TCP &/or TCP like protocols &/or other protocols, which could be capable of completely implemented directly via TCP/Protocol stack software modifications without requiring any other changes/re-configurations of any other network components whatsoever and which could enable immediate ready guaranteed service PSTN transmissions quality capable networks and without a single packet ever gets congestion dropped, said methods comprises any combinations/subsets of (a) to (c):
(a) makes good use of new realization/technique that TCP's Sliding Window mechanism's ‘Effective Window’ &/or Congestion Window CWND needs not be reduced in size to avoid &/or prevent &/or recover from congestions.
(b) Congestions instead are avoided &/or prevented &/or recovered from via complete or partial ‘pause’/‘halt’ in sender's data transmissions, OR various algorithmic derived dynamic reduction of CWND or Allowed inFlights values to exact completely clear all (or certain specified level) traversed nodes' buffered packets before resuming packets transmission, when congestion events are detected such as congestion packet drops &/or returning ACK's round trip time RTT/one way trip time OTT comes close to or exceeded certain threshold value eg known value of the flow path's uncongested RTT/OTT or their latest available best estimate min(RTT)/min(OTT).
(c) Instead or in place or in combination with (b) above, TCP's Sliding Window mechanism's ‘Effective Window’ &/or Congestion Window CWND &/or Allowed inFlights value is reduced to a value algorithmically derived dependent at least in part on latest returned round trip time RTT/one way trip time OTT value when congestion is detected, and/or the particular flow path's known uncongested round trip time RTT/one way trip time OTT or their latest available best estimate min(RTT)/min(OTT), and/or the particular flow path's latest observed longest round trip time max(RTT)/one way trip time max(OTT)

3. Methods for virtually congestion free guaranteed service capable data communications network/Internet/Internet subsets/Proprietary Internet segment/WAN/LAN [hereinafter refers to as network] with any combinations/subsets of features (a) to (f):
(a) where all packets/data units sent from a source within the network arriving at a destination within the network all arrive without a single packet being dropped due to network congestions.
(b) applies only to all packets/data units requiring guaranteed service capability.
(c) where the packet/data unit traffics are intercepted and processed before being forwarded onwards.
(d) where the sending source/sources traffics are intercepted processed and forwarded onwards, and/or the packet/data unit traffics are only intercepted processed and forwarded onwards at the originating sending source/sources.
(e) where the existing TCP/IP stack at sending source and/or receiving destination is/are modified to achieve the same end-to-end performance results between any source-destination nodes pair within the network, without requiring use of existing QoS/MPLS techniques nor requiring any of the switches/routers softwares within the network to be modified or contribute to achieving the end-to-end performance results nor requiring provision of unlimited bandwidths at each and every inter-node links within the network.
(f) in which traffics in said network comprises mostly of TCP traffics, and other traffics types such as UDP/ICMP . . . etc do not exceed, or the applications generating other traffics types are arranged not to exceed, the whole available bandwidth of any of the inter-node link/s within the network at any time, where if other traffics types such as
UDP/ICMP . . . do exceed the whole available bandwidth of any of the inter-node link/s within the network at any time only the source-destination nodes pair traffics traversing the thus affected inter-node link/s within the network would not necessarily be virtually congestion free guaranteed service capable during this time and/or all packets/data units sent from a source within the network arriving at a destination within the network would not necessarily all arrive ie packet/s do gets dropped due to network congestions.

4. Methods in accordance with any of claims 1-3 above, in said methods the improvements/modifications of protocols is effected at the sender TCP.

5. Methods in accordance with any of claims 1-3 above, in said methods the improvements/modifications of protocols is effected at the receiver side TCP.

6. Methods in accordance with any of claims 1-3 above, in said methods the improvements/modifications of protocols is effected in the network's switches/routers nodes.

7. Methods where the improvements/modifications of protocols is effected in any combinations of locations as specified in any of the claims 4-6 above.

8. Methods where the improvements/modifications of protocols is effected in any combinations of locations as specified in any of the claims 4-6 above, in said methods the existing ‘Random Early Detect’ RED &/or ‘Explicit Congestion Notification’ ECN are modified/adapted to give effect to that disclosed in any of the claims 1-7 above.

9. Methods in accordance with any of the claims 1-8 above or independently, where the switches/routers in the network are adjusted in their configurations or setups or operations, such as eg buffer size adjustments, to give effect to that disclosed in any of the claims 1-8 above.

10. Methods for improving TCP &/or TCP like protocols &/or other protocols, which could be capable of Increment Deployable TCP Friendly completely implemented directly via TCP/Protocol stack software modifications without requiring any other changes/re-configurations of any other network components whatsoever and which could enable immediate ready guaranteed service PSTN transmissions quality capable networks and without a single packet ever gets congestion dropped, said methods avoid &/or prevent &/or recover from network congestions via complete or partial ‘pause’/‘halt’ in sender's data transmissions, OR algorithmic derived dynamic reduction of CWND or Allowed inFlights values to clear all traversed nodes' buffered packets (or to clear certain levels of traversed nodes' buffered packets, when congestion events are detected such as congestion packet drops &/or returning ACK's round trip time RTT/one way trip time OTT comes close to or exceeded certain threshold value eg known value of the flow path's uncongested RTT/OTT or their latest available best estimate min(RTT)/min(OTT), &/OR in accordance with any of claims 2-9 above WHERE IN SAID METHODS:
existing protocols RFCs are modified such that sender's CWND value is instead now never reduced/decremented whatsoever, except to temporarily effect ‘pause’/‘halt’ of sender's data transmissions upon congestions detected (eg by temporarily setting sender's CWND=1*MSS during ‘pause’/‘halt’ & after ‘pause’/‘halt’ completed to then restore sender's CWND value to eg existing CWND value prior to ‘pause’/halt or to some algorithmically derived value, OR eg by equivalently setting sender's CWND=CWND/(1+curRTT in sec−minRTT in sec) OR various similar derived different formulations thereof): the ‘pause’/halt ‘ interval could be set to eg arbitrary 300 ms or algorithmically derived such as Minimum (latest RTT of returning ACK packet triggering the 3^{rd} DUP ACK fast retransmit OR latest RTT of returning ACK packet when RTO Timedout, 300 ms) or algorithmically derived such as Minimum (latest RTT of returning ACK packet triggering the 3^{rd} DUP ACK fast retransmit OR latest RTT of returning ACK packet when RTO Timedout, 300 ms, max(RTT))
AND/OR
CWND &/or Allowed inFlights value is now ONLY incremented incremented by number of bytes ACKed (ie exponential increment) IF curRTT's RTT or OTT (latest returning ACK's RTT or OTT, in milliseconds)<minRTT or minOTT+tolerance variance eg 25 ms, ELSE incremented by number of bytes ACKed/CWND or Allowed inFlights value (ie linear increment per RTT) or optionally not incremented at all, OR various similar derived different formulations thereof: the exponential &/or linear increment unit size could be varied eg to be 1/10^{th} or ⅕^{th} or ½ . . . or algorithmic dynamic derived

11. Methods as in accordance with any of the claims 2 or 3 or 10 above, in said Methods:
An Intercept Module, sitting between resident original TCP & the network intercepts examine all incoming & outgoing packets, takes over all 3^{rd} DUPACK fast retransmit & all RTO Timeout retransmission functions from resident original TCP, by maintaining Packet Copies list of all sent but as yet unacked packets/segments/bytes together with their SentTime: thus resident original TCP will now not ever notice any 3^{rd} DUPACK or RTO Timeout packet drop events, and resident original
TCP source code is not modified whatsoever
Intercept Module dynamically tracks resident TCP's CWND size (usually equates to inFlight size, if so can very readily be derived from largest SentSeqNo+its data payload size−largest ReceivedAckNo), during any RTT eg using ‘Marker packets’ &/or various pre-existing passive CWND tracking methods, update & record largest attained trackedCWND size.
On 3^{rd} DUPACK triggering fast retransmit, update & record MultAcks (total number of Multiple DUPACKs received during this fast retransmit phase, before exiting this particular fast retransmit phase)
trackedCWND now never ever gets decremented, EXCEPT when/upon exiting fast retransmit phase or when/upon completed RTO Timeout: here trackedCWND could then be decremented eg by the actual total # of bytes retransmitted onwards during this fast retransmit phase (or by the actual # of bytes retransmitted onwards during RTO Timeout)
During fast retransmit phase (triggered by 3^{rd} DUPACK), Intercept Module strokes out 1 packet (can be retransmission packet or normal new higher SeqNo data packet, with priority to retransmission packet/s if any) correspondingly for each arriving subsequent multiple DUPACKs (after the 3^{rd} DUPACK which triggered the fast retransmit phase)

12. Methods as in accordance with any of the claims 10 or 11 above, in said Methods:
the resident TCP source code is modified directly correspondingly thus not needing Intercept Module, and with many attending simplifications achieved

13. Methods as in accordance with the claims 2 or 3 or 10 above, in said Methods:
An Intercept Module, sitting between resident original TCP & the network intercepts examine all incoming & outgoing packets, but does not takes over/interferes with all existing 3^{rd} DUPACK fast retransmit & all RTO Timeout retransmission functions of resident original TCP, & does not needs to maintain Packet Copies list of all sent but as yet unacked packets/segments/bytes together with their SentTime: thus resident original TCP will now continue to notice 3^{rd} DUPACK or RTO Timeout packet drop events, and resident original TCP source code is not modified whatsoever
Intercept Module dynamically tracks resident TCP's CWND size (usually equates to inFlight size, if so can very readily be derived from largest SentSeqNo+its data payload size−largest ReceivedAckNo), during any RTT eg using ‘Marker packets’ &/or various pre-existing passive CWND tracking methods, update & record largest attained trackedCWND size.
On 3^{rd} DUPACK triggering fast retransmit, Intercept Module follows with generation of a number of multiple same ACKNo DUPACKs towards resident TCP such that this number*remote TCP's MSS (max segment size) is =<0.5*trackedCWND (or total inFlights) at the instant of the 3^{rd} DUPACK: resident TCP's CWND value is thus preserved unaffected by existing RFC halving of CWND value on entering fast retransmit phase.
On exiting fast retransmit phase, Intercept Module generates required number of ACK Divisions towards resident TCP to inflate resident TCP's CWND value back to the original CWND value at the instant just before entering into fast retransmit phase: this undo halving of resident TCP's CWND value by existing RFC on exiting fast retransmit phase.
On RTO Timeout retransmission completion, Intercept Module generates required number of ACK Divisions towards resident TCP to restore undo existing RFC reset of resident TCP's CWND value.

14. Methods as in accordance with claim 13 above, in said Methods:
the resident TCP source code is modified directly correspondingly thus not needing Intercept Module, and with many attending simplifications achieved

15. Methods as in accordance with any of claims 2 or 3 or 10-14 above, in said Methods:
resident TCP's CWND value is to be reduced to be CWND (or actual inFlights)*factor of (curRTT−minRTT)/curRTT, OR is to be reduced to be CWND (or actual inFlights)/(1+curRTT in seconds−minRTT in seconds), OR various similarly derived formulations: this resident TCP's CWND reduction now totally replaces earlier needs for ‘temporal pause’ method step.

16. Methods as in accordance with any of claims 2 or 3 or 10-15 above, in said Methods:
resident TCP is directly modified or modification is only in the Intercept Module or both together ensures 1 packet is forwarded onwards to network for each arriving new ACKs (or for each subsequent arriving multiple DUPACKs during fast retransmit phase), OR ensures corresponding cumulative number of bytes is allowed forwarded onwards to network for each arriving new ACKs' cumulative number of bytes freed (or ensures 1 packet is forwarded onwards to network for each subsequent arriving multiple DUPACKs during fast retransmit phase): this is ACKs Clocking maintaining same number of inFlight packets in the network, UNLESS CWND or trackedCWND or Allowed inFlights value incremented which injects more ‘extra’ packets into network
CWND or trackedCWND or Allowed inFlights value is incremented as follows, or various similarly derived formulations (different from existing RFC Congestion Avoidance algorithm):
IF curRTT<minRTT+tolerance variance eg 25 ms
THEN incremented by bytes acked (ie exponential increment)
ELSE incremented by bytes acked/CWND or trackedCWND or Allowed inFlights (ie linear increment per RTT) OR OPTIONALLY do not increment at all.
OPTIONALLY sets CWND or trackedCWND or Allowed inFlights to largest recorded CWND or trackedCWND or Allowed inFlights attained during/under uncongested path conditions (ie curRTT<minRTT+tolerance variance eg 25 ms), when/upon exiting fast retransmit phase or upon completing RTO Timeout retransmissions

17. Methods as in accordance with any of claims 2 or 3 or 10-16 above, in said Methods:
An Intercept Module, sitting between resident original TCP & the network intercepts examine all incoming & outgoing packets, takes over all 3^{rd} DUPACK fast retransmit & all RTO Timeout retransmission functions from resident original TCP, by maintaining Packet Copies list of all sent but as yet unacked packets/segments/bytes together with their SentTime: thus resident original TCP will now not ever notice any 3^{rd} DUPACK or RTO Timeout packet drop events, and resident original
TCP source code is not modified whatsoever
Intercept Module dynamically tracks resident TCP's CWND size (usually equates to inFlight size, if so can very readily be derived from largest SentSeqNo+its data payload size−largest ReceivedAckNo), during any RTT eg using ‘Marker packets’ &/or various pre-existing passive CWND tracking methods, update & record largest attained trackedCWND size.
Intercept Module immediately ‘spoof acks’ towards resident TCP whenever receiving new higher SeqNo packets from resident TCP (ie with SpoofACKNo=this packet's SeqNo+its data payload length), thus resident TCP now never ever notice any 3^{rd} DUPACK nor any RTO Timeout packet drop events whatsoever.
Resident MSTCP here now continuous exponential increment its CWND value until CWND reaches MAX [sender max negotiated window size, receiver max negotiated window size] as in existing RFC algorithm, and stays there continuously.
Intercept Module puts all newly received packets from resident TCP, and all RTO & fast retransmission packets generated by Intercept Module into a Transmit Queue (just before the network interface) arranging them all in well ordered ascending SeqNos (lowest SeqNo at front): whenever actual inFlights becomes <Intercept Module's own trackedCWND or Allowed inFlights eg upon Intercept Module's own trackedCWND or Allowed inFlights incremented when ACKs returned, Intercept Module's own trackedCWND or Allowed inFlights needs not be limited in size.
Intercept Module controls MSTCP packets generations rates (start & stop etc) at all times, via changing receiver advertised rwnd value of incoming packets towards resident TCP (eg ‘0’ or very small rwnd value would halt resident TCP's packet generation) and ‘spoof acks’ (which would cause resident TCP's Sliding Window's left edge to advance, allowing new packets to be generated): IF Intercept Module needs to forward onwards packet/s to the network (eg when actual inFlights+this to be forwarded packet's data payload length<trackedCWND or Allowed inFlights) it will first do so front of Transmit Queue if no empty OTHERWISE it will ‘spoof required number of ack/s’ with successive SpoofACKNo=next as yet unacked Packet Copies list's SeqNo (if Packet Copies list ever becomes empty (ie all Packet Copies have all now becomes ACKed & thus all removed) then resident TCP's Sliding Window size will have become ‘0’ & thus generate new higher SeqNo packet/s filling Transmit Queue ready to be forwarded onwards to network, AND IF Intercept Module needs to ‘pause’ forwarding it can eg reduce trackedCWND (or Allowed inFlights) to be trackedCWND (or Allowed inFlights)/(1+curRTT in seconds−minRTT in seconds) &/or change/generate receiver advertise RWND field to be ‘0’ for a corresponding period &/or SIMPLY do not forward onwards from Transmit Queue until actual inFlights+this to be forwarded packet's data payload length becomes=<trackedCWND (or Allowed inFlights)/(1+curRTT in seconds−minRTT in seconds)

18. Methods as in accordance with claims 2 or 3 or 17 above, in said Methods:
Intercept Module does not immediately ‘spoof acks’ towards resident TCP whenever receiving new higher SeqNo packets from resident TCP, instead Intercept Module ‘spoof acks’ towards resident TCP ONLY when 3^{rd} DUPACK arrives from network (this 3^{rd} DUPACK will only be forwarded onwards to resident TCP after the ‘spoof ack’ has been forwarded first, with SpoofACKNo=3^{rd} DUPACKNo+data payload length of Packet Copies list entry with corresponding same SeqNo as 3^{rd} DUPACKNo), AND immediately ‘spoof NextAcks’ (ie NextAcks=packet's SeqNo+its data payload length) whenever any Packet Copies' SentTime+eg 850 ms<present systime (ie before RFC specified minimum lowest RTO Timeout value of 1 second triggers resident TCP's RTO Timeout retransmission), thus resident TCP now never ever notice any 3^{rd} DUPACK nor any RTO Timeout packet drop events whatsoever.

19. Methods as in accordance with claims 17 or 18 above, in said Methods:
Intercept Module does not ‘spoof ack’ whatsoever UNTIL very 1^{st} 3^{rd} DUPACK or RTO Timeout packet drop event is noticed by resident TCP, thereafter Intercept Module continues with ‘spoof acks’ schemes as described: thus resident TCP would only ever able to increment its own CWND linearly per RTT.

20. Methods as in accordance with claims 17 or 18 or 19 above, in said Methods:
the resident TCP source code is modified directly correspondingly thus not needing Intercept Module, and with many attending simplifications achieved

21. Methods as in accordance with claims 2 or 3 or 10-20 above, in said Methods the modifications are implemented at receiver side Intercept Module:
when receiver resident TCP initiates TCP establishment, receiver side Intercept Module records the negotiated max sender/receiver window size, max segment size, initial sender/receiver SeqNos & ACKNos & various parameters eg large scaled window option/SACK option/Timestamp option/No Delay ACK option.
receiver side Intercept Module records the very 1^{st} data packet's SeqNo (sender 1stDataSeqNo) & the very 1^{st} data packet's ACKNo (sender 1 stDataACKNo)
when receiver resident TCP generates ACK/s towards remote sender TCP (whether pure ACK or ‘piggyback’ ACK), receiver side Intercept Software will modify the ACKNo field value to be Receiver1stACKNo (initialised to be same value as initial negotiated ACKNo) thus after receiving 3 such modified ACKs remote sender TCP will enter into fast retransmit phase & receiver side Intercept Module upon detecting 3^{rd} DUPACK forwarded to remote sender TCP will now generate an exact # of ‘pure’ multiple DUPACKs all with ACKNo field value set to same Receiver1stACKNo exact # of which=total inFlight packets (or trackedCWND/sender SMSS)/2, thus remote sender TCP upon entering fast retransmit phase here will have its CWND value ‘restored’ to the value just prior to entering fast retransmit phase & could immediately ‘stroke’ out 1 packet (new higher SeqNo packet or retransmission packet) for each subsequent arriving multiple same SeqNo Multiple DUPACKs preserving ACKs Clocking
receiver side Intercept Module upon detecting/receiving retransmission packet from remote sender TCP (with SeqNo=<recorded largest ReceivedSeqNo) and while at the same time remote sender TCP is not in fast retransmit mode (ie this now correspond to remote sender TCP RTO Timeout retransmit) will similarly generate an exact required # of ‘pure’ multiple DUPACKs all with ACKNo field value set to same Receiver1stACKNo exact # of which=total inFlight packets (or trackedCWND/sender SMSS)/(1+curRTT in seconds−minRTT in seconds) THUS ensuring remote sender TCP's CWND value upon completing RTO Timeout retransmission is ‘RESTORED’ immediately to ‘Calculated Allowed inFlights’ value in packets (or in equivalent bytes) ensuring complete removal of all nodes' buffered packets along the path & subsequent total inFlights ‘kept up’ to the new ‘Calculated Allowed inFlights’ value: OPTIONALLY receiver side Intercept Module may want to subsequently now use this received RTO Timeout retransmission packet's SeqNo+its datalength as the new incremented Receiver1stACKNo/new incremented ‘clamped’ ACKNo.
After the 3^{rd} DUPACK has been forwarded to remote sender TCP triggering fast retransmit phase, subsequently receiver side Intercept Module upon detecting receiver resident TCP generating a ‘new’ ACK packet (with ACKNo>the 3^{rd} DUPACKNo forwarded which when received at remote sender TCP would cause remote sender TCP to exit fast retransmit phase again reducing CWND to Ssthresh value of CWND/2) will now generate an exact # of ‘pure’ multiple DUPACKs all with ACKNo field value set to same Receiver stACKNo
exact # of which=[{total inFlight packets (or trackedCWND in bytes/sender SMSS in bytes)/(1+curRTT in seconds−minRTT in seconds)}−total inFlight packets (or trackedCWND in bytes/sender SMSS in bytes)/2]
ie target inFlights or CWND in packets to be ‘restored’ to—remote sender TCP's halved CWND size on exiting fast retransmit (or various similar derived formulations) THUS ensuring remote sender TCP's CWND value upon exiting fast retransmit phase is ‘RESTORED’ immediately to ‘Calculated Allowed inFlights’ value in packets (or in equivalent bytes) ensuring complete removal of all nodes' buffered packets along the path & subsequent total inFlights ‘kept up’ to the new ‘Calculated Allowed inFlights’ value: OPTIONALLY receiver side Intercept Module may want to subsequently now use this ‘new’ ACKNo as the new incremented Receiver1stACKNo/new incremented ‘clamped’ ACKNo.
OPTIONALLY instead of forwarding each receiver resident TCP generated ACK packets modifying their ACKNo field values to all be the same Receiver1stACKNo/‘clamped’ ACKNo receiver side Intercept Module can only forward 1 single ACK packet only when the cumulative # of bytes freed by the receiver resident TCP generated ACK/s becomes near equal to or near to exceed the initial negotiated remote sender TCP max segment size, and subsequently receiver side Intercept Module will thereafter sets Receiver1stACKNo/‘clamped ACKNo’ to be this latest forwarded ACKNo . . . & so forth in repeated cycles
Upon detecting that the total # of ‘bytes’ remote sender TCP has been progressively cumulatively incremented (each multiple DUPACKs increments remote sender TCP's CWND by 1*SMSS) getting close to (or getting close to eg half . . . etc) the remote sender TCP's negotiated max window size, receiver side Intercept Software will thereafter always use this present largest received packet's SeqNo from remote sender (or SeqNo+its datalength) as the new incremented Receiver1stACKNo/‘clamped’ ACKNo
OPTIONALLY receiver side Intercept Module upon detecting 3 new packets with out-of-order SeqNo have been received from remote sender TCP, to then thereafter always use the ‘missing’ earlier SeqNo as the new incremented Receiver1stACKNo/‘clamped’ ACKNo
Allowed inFlights & trackedCWND values are updated constantly, receiver side intercept Module may generate ‘extra’ required # of pure multiple DUPACKs to ensure actual inFlights ‘kept up’ to Allowed inFlights or trackedCWND value
OPTIONALLY ‘Marker’ packets CWND/inFlights tracking techniques, ‘continuous advertised receiver window size increments’ techniques, Divisional ACKs techniques, ‘synchronising packets’ techniques, inter-packet-arrivals techniques, receiver based ACKs Pacing techniques could be adapted incorporated

22. Methods as in accordance with claim 21 above, in said Methods:
the receiver resident TCP source code is modified directly correspondingly thus not needing receiver side Intercept Module, and with many attending simplifications achieved

23. Methods as in accordance with any of claims 2 or 3 or 10-22 above, in said Methods:
All, or majority of all TCPs within proprietary LAN/WAN/geographic subset all implements the methods/modifications thus achieving better TCP throughput/latency performances.
Further all TCPs or majority of all TCPs within proprietary LAN/WAN/geographic subset all ‘refrain’ from any increment of Calculated Allowed inFlights or trackedCWND or CWND even when latest arriving curRTT (or curOTT)<minRTT (or minOTT)+‘tolerance variance’ eg 25 ms+‘refrain buffer zone’ eg 50 ms THEN PSTN or close to PSTN real time guaranteed transmission qualities will be achieved for all TCP flows within the within proprietary LAN/WAN/geographic subset
OPTIONALLY when latest arriving curRTT (or curOTT)<minRTT (or minOTT)+‘tolerance variance’ eg 25 ms+‘refrain buffer zone’ eg 50 ms THEN TCPs may again resume increments of Calculated Allowed inFlights or trackedCWND or CWND

24. Method to overcome combined effects of remote receiver TCP's buffer size limitation & high transit link's packet drop rates on throughputs achievable (such as BULK FTPs, High Energy Grids Transfer), throughputs achievable here may be reduced many times magnitudes order smaller than actual available bottleneck bandwidth:
(A) TCP SACK mechanism should be modified to have unlimited SACK BLOCKS in SACK field, so within each RTT/each fast retransmit phase ALL missing SACK Gaps SeqNo/SeqNo blocks could be fast retransmit requested. OR could be modified so that ALL missing SACK Gaps SeqNo/SeqNo blocks could be contained within pre-agreed formatted packet/s' data payload transmitted to sender TCP for fast retransmissions. OR existing max 3 blocks SACK mechanism could be modified so that ALL missing SACK Gaps SeqNos/SeqNo blocks could cyclical sequentially be indicated within a number of consecutive DUPACKs (each containing progressively larger value yet unindicated missing SACK Gaps SeqNos/SeqNo blocks) ie a necessary number of DUPACKs would be forwarded sufficiently to request all the missing SACK SeqNos/SeqNo blocks, each DUPACK packets repeatedly uses the existing 3 SACK block fields to request as yet unrequested progressively larger SACK Gaps SeqNos/SeqNo blocks for retransmission WITHIN same fast retransmit phase/same RTT period.
AND/OR
(B) Optional but preferable TCP be also modified to have very large (or unlimited linked list structure, size of which may be incremented dynamically allocated as & when needed) receiver buffer. OR all receiver TCP buffered packets/all receiver TCP buffered ‘disjoint chunks’ should all be moved from receiver buffer into dynamic arbitrary large size allocated as needed ‘temporary space’, while in this ‘temporary space’ awaits missing gap packets to be fast retransmit received filling the holes before forwarding onwards non-gap continuous SeqNo packets onwards to end user application/s.
OR
(C) Instead of above direct TCP source code modifications, an independent ‘intermediate buffer’ intercept software can be implemented sitting between the incoming network & receiver TCP to give effects to above foregoing (A) & (B), working in cooperation with earlier sender based TCPAccelerator software
implement an unlimited linked list holding all arriving packets in well ordered SeqNo, this sits at remote PC situated between the sender TCPAccel & remote receiver TCP, does all 3rd DUP ACKs processing towards sender TCP (which could even just be notifying sender TCPAccel of all gaps/gap blocks, or unlimited normal SACK blocks) THEN forward continuous SeqNo packets to remote receiver MSTCP when packets non-disjointed) THUS remote MSTCP now appears to have unlimited TCP buffer & mass drops problem now completely disappear.

25. Method as in accordance with claim 25(C) above, an outline of efficient SeqNos well ordered ‘intermediate buffer’:
(A). STRCTURE: Intermediate Packets buffer as unlimited linked list. And Missing Gap SeqNos unlimited linked list each of which also contains ‘pointer’ to corresponding ‘insert’ location into Intermediate Packets buffer
(B). keeps record of LargestBufferedSeqNo, arriving packets' SeqNo first checked if >LargestBufferedSeqNo TRUE most of the times)
THEN to just straight away append to end of linked list (& if present LargestBufferedSeqNo+datasize<incoming SeqNo then ‘append insert’ value of LargestBiufferedSeqNo+datasize into end of MissingGapSeqNo list, update LargestBufferedSeqNo)
ELSE iterate through Missing Gap SeqNos list (most of the times would match the very front's SeqNo) place into pointed to Intermediate buffer location & ‘remove’ this Missing Gap SeqNos entry [EXCEPTION: if at anytime time while iterating, previous Missing Gap SeqNo<incoming SeqNo<next Missing Gap SeqNo (triggered when incoming SeqNo<current Missing Gap SeqNo) then ‘insert before’ into pointed to Intermediate buffer location BUT do not remove Missing Gap SeqNo.
also if incoming SeqNo>end largest Missing Gap SeqNo then ‘insert after’ pointed to Intermediate buffer location BUT also do not remove Missing Gap SeqNo. [eg scenario when there is a block of multiple missing gap SeqNos] (check for erroneous/‘corrupted’ incoming SeqNo eg<smallest Missing Gap SeqNo)
Similarly TCPAccel could Retransmit requested SeqNos iterating SeqNo values starting from front of Packets Copies (to first match smallest RequestedSeqNos) then continue iterating down from present Packet Copies entry location to match next RequestedSeqNo . . . & so forth UNTIL list of RequestedSeqNos all processed.
(Note: TCPAccel at Sender TCP would only receive a ‘special created’ packet with ‘special identification’ field & all the RequestedSeqNos within data payload, every eg 1 second interval)
Its simpler for ‘intermediate buffer’ to generate packet with unique identification field value eg ‘intbuf’, containing list of all missing ‘gap’ SeqNos/SeqNo blocks using already established TCP connections, there are several port #s for a single FTP (control/data etc) & control channel may also drop packets requiring retransmissions.
the data payload could be just a variable number of 4 byte blocks each containing ascending missing SeqNos (or each could be preceded by a bit flag 0-single 4 byte SeqNo, 1-starting SeqNo & ending SeqNo for missing SeqNos block)
with TCPAccel & remote ‘intermediary buffer working together, path's throughputs will now ALWAYS show constant near 100% regardless of high drops long latencies combinations, ALSO ‘perfect’ retransmission SeqNo resolution granularity regardless of CAI/inFlights attained size eg 1 Gbytes etc:
this is further expected to be usable without users needing to do anything re Scaled Window Sizes registry settings whatsoever, it will cope appropriate & expertly with various bottleneck link's bandwidth sizes (from 56 Kbs to even 100000 Gbs! ie far larger than even large window scaled max size of 1 Gbytes settings could cope!) automatically, YET retains same perfect retransmission SeqNo resolution as when no scaled window size utilised eg usual default 64 Kbytes ie it can retransmit ONLY the exact 1 Kbytes lost segments instead of existing RFC1323 TCP/FTP which always need to retransmit eg 64,000×1 Kbytes when just a single 1 Kbyte segment is lost (assume max window scale utilised).

26. Method to adapt various earlier described external public Internet increment deployable TCP/UDP/DCCP/RTSP modifications (AI: allowed inFlights scheme, with or without ‘intermediate buffer’/Cyclical SACK Re-use schemes to be install in all network nodes/TCP UDP/DCCP/RTSP sources within proprietary LAN/WAN/external Internet segments, providing instant guaranteed PSTN transmission qualities among all nodes or all ‘1^{st} priority’ traffic sources requiring guaranteed real time critical deliveries, requires additional refinements here (also assuming all, or majority of sending traffics sources' protocols are so modified):
at all times (during fast retransmit phase, or normal phase, if incoming ACK's/DUPACAK's RTT (or OTT)>min RTT (or minOTT)+specified tolerance variance eg 25 ms+optionally specified additional threshold eg 50 ms THEN immediately reduce AI size to AI/(1+latest RTT or latest OTT where appropriate−minRTT or minOTT where appropriate) THUS total AI allowed inFlights bytes from all modified traffic sources (may further assume limits total maximum aggregate peak ‘1^{st} priority’ eg VoIP bandwidth requirements at any time is always much less than available network bandwidth, also 1^{st} priority traffics sources could be assigned much larger specified tolerance value eg 100 ms & much larger additional threshold value eg 150 ms) most of the times would never ever cause additional packet delivery latency more than eg 25 ms+optional 50 ms here BEYOND the absolute minimum uncongested RTT/uncongested OTT:
after reduction CAI will stop forwarding UNTIL sufficient number of returning ACKs sufficiently shift sliding window's left edge, we do not want to overly continuously reduce CAI, so this should happen only if total extra buffer delays>eg 25 ms+50 ms.
also CAI algorithm should be further modified to now not allow to ‘linear increment’ (eg previously when ACKs return late thus ‘linear increment’ only not ‘exponential increment’) WHATSOEVER AT ANYTIME if curRTT>minRTT+eg 25 ms, thus enabling proprietary LAN/WAN network flows to STABILISE utilise near 100% bandwidths BUT not to cause buffer delays to grow beyond eg 25 ms (allowing linear increments whenever ACK returns even if very very late would invariably cause network buffer delays to approach maximum, destroys realtime critical deliveries for 1^{st} priority traffics).

27. Methods as in accordance with any of claims 2 or 3 or 10-26 above, in said Methods:
In any of the Methods the component method/component step therein may be replaced by any of other Methods' component method/component sub-method/component step/component sub-step,
and in any of the Methods combinations of other Methods' component method/component sub-method/component step/component sub-step may be added adapted incorporated.
